(19) United States
(12) Patent Application Publication
(10) Pub. No.: US 2005/0228744 A1
(43) Pub. Date: Oct. 13, 2005

(54) Method and apparatus for modifying the winning bid in an on-line auction to benefit a charitable organization

(75) Inventors: Gregory Chales McHale, Melrose, MA (US); Carl Maib, Dracut, MA (US)

Correspondence Address: KUDIRKA & JOBSE, LLP, ONE STATE STREET, SUITE 800, BOSTON, MA, 02109, US

(73) Assignee: cMarket, Inc., Cambridge, MA (US)

(21) Appl. No.: 11/102,160

(22) Filed: Apr. 8, 2005

Related U.S. Application Data
(60) Provisional application No. 60/561,101, filed on Apr. 9, 2004.

(51) Int. Cl. G06F 17/60

(52) U.S. Cl. 705/37

(57) ABSTRACT

The present invention discloses methods, systems, and program code that enable a nonprofit organization to manage its fundraising activities online. Disclosed are methods and systems for providing online hosting of fundraising auctions, and auction services such as maintaining donor/bidder registries, bid tracking, processing credit cards, and auction closeout activities. Also disclosed are a plurality of on-line, web-based tools, including tools for: 1) building a customized homepage reflecting the look and feel of the nonprofit organization; 2) building a customized catalog that allows for easy addition of items and pictures; and 3) enhanced email messaging that lets a nonprofit organization reach its constituents. According to one aspect of the invention, an organization can, as part of the auction preferences, include the ability to suggest a ‘round up’ amount to any winning bidder. If enabled, the system will automatically suggest a ‘round up’ purchase price above the winning bid. The bidder would be informed where the ‘round up’ amount will be utilized. The bidder has the option to disregard the ‘round up’ price and continue the close-out with the original winning bid. Also disclosed are techniques for handling payment for auction items upon rejection of electronic payment data.

### RELATED APPLICATIONS

This application claims priority to commonly assigned U.S. Provisional Patent Application Ser. No. 60/561,101, entitled METHOD AND APPARATUS FOR CREATING AND CONDUCTING ON-LINE CHARITABLE FUND RAISING ACTIVITIES WITH COMPETITIVE EVENTS, filed Apr. 9, 2004, by inventors Gregory C. McHale and Carl Maib.

The subject matters of the following commonly assigned U.S. Patent Applications are incorporated herein by reference for all purposes, including the following:
U.S. patent application Ser. No. 10/953,052 entitled METHOD AND APPARATUS FOR CREATING AND CONDUCTING ON-LINE CHARITABLE FUND RAISING ACTIVITIES by inventors Gregory C. McHale and Carl Maib, filed Sep. 29, 2004, attorney docket number C0017/7000;
U.S. patent application Ser. No. 10/953,035 entitled METHOD AND APPRATUS FOR COMBINIGN ITEMS IN AN ON-LINE CHARITABLE AUCTION OR FUND RAISING EVENT, filed Sep. 29, 2004 by inventors Gregory C. McHale and Carl Maib, attorney docket number C0017/7002; and
U.S. patent application Ser. No. 10/953,034 entitled METHOD AND APPRATUS FOR CREATING A CATALOG FOR AN ON-LINE CHARITABLE AUCTION OR FUND RAISING EVENT, filed Sep. 29, 2004 by inventors Gregory C. McHale and Carl Maib, attorney docket number C0017/7003; and
U.S. patent application Ser. No. 11/012,881 entitled METHOD AND APPARATUS FOR CREATING AND CONDUCTING ON-LINE CHARITABLE FUND RAISING ACTIVITIES WITH COMPETITIVE EVENTS, filed Dec. 15, 2004 by inventors Gregory C. McHale and Carl Maib, attorney docket number C0017/7001.

In addition, this application is one of a plurality of US utility applications filed on even date herewith and commonly assigned, the subject matters of which are incorporated herein by reference for all purposes, including the following:
U.S. patent application Ser. No. ______ entitled METHOD AND APPRATUS FOR ASSIGNING VALUE TO AN ITEM DONATED TO AN ON-LINE CHARITABLE AUCTION OR FUND RAISING EVENT by inventors Gregory C. McHale and Carl Maib, attorney docket number C0017/7004;
U.S. patent application Ser. No. ______ entitled METHOD AND APPRATUS FOR CONTRIBUTION BASED PLACEMENT OF DONOR ADVERTISMENTS by inventors Gregory C. McHale and Carl Maib, attorney docket number C0017/7006; and
U.S. patent application Ser. No. ______ entitled METHOD AND APPRATUS FOR CONDUCTING ON-LINE AUCTION EVENTS IN COORDINATION WITH INCENTIVE PROMOTIONS FOR BIDDERS by inventors Gregory C. McHale and Carl Maib, attorney docket number C0017/7007.

### FIELD OF THE INVENTION

This invention relates to on line charitable fund raising events, such as on-line auctions, and the system and techniques for facilitating the creation and execution of such activities.

### BACKGROUND OF THE INVENTION

Publicly accessible wide area networks (WANs), such as the Internet and the World Wide Web, have transformed the manner in which transactions occur. Such transactions include not only business transactions but other activities, such as on-line auctions and charitable fund solicitation and giving. On-line auctions, such as those facilitated by eBay, provide venues for buyers and sellers to transact business in a complex, global virtual marketplace. Charities and not for profit organizations have also tapped the vast market potential of the Internet to reach a wider audience of potential donors. Specifically, web sites such as ePhilanthropyFoundation.com exist to foster the ethical and efficient use of the Internet for philanthropic purposes. Indeed, many charitable organizations allow on line users to donate money directly through a web site to the organization. However, many of the same charitable organizations continue to rely on traditional fundraising events such as telethons and walkathons to raise money at the local community level, without any significant assistance or interaction with on line tools or the local online community.

Accordingly, the need exist for charitable organizations and not for profit entities to conduct on-line fundraising activities in a manner which will gain greater exposure for the organization.

A further need exists for the ability to encourage bidders to bid more than the winning bid than they have submitted.

Yet another need exists for the ability to present the winning bidder of an item in an on-line charitable auction with a suggested round-up amount to increase the benefit to the charity or non-profit organization.

### SUMMARY OF THE INVENTION

The present invention discloses methods, systems, and program code that enable a nonprofit organization to manage its fundraising activities online. The inventive system provides online hosting of fundraising auctions, and auction services such as maintaining donor/bidder registries, bid tracking, processing credit cards, and auction closeout activities. Also disclosed are a plurality of on-line, web-based tools, including tools for: 1) building a customized homepage reflecting the look and feel of the nonprofit organization; 2) building a customized catalog that allows for easy addition of items and pictures; and 3) enhanced email messaging that lets a nonprofit organization reach its constituents. The subject invention provides the tools and facilities for a nonprofit or charitable entity to create either a live or virtual auction event, compile lists of potential donor/bidder participants, create a catalog from donated items, combine individual donated items into aggregate item offerings, and facilitate on line viewing and bidding of the published catalog items in a manner that is efficient and capable of reaching the vast potential of the virtual online community for a particular cause.

According to the invention, an inventive system, computer program and method enables a nonprofit organization, as part of the auction preferences set-up, to optionally include the ability to suggest a ‘round up’ amount to any winning bidder. If enabled, the system will automatically suggest a ‘round up’ purchase price above the winning bid. For instance, ‘round up’ any winning bid to the next zero amount, e.g. for a winning bid of $53, the inventive system suggests a round up to $60. The bidder would be informed where the ‘round up’ amount will be utilized. The bidder has the option to disregard the ‘round up’ price and continue the close-out with the original winning bid.

According to a first aspect of the invention, in a computer system operatively connectable to a network and capable of communicating with one or more other processes operatively connectable to the network capable of hosting an on-line auction with at least one auction item, a method comprises: (A) identifying a winning bid and bidder associated with an auction item; (B) deriving from the winning bid an alternative bid of greater value; and (C) presenting the alternative bid of greater value to the bidder. In other embodiments, (B) further comprises: (B1) identifying a percent increase by which the winning bid will be multiplied; and (B2) computing the alternative bid as the product of the winning bid and the percent increase. In another embodiment, (B) further comprises: (B1) identifying a multiple threshold to which the winning bid will be increased; and (B2) computing the alternative bid as the sum of the of the winning bid and the difference between the winning bid and a next higher multiple value. In a still further embodiment, (B) further comprises: (B1) identifying a percent increase by which the winning bid will be multiplied; (B2) identifying a multiple threshold to which the winning bid will be increased; (B3) program logic for computing a first intermediate value as the product of the winning bid and the percent increase; (B4) program logic for computing a second intermediate value as the difference between the first intermediate and the next higher multiple value; and (B5) program logic for computing the alternative bid as the sum of the of the first intermediate and the second intermediate value.

According to second aspect of the invention, a computer program product for use with a computer system operatively connectable to a network and capable of communicating with one or more other processes operatively connectable to the network and capable of hosting an on-line auction with at least one auction item, the computer program product comprising a computer useable medium having embodied therein program code comprising: (A) program code for identifying a winning bid and bidder associated with an auction item; (B) program code for deriving from the winning bid an alternative bid of greater value; and (C) program code for presenting the alternative bid of greater value to the bidder. In other embodiments, (B) further comprises: (B1) program code for identifying a percent increase by which the winning bid will be multiplied; and (B2) program code for computing the alternative bid as the product of the winning bid and the percent increase. In another embodiment, (B) further comprises: (B1) program code for identifying a multiple threshold to which the winning bid will be increased; and (B2) program code for computing the alternative bid as the sum of the of the winning bid and the difference between the winning bid and a next higher multiple value.

According to a third aspect of the invention, in a computer system operatively connectable to a network and capable of communicating with one or more other processes operatively connectable to the network and capable of hosting an on-line auction with at least one auction item, apparatus comprises: (A) program logic for identifying a winning bid and bidder associated with an auction item; (B) program logic for deriving from the winning bid an alternative bid of greater value; and (C) program logic for presenting the alternative bid of greater value to the bidder. In other embodiments, (B) further comprises: (B1) program logic for identifying a percent increase by which the winning bid will be multiplied; and (B2) program logic for computing the alternative bid as the product of the winning bid and the percent increase. In another embodiment, (B) further comprises: (B1) program logic for identifying a multiple threshold to which the winning bid will be increased; and (B2) program logic for computing the alternative bid as the sum of the of the winning bid and the difference between the winning bid and a next higher multiple value.

According to another aspect of the invention, a system and computer program and method enables a nonprofit organization, as part of the auction preferences setup, to determine whether the process for clearing a rejected credit card or electronic payment transactions is to be resolved automatically or manually, thereby enabling the nonprofit to specify, as part of the auction process, how much time a successful bidder has to correct a payment problem.

According to a fourth aspect of the invention, in a computer system operatively connectable to a network and capable of communicating with one or more other processes operatively connectable to the network capable of hosting an on-line auction with at least one auction item, a method comprises: (A) determining that a transaction for payment of an auction item was not completed; (B) notifying a winning bidder of the auction item that the transaction for payment of the auction item was not completed and indicating a time by which the transaction for payment of the auction item must be completed; and (C) offering the auction item to a next highest bidder for the auction item that has met all auction conditions, if the transaction for payment of the auction item is not completed by the winning bidder before the indicated time.

### BRIEF DESCRIPTION OF THE DRAWINGS

The above and further advantages of the invention may be better understood by referring to the following description in conjunction with the accompanying drawings in which:

FIG. 1 is a block diagram of a computer system suitable for use with present invention;

FIG. 2 is a conceptual block diagram of the elements of the inventive system in a network environment;

FIG. 3 is a conceptual block diagram of the elements of the inventive system in accordance with present invention

FIG. 4 illustrates conceptually the logical organization of the various functional modules of the inventive system in accordance with present invention;

FIG. 5 is a conceptual table illustrating an automatically generated timeline and activity list associated with an auction event in accordance with present invention;

FIGS. 6A-C are screen captures of the graphic user interface of the inventive system in accordance with the present invention;

FIGS. 7A-C are a flow diagram of the processes utilized in the inventive system in accordance with present invention;

FIG. 7D is a conceptual diagram of the object records in memory and the interrelations therebetween in accordance with present invention;

FIGS. 8A-E are screen captures of the graphic user interface of the inventive system in accordance with the present invention;

FIGS. 9A-D are screen captures of the graphic user interface of the inventive system in accordance with the present invention;

FIG. 10 is a flow diagram of the processes utilized in the inventive system in accordance with present invention;

FIG. 11 is a diagram of the processes utilized in the inventive system in accordance with present invention;

FIGS. 12-16 are screen captures of the graphic user interface of the inventive system in accordance with the present invention;

FIGS. 17-21 are conceptual diagrams of the object records in memory and the interrelations therebetween in accordance with present invention;

FIGS. 22-23 are screen captures of a user interface for editing and combining auction items in accordance with present invention;

FIG. 24 is a conceptual diagram of a page displaying one or more items associated with a particular auction registrant are accordance with present invention;

FIG. 25 illustrates various types of web page templates that can be used to generate on line communications in accordance with present invention;

FIG. 26 illustrates a sponsorship web page template in accordance with present invention;

FIGS. 27-28 are flow diagrams of the processes utilized in the inventive system in accordance with present invention;

FIG. 29 is a conceptual diagram of the object records in memory and the interrelations therebetween in accordance with present invention;

FIGS. 30-33 are flow diagram of the processes utilized to coordinate the assignment of reward points to the participant of a -thon event in accordance with present invention;

FIGS. 34-36 are screen captures of a user interface for assignment of reward points to the participant of a thon event in accordance with present invention;

FIGS. 37-38 are screen captures of a user interface utilized to implement a bidder incentive promotion in accordance with present invention;

FIG. 39 is a flow diagram of the processes utilized to implement a bidder incentive promotion in accordance with present invention;

FIG. 40 is a flow diagram of the processes utilized to implement the bidder round-up function in accordance with present invention; and

FIG. 41 is a flow diagrams of the processes utilized to implement the payment processing function in accordance with present invention.

### DETAILED DESCRIPTION

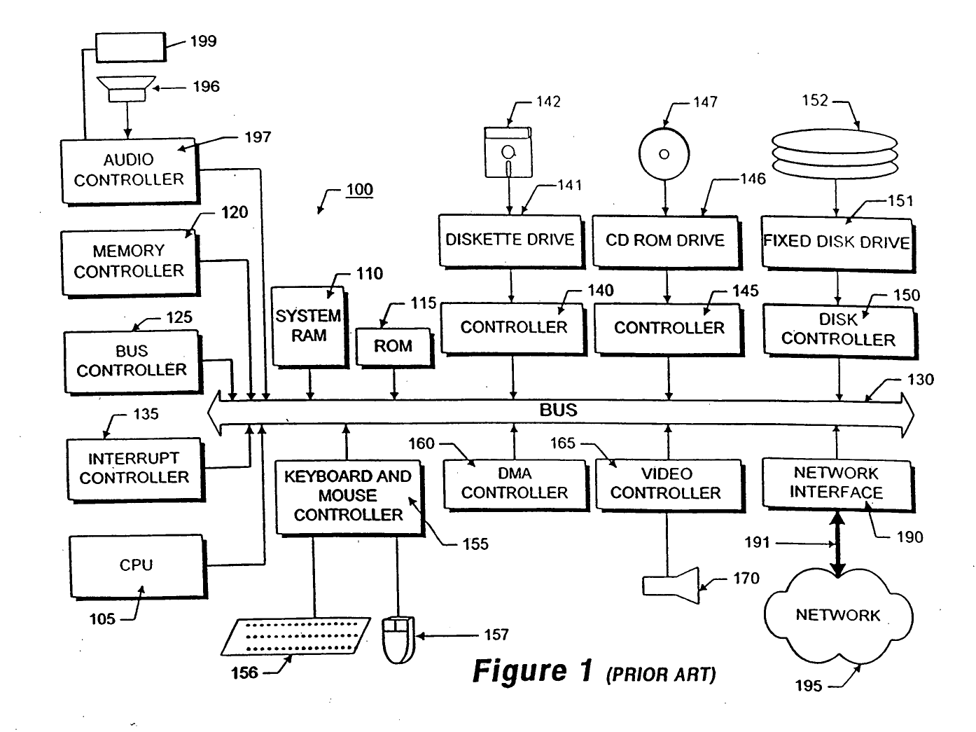

FIG. 1 illustrates the system architecture for a computer system 100, such as a Dell Dimension 8200, commercially available from Dell Computer, Dallas Tex., on which the invention can be implemented. The exemplary computer system of FIG. 1 is for descriptive purposes only. Although the description below may refer to terms commonly used in describing particular computer systems, the description and concepts equally apply to other systems, including systems having architectures dissimilar to FIG. 1.

The computer system 100 includes a central processing unit (CPU) 105, which may include a conventional microprocessor, a random access memory (RAM) 110 for temporary storage of information, and a read only memory (ROM) 115 for permanent storage of information. A memory controller 120 is provided for controlling system RAM 110. A bus controller 125 is provided for controlling bus 130, and an interrupt controller 135 is used for receiving and processing various interrupt signals from the other system components. Mass storage may be provided by diskette 142, CD ROM 147 or hard drive 152. Data and software may be exchanged with computer system 100 via removable media such as diskette 142 and CD ROM 147. Diskette 142 is insertable into diskette drive 141 which is, in turn, connected to bus 130 by a controller 140. Similarly, CD ROM 147 is insertable into CD ROM drive 146 which is connected to bus 130 by controller 145. Hard disk 152 is part of a fixed disk drive 151 which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices such as a pen and/or tablet and a microphone for voice input may be connected to computer system 100 through bus 130 and an appropriate controller/software. DMA controller 160 is provided for performing direct memory access to system RAM 110. A visual display is generated by video controller 165 which controls video display 170. In the illustrative embodiment, the user interface of a computer system may comprise a video display and any accompanying graphic use interface presented thereon by an application or the operating system, in addition to or in combination with any keyboard, pointing device, joystick, voice recognition system, speakers, microphone or any other mechanism through which the user may interact with the computer system.

Computer system 100 also includes a communications adapter 190 which allows the system to be interconnected to a local area network (LAN) or a wide area network (WAN), schematically illustrated by bus 191 and network 195.

Computer system 100 is generally controlled and coordinated by operating system software, such as the WINDOWS NT, WINDOWS XP or WINDOWS 2000 operating system, available from Microsoft Corporation, Redmond Wash. The operating system controls allocation of system resources and performs tasks such as process scheduling, memory management, and networking and I/O services, among other things. In particular, an operating system resident in system memory and running on CPU 105 coordinates the operation of the other elements of computer system 100. The present invention may be implemented with any number of commercially available operating systems including OS/2, AIX, UNIX and LINUX, DOS, etc. One or more applications 220 may execute under control of the operating system. If operating system 210 is a true multitasking operating system, multiple applications may execute simultaneously.

In the illustrative embodiment, the present invention may be implemented using object-oriented technology and an operating system which supports execution of object-oriented programs. For example, the inventive code module may be implemented using the Java programming environment from Sun Microsystems, Redwood, Calif.

The Java programming language is rapidly emerging as the preferred OOP language for Internet and cross platform use because Java programs consist of bytecodes, which are architecture and operating system independent and can be sent over the Internet and other networks. The bytecode is actually executed on a particular platform by means of a “virtual machine” (VM) which allows a Java program to be run on any platform, regardless of whether the Java program was developed on, or for, the particular platform which attempts to run the Java program. Java bytecodes which arrive at the executing machine are interpreted and executed by the embedded VM.

A complete Java program is known as an application, while a segment of Java code, which does not amount to a full application, but is reusable, is referred to as an “applet”. Java also includes a component model where a component is a self-contained object with a predefined interface. A component within Java is referred to as a “bean,” and includes such a defined interface. Java beans are used within applets and applications and a programmer need not know the internal structure of the Java bean to use it, he need only know the interface. Since Java is well-suited to operation over networks, the following description of the illustrative embodiment is directed toward the Java programming language. However, it will be obvious to those skilled in the art that the invention could be implemented for other OOP languages as well, e.g. C++.

As will be understood by those skilled in the art, Object-Oriented Programming (OOP) techniques involve the definition, creation, use and destruction of “objects”. These objects are software entities comprising data elements, or attributes, and methods, or functions, which manipulate the data elements. The attributes and related methods are treated by the software as an entity and can be created, used and deleted as if they were a single item. Together, the attributes and methods enable objects to model virtually any real-world entity in terms of its characteristics, which can be represented by the data elements, and its behavior, which can be represented by its data manipulation functions. In this way, objects can model concrete things like people and computers, and they can also model abstract concepts like numbers or geometrical designs.

Objects are defined by creating “classes” which are not objects themselves, but which act as templates that instruct the compiler how to construct the actual object. A class may, for example, specify the number and type of data variables and the steps involved in the methods which manipulate the data. When an object-oriented program is compiled, the class code is compiled into the program, but no objects exist. Therefore, none of the variables or data structures in the compiled program exist or have any memory allotted to them. An object is actually created by the program at runtime by means of a special function called a constructor which uses the corresponding class definition and additional information, such as arguments provided during object creation, to construct the object. Likewise objects are destroyed by a special function called a destructor. Objects may be used by using their data and invoking their functions. When an object is created at runtime memory is allotted and data structures are created.

Network Environment

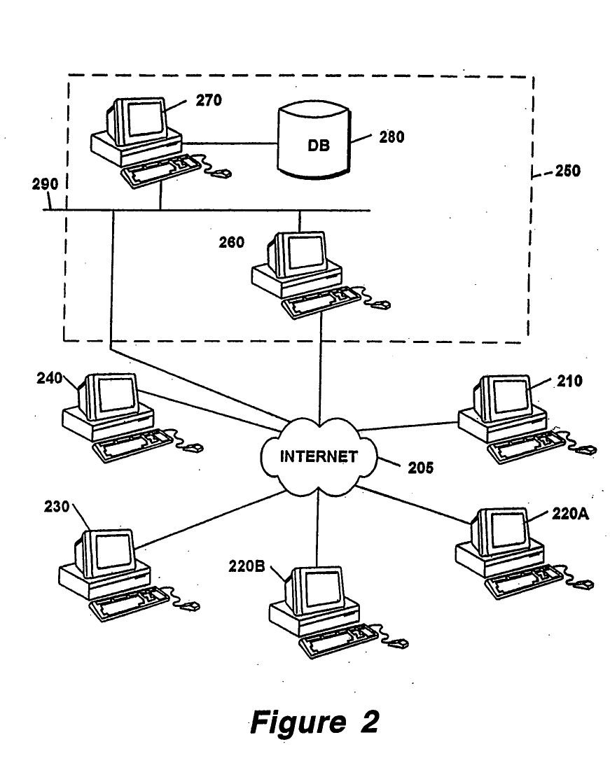

Referring to FIG. 2, illustrates conceptually a network topology in which the auction system 250 of present invention may be implemented. Specifically, a publicly accessible, wide area network topology, such as the Internet, labeled 205, operatively couples a plurality of systems, and their respective executing process, including bidder/donor processes 220A-B, sponsor web server 230 and credit server 210, charitable client system 240, and system 250, highlighted in phantom, which further comprises auction web server 260, database server 270 and database 280 interconnected over a private network 290, as illustrated. All of the system illustrated in FIG. 2 may execute on hardware platforms which may be similar to that described with reference to FIG. 1.

In the illustrative embodiment, auction web server 260 performs the functions of a traditional web server enabling access to one or more web pages by bidder/donor processes 220A-B connected to Internet 205. One or more of the pages accessible on auction web server 260 may contain address information in the form of a Hypertext Markup Language (HTML) tag which may be downloaded over the Internet 205 to a browser process executing on any of the system 210-240.

In the illustrative embodiment, sponsor web server 230 also may perform the functions of a traditional web server enabling access to one or more web pages by bidder/donor processes 220A-B connected to Internet 205. One or more of the pages accessible on sponsor web server 230 may contain address information in the form of a Hypertext Markup Language (HTML) tag which may be downloaded over the Internet 205 to a browser process executing on any of the other system in the network.

User/bidder systems 220A-B may be implemented using a computer architecture similar to that illustrated with reference to FIG. 1. The hardware platform may include a network interface, such as a Ethernet LAN card or other LAN-based TCP/IP network connector, for interfacing system 220 with the Internet, and executes a computer operating system, such as Windows NT 4.0, available from Microsoft Corporation, Redmond, Wash. Execution under the control of operating system is web browser application which may be implemented with any number of commercially available Java enabled web browser that provide standard JavaScript support, such as NetScape Navigator version 4.5 and above, commercially available from America On-line, Reston, Va.; Microsoft Internet Explorer version 4.0, commercially available from Microsoft Corporation, Redmond, Wash. Alternatively, the user system browser may execute in conjunction with the collaborative communication program, such as Sametime, commercially available from International Business Machines Corp., or Groove, commercially available from Groove Networks Inc., Beverley, Mass., or other collaborative communication programs that are Java enabled and have standard JavaScript support.

Credit server 210 may be implemented using a computer architecture similar to that illustrated with reference to FIG. 1. Credit server 210 is typically part of a publicly accessible Internet maintained by a bank or other electronics funds transfer facility or institution, such as those run by MasterCard or Visa and contains the appropriate server applications and database software for clearing in conducting electronic transactions in that are understood by those recently skilled in the arts.

System Organization

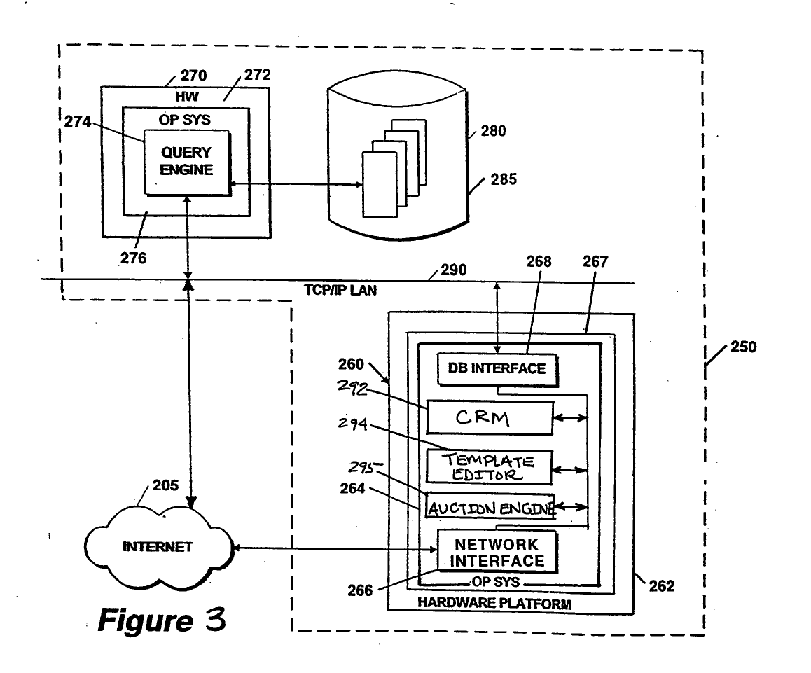

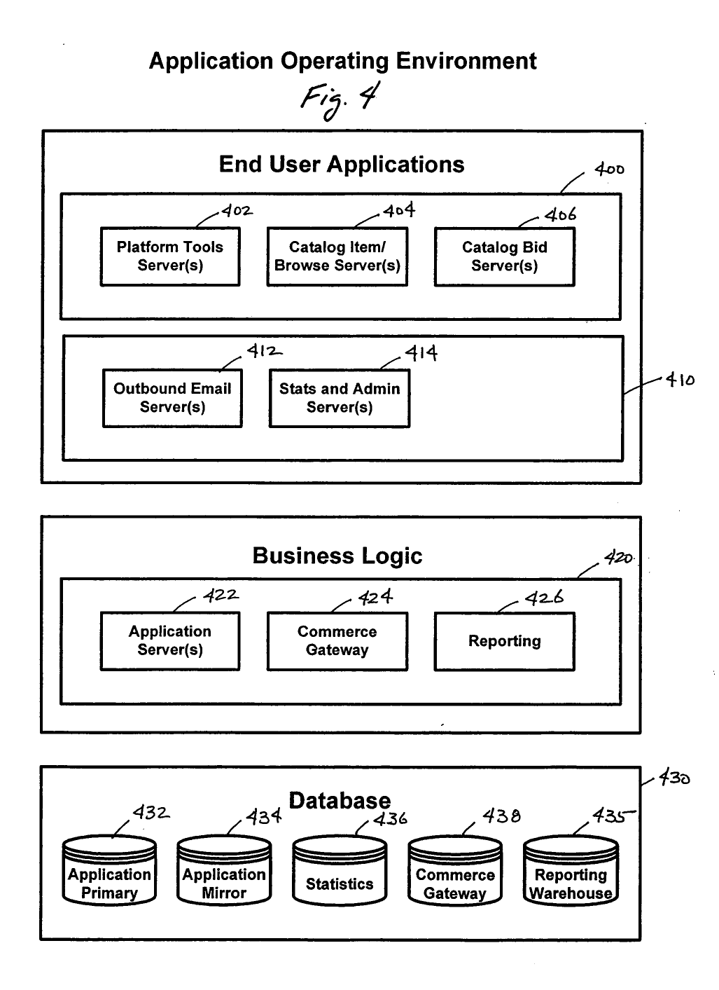

Referring to FIG. 3, a conceptual block diagram of the auction system 250 in accordance with the present invention is illustrated. The system 250 comprises a auction web server 260, a database server 270 and database 280, and an optional electronic mail server 288 operatively coupled, in the illustrative embodiment, via a private network 292, e.g., a packet-switched network, such as a Local Area Network executing the TCP/IP protocol.

Private network 290 may couple auction web server 260 to both an optional electronic mail server (not shown) and to a firewall server (not shown). In the illustrative embodiment of the present invention, electronic mail server 288 may be implemented as a server executing an application program in accordance with the Post Office Protocol version 3.0 (POP3), such server capable of receiving and sending electronic mail in a manner understood by those skilled in the arts. In an alternative embodiment, the optional electronic mail server and web server 260 may be implemented with applications which execute on the same computer system. The firewall server may be implemented as a server or network appliance executing any of a number of commercially available network security applications which prevent unauthorized access to private networks in a manner understood by those skilled in the arts. The firewall server is typically connected to Internet 205, via a T1 line, or other connection such as a frame relay connection.

Web Server

Web server 260 may be implemented using a hardware platform similar to that illustrated with reference to FIG. 1. Executing under the control of an operating system are one or more functional code modules necessary for auction web server 260 to perform its appropriate functions. Specifically, web server 260 executes Constituency Relation Management (CRM) module 292, template editor module 294, and auction services engine 295, as illustrated. The algorithmic processes described herein may be performed by web server 260, including any of the Constituency Relation Management (CRM) module 292, template editor module 294, and auction services engine 295, and may be functionally delineated among the plurality of sub components illustrated in FIG. 4.

Referring to FIG. 3, web server 260 presents web pages to the network user and controls the flow of information to/from database server 270. In the illustrative embodiment, the functions performed by web server 260, and Constituency Relation Management (CRM) module 292, template editor module 294, and auction services engine 295, may be implemented either with object-oriented programming techniques using the appropriate class definitions and objects for values within the database, or, alternatively, using a non-object oriented language such as the C++ programming language.

Web server 260 retains in memory one or more “pages” which collectively may comprise a web site used to visually present the information on the pages. One or more of the pages accessible on web server 260 may contain address information in the form of a Hypertext Markup Language (HTML) tag which may be downloaded over the Internet 205 to a browser process executing on any of the other computer systems connected to the network. Such HTML tag may include the IP address or E-mail address associated with the web site.

Upon connection to web server 260, either directly or through a hyperlink from the website of a vendor client, a network user is presented with a graphic user interface. The graphic user interface includes a number of web pages which are resident on web server 260 and through which the network user may navigate. The web pages include a number of menus and dialog boxes which allow the network user to interact with the web server 260. The sample web pages illustrated herein include various highlight options and dialog boxes through which a network user may interact with web server 260.

Web server 260 functions to render pages to a network user connected to the web server 260 and to pass data received from a network user to database through the appropriate Application Program Interfaces (APIs). In the illustrative embodiment, the web server 260 may utilize a plurality of Visual Basic, Java script files and/or Java applets to create active web pages. Web server 260 may include a database interface (not shown) which functions as the interface between web server 260 and database server 270. Such database interface may be implemented via ODBC, Remote Procedure Call libraries or other similar technologies which enables the interface to make remotely access the database server 270 and to service calls received from database server 270.

Data Base Architecture

In the illustrative embodiment, database server 270 and database 280 may comprise a hardware platform and an operating system capable of executing one of a number of commercially available database products. In the illustrative embodiment, hardware platform may be implemented with a computer system similar to that described with reference to FIG. 1. The operating system may be implemented with the Windows NT 4.0 product from Microsoft. The database product may be implemented with Microsoft SQL Server Version 7.0, also commercially available from Microsoft Corporation. The structure of information, including the data fields, records, tables which comprise database 280 are described hereinafter and may also be designed using Microsoft SQL Server Version 7.0.

Query engine 274 receives information from web server 260 in the form of a query and supplies the query to database 280. Database server 270 and database 280 may communicate using SQL standard database query language. The SQL standard is published by the American National Standards Institute (ANSI). The database query engine which is integrated into database server filters the queries received from web server 260, such filters useful in focusing or customizing the scope of a database query. The information retrieved from database 280 may be forwarded by database server 270 to web server 260 using any number of know techniques such as remote procedural call libraries, as that previously described.

Application Operating Environment

Referring to FIG. 4, the subcomponents that perform the necessary algorithmic processes of the inventive system are logically divided in application operating environment that includes end-user applications 400, specialty front end applications 410, business logic applications 420, and database applications 430. The end-user applications 400 comprise a series of server applications that provide functionality to bidder/donor processes and charitable client processes (auction committee) and comprise platform tools server(s) 402, catalog/item browser server(s) 404, and catalog bid server(s) 406. The specialty front end applications 410 comprise a series of server applications that provide specific functionality for system administration and include outbound electronic mail server(s) 412 and statistics and system administration server(s) 414. The business logic applications 420 comprise a series of server applications that provide functionality for operating in a network environment including application server(s) 422, commerce gateway application server(s) 424, and reporting server(s) 426. The database applications 430 comprise a primary catalog database 432, a mirror catalog database 434, and electronic mail stack database 436, a gateway transactions database 438, and a reporting database 435.

In the illustrative embodiment, end-user applications 400, specialty front end applications 410, business logic applications 420, may execute on auction web server 260, while database applications 430 may execute on database server 270 in conjunction with database 280, as illustrated in FIG. 3. Alternatively, for more sophisticated systems, any of the end-user applications 400, specialty front end applications 410, business logic applications 420, and database applications 430 may execute or their own separate system, accessible through either public and/or private networks. In this matter, a particular system may have a dedicated application function. In addition, multiple systems may perform the same function, for example there may be multiple servers each performing catalog bid receipt and recording functions. In other embodiments, several application functions may execute on the same system. In the case of database applications, the database is may reside on separate systems or may be implemented in a distributed matter, with selected portions of a particular database or database(s) residing within the same or different systems but logically separated therefrom. Such alternative implementations provide more scalable and redundant functionality across the network environment. As indicated previously, any of the above-mentioned systems may reside within private network, an intranet, extranet, or on the Internet or other publicly accessible networks, with or without protection of a dedicated firewall server or appliance.

The reader will appreciate that any of the object records described within the occasion may be stored in one or more of the databases illustrated in the figures, or, alternatively, in a redundant, distributed or remote access manner without parting from the spirit and scope of the invention described herein. Similarly, the data and methods associated with any single object record may be further divided into sub classes to achieve the same results as those described herein. Similarly, the algorithmic processes described herein may be performed by any number of program code processing modules illustrated in the figures, including any of the Constituency Relation Management (CRM) module 292, template editor module 294, and auction services engine 295 in conjunction with database server 270, in addition to the logical/functional delineations described in the illustrative embodiment.

Having described the system hardware, network and logical organization of the inventive system, a description of individual inventive algorithms and techniques is set forth below with respect to the individual flowcharts, conceptual diagrams and graphic user interfaces of Figures.

The Auction/Event Scheduler

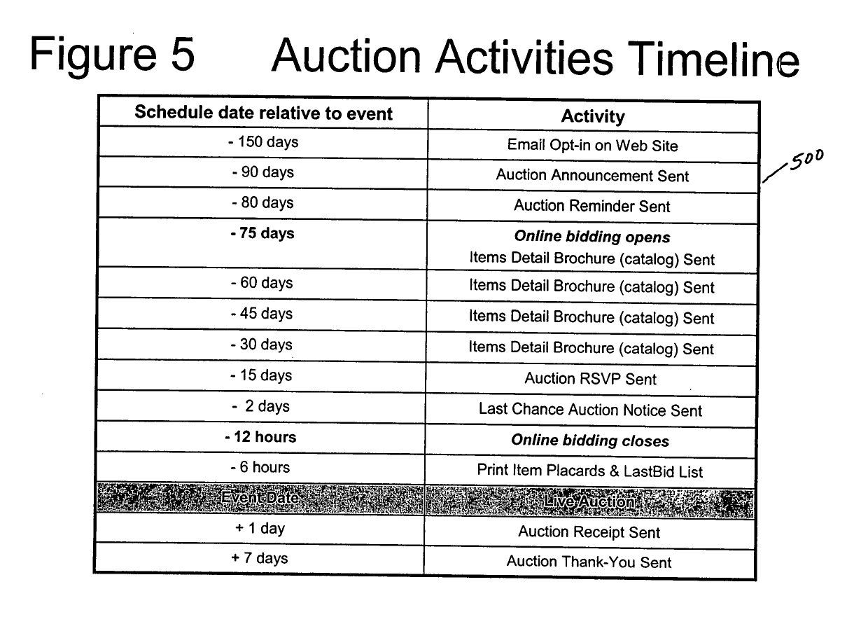

According to one aspect of the invention, the auction committee for a charitable client is able to specify a date for either a physical or virtual auction and have the inventive system generate a calendar of future events and dates relevant to the auction. Specifically, a charitable client user enters a date for a physical or virtual auction. Based on the designated date, the inventive system 1) creates a series of tasks, such as auction announcement, auction RSVP, first catalog publication, etc.; 2) suggests dates by which those tasks should be completed; and 3) a series of automatically generated electronic mail are sent notifying the auction committee, or other third parties in advance of the completion date for each task so that action can be taken to send the communications to the appropriate parties. With the inventive system 250, the list of activities and suggested dates, as illustrated in FIG. 5, can be modified to suit the needs of the nonprofit or charitable client. As illustrated in conceptual diagram 500 of FIG. 5, a number of activities occur days or hours before the auction event as well as afterwards. When a single date is changed the charitable client user can have the system 250 adjust all the subsequent dates accordingly or only change the single date. The charitable client user can ‘reset’ the dates to the original via a reset button, if desired. The generation of electronic mail is adjusted accordingly to the new dates. When the communication is sent to the electronic mail list an acknowledgement electronic mail is delivered to the auction committee with the success measurements and next steps indicating the total number of electronic mail sent, the total number of electronic mail successfully received, the next steps in the process.

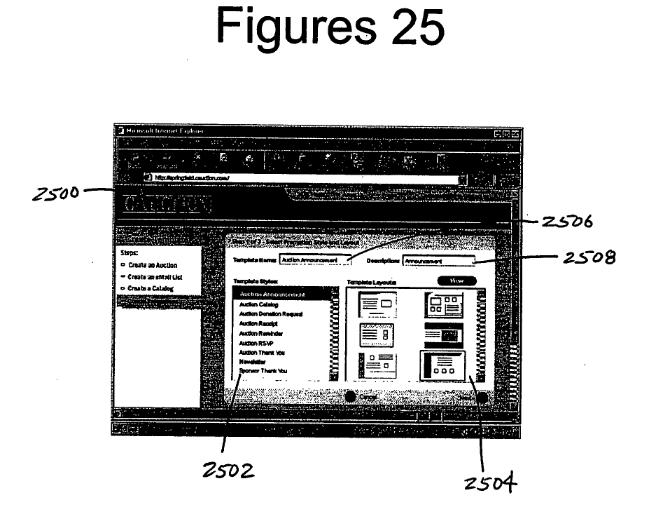

Alternatively, the charitable client user may also request that that the system automatically sends the communications without intervention. In such instance the system 250 would prompt the charitable client user to assign one of the templates described herein and as illustrated in FIG. 25, for communications and then assign one or more electronic mail lists to the communication. At a predetermined number of days after the passing of the desired date, where the number of days is defined by the assistance server application 432, if certain database conditions which indicate that the step has taken place do not exist, the database will 1) populate a non-public web page that will send code to the CRM module 292 which will, in turn, create a service “case” or event in the CRM system that will alert the staff of system 250 to make contact with the charitable client user to assist him/her/them in completing the overdue task, typically by sending the customer an electronic mail offering assistance in completing the task.

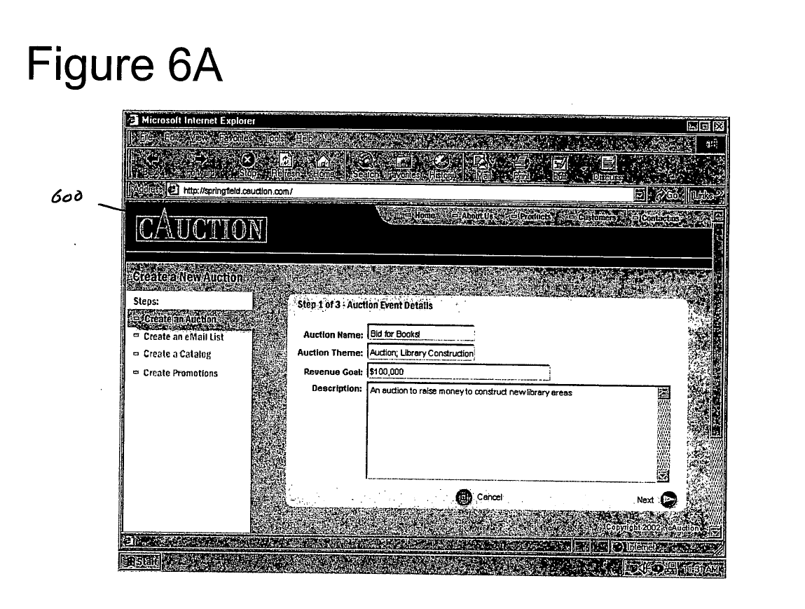

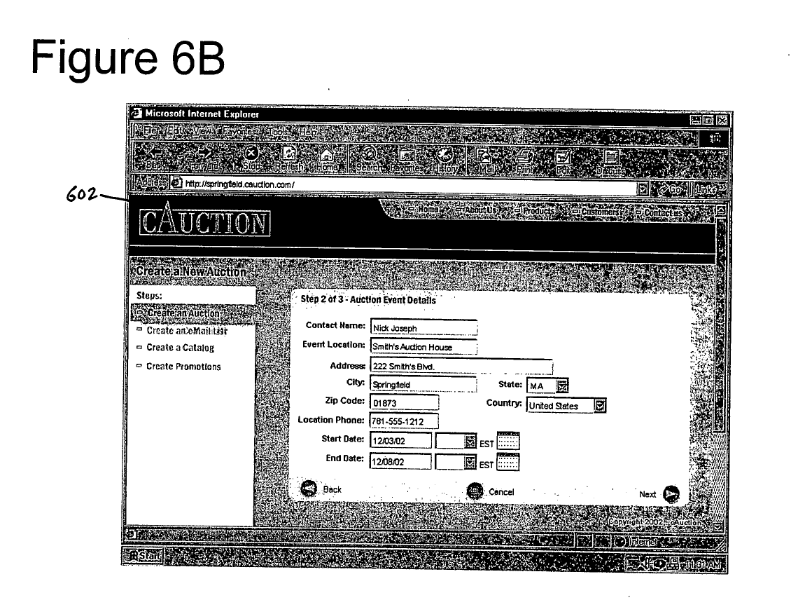

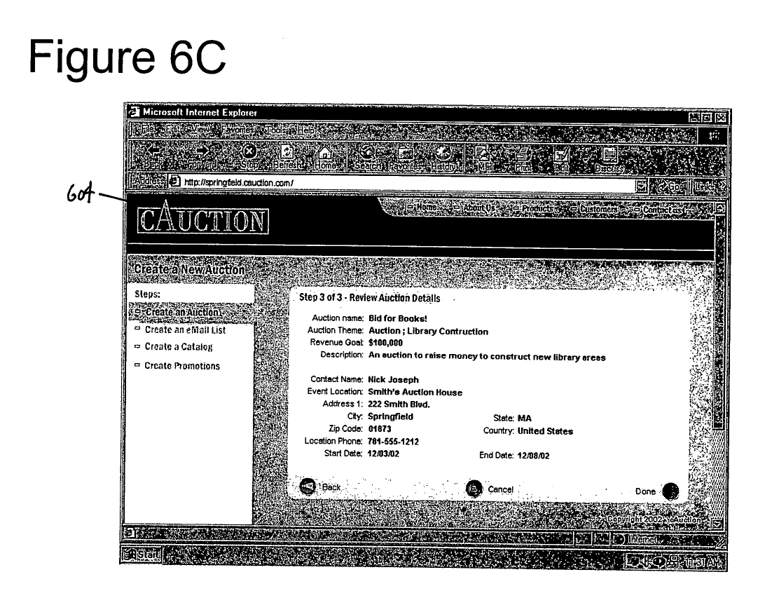

FIGS. 6A-C illustrate conceptually the graphic user interface(s) 600, 602 and 604, respectively, and algorithmic processes associated with the process of creating an auction event in accordance with the system 250 of the present invention. The components which comprise these user interface(s) are typically stored as objects or components which collectively comprise one of the templates to stored in database 432 and modifiable using template editor 294. These templates utilize the windowing functionality in the local operating system. For UNIX-based systems, X-windows functionality may be utilized.

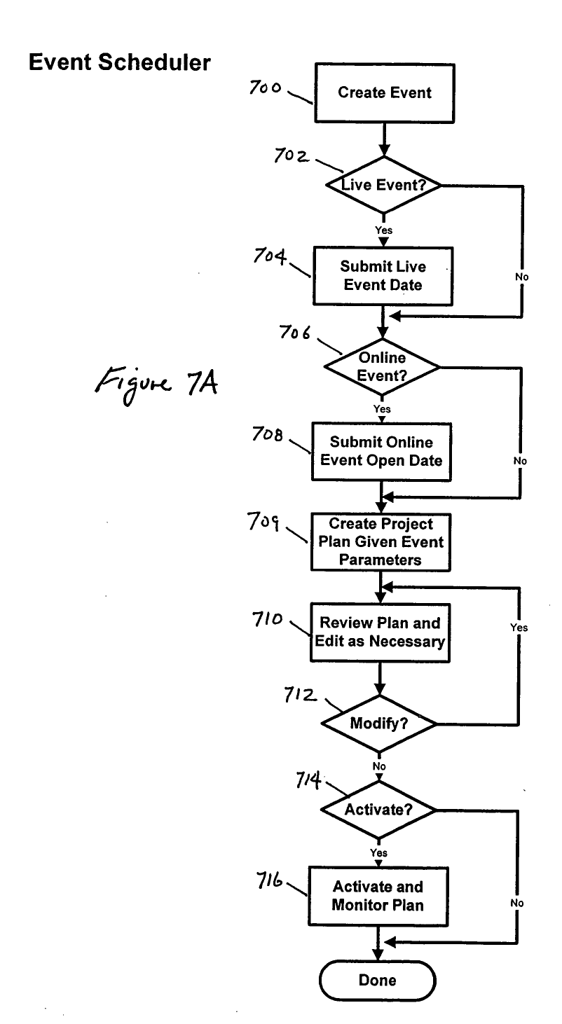

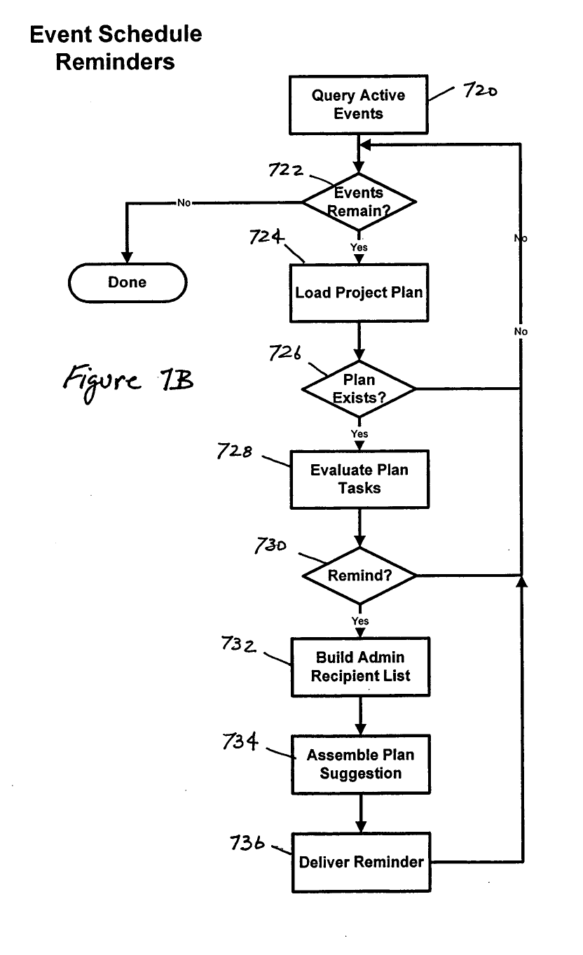

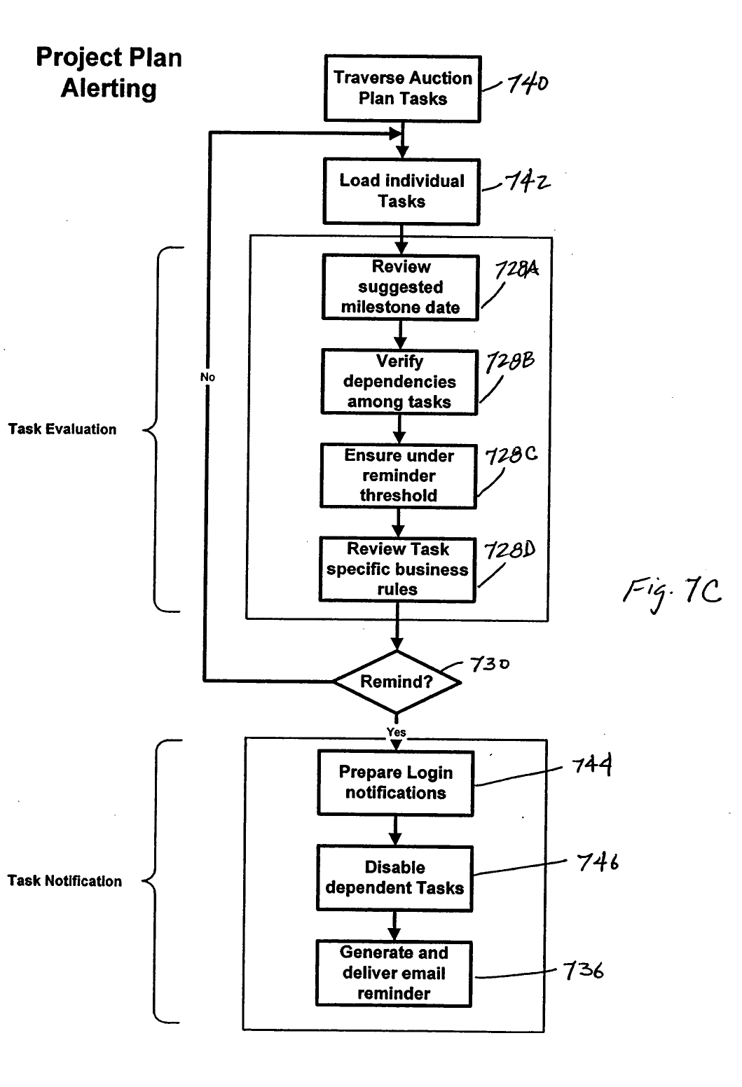

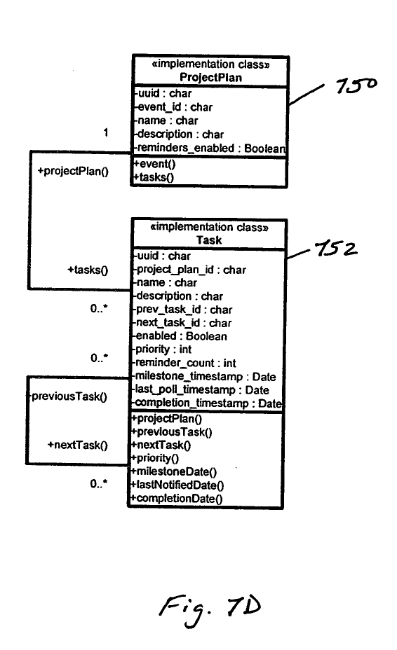

FIGS. 7A-C are flowcharts of the algorithmic process utilized to create an auction event. These processes are typically performed with a charitable client process connected to system 250 and interacting with the web pages and templates as illustrated in FIGS. 6A-C. Referring to FIG. 7A, the charitable client user, who is typically a member of an auction committee for the nonprofit organization or charity, selects the Create an Auction tab from the web pages illustrated in FIG. 6A. The charitable client user specifies the auction name, a theme, revenue goal and description in the dialog boxes of the template illustrated in FIG. 6A and process block 700. Next, if the charitable client user specifies a live event, an event date is submitted, as illustrated by decision block 702 and process block 704. Alternatively, if an on-line event was specified, and event open date is submitted, as illustrated by decision block 706 and process block 708. Next, the various event parameters are submitted using the dialog boxes, as illustrated by process block 709. These parameters can include any of a contact name, event location address, phone number, events start date and event end date, as illustrated in the template of FIG. 6B. The CRM module 292 stores all the event parameters and displays them through web page similar to that illustrated in FIG. 6C, allowing the charitable client user to review and modify any of the parameters, as illustrated by process block 710 and decision block 712. Once the auction details have been reviewed and accepted the auction is activated by submitting the data to the system as an auction event object, as illustrated by decisional block 714 and process block 716.

Having created an auction object, the system 250 generates the list of activities/tasks and suggested dates, as illustrated in FIG. 5. FIG. 7B is a flowchart of the algorithmic process utilized to generate the event reminders and associated communications listed in FIG. 5. First, the auction services engine 295 queries an auction object representing an active event, as illustrated in process block 720. Next, a determination is made if any events are remaining, as illustrated by decisional block 722. If no events are remaining, the process terminates otherwise, the project plan associated with the created auction object is loaded, as illustrated by process block 724. If a project plan exists, as illustrated by decisional block 726, an evaluation is performed of the tasks required, as illustrated by process block 728. In illustrative embodiment, auction services engine 295, and the subcomponent applications associated therewith, evaluates the project plan associated with the active event to determine if any reminders are required at the current time. This process typically entails the auction services module reviewing whether a particular task has been performed, as monitored by the system 250 or as indicated by the charitable client, within a predetermined number of days from the intended task completion date, as illustrated by decisional block 730. For example, referring to FIG. 5, assuming that an announcement of a live auction is occurring 90 days prior to the event date, system 250 will determine whether auction announcements have been sent. If not, engine 295 and will generate an administration recipient list from the parties, typically the auction committee, associated with the auction object, as illustrated by procedural block 732. Next, depending on the nature of the incomplete task and the reminder necessary, engine 295 will assemble a list of one or more project plan recommendations, as illustrated by procedural block 734. Finally, the generated recommendation(s) are delivered to the contact name associated with the auction object and any other recipients designated by the charitable client via electronic mail or other forms of communication including, but not limited to, wireless communications, cell phones, pagers, Internet telephony, PSTN per telephony, Internet messaging, and even physical mail, as illustrated by process block 736. Thereafter, the process repeats.

FIG. 7C is a flowchart of an alternative algorithmic process to that illustrated in FIG. 7B. First, if a project plan exists, any remaining tasks of the project plan are traversed, as illustrated by procedural block 740, and loaded for review, as illustrated by procedural block 742. Next, the remaining evaluation plan tasks are evaluated, similar to procedural block 728 of FIG. 7B. Specifically, an evaluation is performed of the tasks required, as illustrated by process block 728. This process entails evaluating every task against a set of common and specific business roles, as illustrated by procedural block 728A Milestone dates have been previously calculated during the setup of the event record. Next, dependencies among tasks are assumed and verified, as illustrated by procedural block 728B. Thereafter, a determination is made whether the number of times a reminder alert is sent is below a predetermined threshold, as illustrated by procedural block 728C, if additional reminder alert instances remain, engine 295 reviews a task specific business rule as well as possible general business roles associated with the particular task to determine an appropriate recommended response from his illustrated by procedural block 728D. Accordingly, procedural block's 728A-D comprise the process utilized to perform task evaluation. If a recommendations/reminder is to be sent, engine 295 prepares the necessary login notifications so that the reminders are visible upon successful login to the system 250, as illustrated by procedural block 744. In the illustrative embodiment, various tasks within the project plan are sequentially dependent upon one another. Is contemplated that if a primary task upon which dependent tasks has not yet been completed, the alerts/recommendations associated with the dependent tasks are disabled his illustrated by procedural block 746. This process allows the custom electronic mail to be generated suggesting that expects to complete in the as yet unfinished milestone and not delay other dependent tasks. For example, if the project plan schedule calls for building up the constituency list, and, after a review of the appropriate records within one or databases by engine 295 there is a determination that there has been no activity in this area, then an electronic mail reminder will be sent along with a best business practices recommendation on how to do so, rather than the subsequent tasks of generating an email which may suggest building the email list, asking for item donations and sending out the first catalog newsletter. This process may be done as often as the tasks and project plan schedule call for. Finally, the electronic communications are generated in delivered via e-mail or other medications mediums, as illustrated by procedure block 736.

Project Plans are calculated and maintained for each organization event. The Project Plan contains a list of recommended, best practice tasks that should be followed to ensure the success of the event. Object records within memory are utilized to maintain data related to both the project plan and all of the associate tasks, as described with reference to FIG. 7D. Project Plan details are maintained in a Project Plan record 750 and one or more task records 752 can exist for each Project Plan record 750.

In the illustrated embodiment, Project Plan record 750 comprises the following variables:
uuid
event_id
name
description
reminders_enabled

The nature of the data type used to implement each variable is illustrated in FIG. 7D. In Project Plan record 750 the uuid data is a unique universal identifier and may be implemented with a multiple bit field of alphanumeric data. The uuid data serves as a primary key to identify a project plan. The event_id variable identifies the corresponding Event Record 1700, described hereafter, to which the live event record corresponds. The name and description variables describe the name and nature of the project plan, respectively. The reminders_enabled variable enables reminders to be sent as described herein. In addition, the Project Plan record 750 has at least a +event( ) method and a +tasks( ) method that can be used to call the event with which they project plan is associated as well as one or more tasks associated with the project plan.

In the illustrated embodiment, Tasks record 752 comprises the following variables:
uuid
project_plan_id
name
description
prev_task_id
next_task_id
enabled
priority
reminder_count
milestone_timestamp
last_poll_timestamp
completion_timestamp

The nature of the data type used to implement each variable is illustrated in FIG. 7D. In task record 752 the uuid data is a unique universal identifier and may be implemented with a multiple bit field of alphanumeric data. The uuid data serves as a primary key to identify a task. The project_plan_id variable identifies the corresponding project plan, to which the task record corresponds. The name and description variables describe the name and nature of the task, respectively. The prev_task_id and next_task_id variables identify respectively the previous and next tasks, in a sequence of which the current task as part. The milestone_timestamp, last_poll_timestamp, completion_timestamp variables identify, respectively, the recommended milestone time, the time the task record was last poll by engine 295, and the time the task was determined by engine 295 to be completed. The priority and reminder_count variables contain numeric values, respectively, representative of the threshold number and number of times a reminder has been sent. The enabled variable indicates whether the task has been enabled to allow subsequent dependent tasks to be poll and completed. In addition, the task record 752 has at least seven method associated therewith including the +projectplan( ), +previoustask( ), +nextTask( ), +priority( ), +milestoneDate( ), I+astNotifiedDate( ), and +completionDate( )methods that can be used to call the project plan and the previous and next tasks in a sequence of which the current task as part.

The Project Plan recommends a target milestone for each task in the plan. Engine 295 monitors the records associated with the recommended tasks and sends out reminders when tasks are not being completed as the Project Plan suggests. Data fields within the test records enable auction administrators to chose whether or not to receive electronic reminders. When enabled, electronic reminders are sent automatically by the application when milestones are missed. When disabled, similar messages are displayed on the administrator's a dashboard summary whether page upon successful login. Engine 295 tracks how many times administrators have been reminded of a particular task, along with the timestamp for the last reminder. When completed, the completion timestamp is maintained and all dependent subsequent tasks are enabled using the data structures implemented within records 752. Tasks can be distinct operations, or can be sequenced to have prerequisite and follow-up tasks. In the illustrative embodiment, subsequent tasks are disabled until the prerequisite task is complete. A task with no prerequisite can include the setup of an electronic mail list or setting up another administrator to assist in the management of the event. Sequenced and linked tasks can include the initial event notice, catalog update and last chance to bid emails.

Creating a Community

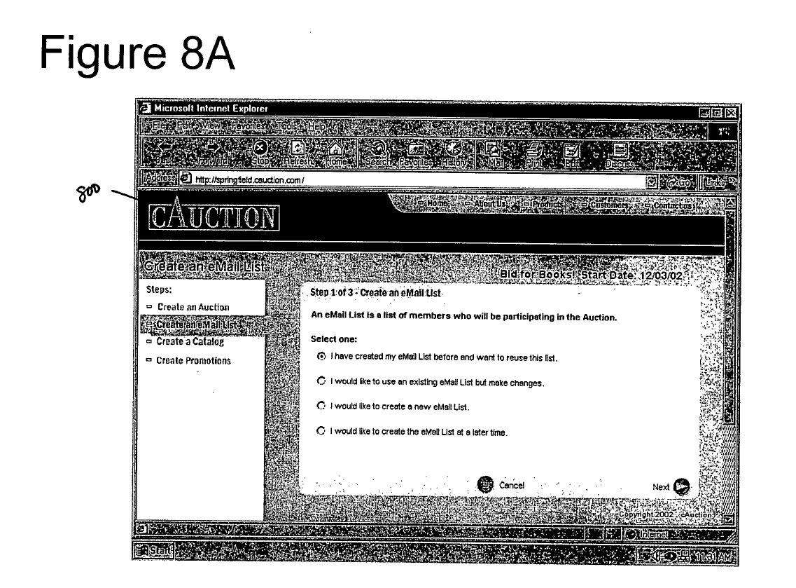

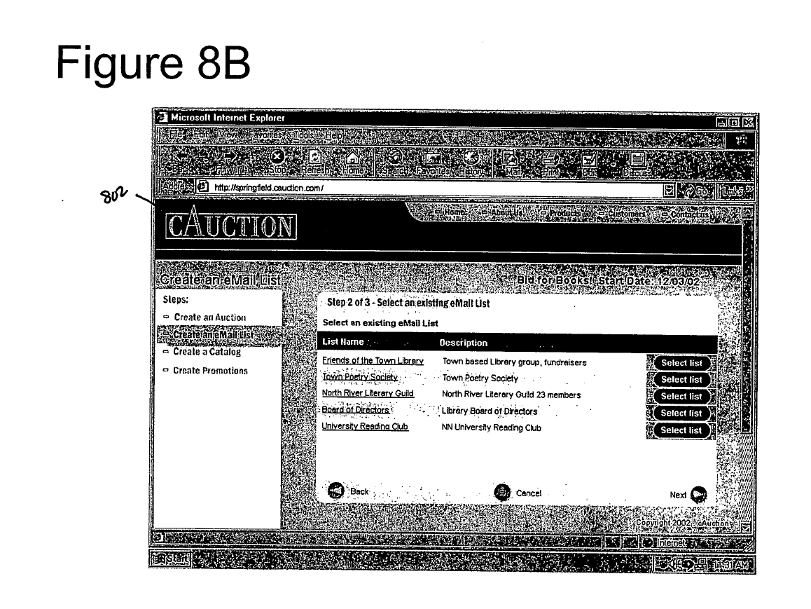

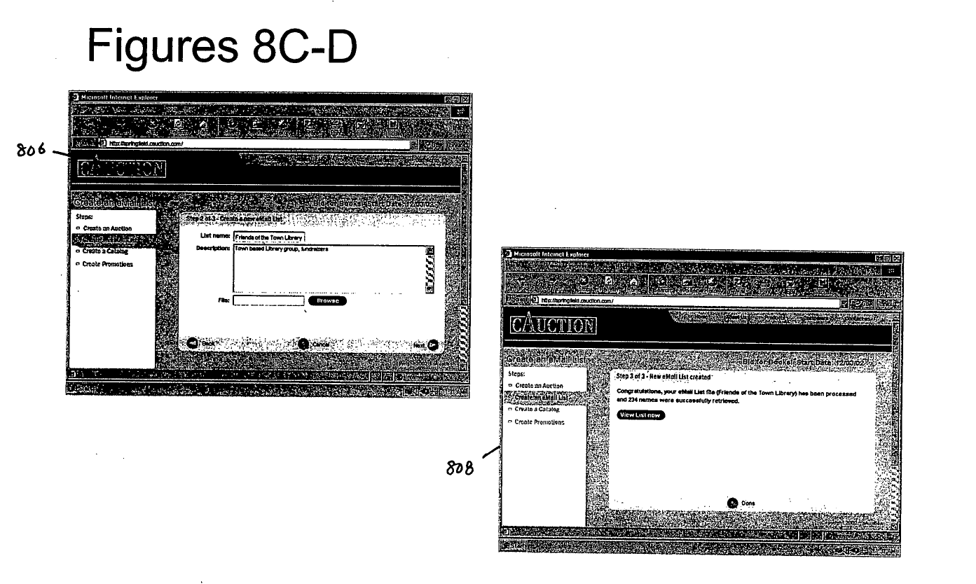

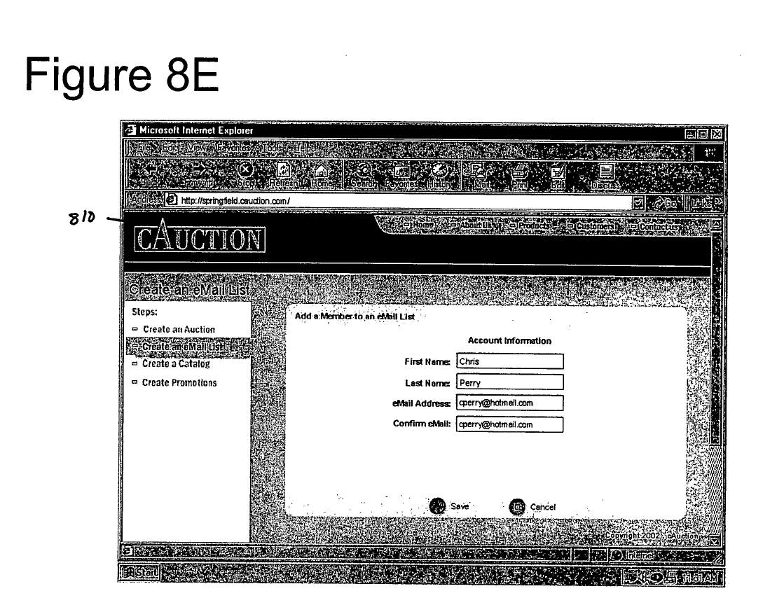

In addition to the finding the auction event using the templates and graphic user interfaces presented by system 250, the charitable client may also define the their constituency or community of potential donors for the auction event. FIGS. 8A-E illustrate conceptual graphic user interfaces of the web pages 800, 802, 804, 806, 808, 810, respectively, in accordance with the inventive system, as would be displayed to a charitable client who is utilizing the services of the inventive system. In FIG. 8A, the charitable client user, who is typically a member of an auction committee for the nonprofit organization or charity, selects the “Create an eMail List” tab from the web page illustrated and designates that a previously created electronic mail list is to be used. In FIG. 8B, a listing of existing electronic mail list is presented with selection tabs for the charitable client user to select which of the lists to associate with the auction. Upon selection of a preexisting list or the completion of a new list, the dialog box illustrated in FIG. 8C will be displayed. Alternatively, if in the user interface of FIG. 8A, the charitable client had selected the third option to create a new electronic mail list, the user interface illustrated in FIG. 8D would be displayed. If in the user interface of FIG. 8A. the charitable client had selected the second option to modify an existing electronic mail list, the user interface illustrated in FIG. 8E would be displayed. In this manner, the online constituency for the auction event may be generated efficiently.

Community Builds Electronic Mail Lists

According to another aspect of the invention, system 250 enables a charitable organization to send an electronic mail based communication to their constituency (constituents) to ask for electronic mail referrals (contacts) or, alternately, to incorporate a ‘community email button’ on all web pages and communications that allows constituents to add contacts. A constituent selects a web link, either embedded in the email or as a result of clicking on the community email button, to transfer to a data entry page where a contacts' information (name, email, etc.) can be captured. The inventive system automatically generates a personalized electronic mail that includes the constituent name, to the submitted contact enabling the contact to opt-in to the nonprofit's email database. The contact may opt-in, at the discretion of the nonprofit, for different email communications (auction only, general communications, further fund-raising solicitations, etc.). After the contact has opted in, the system automatically informs, via electronic mail, the constituent that one of their contacts has opted in. The constituent, via a web-based ‘dashboard’, may view the status of each contact that they have submitted.

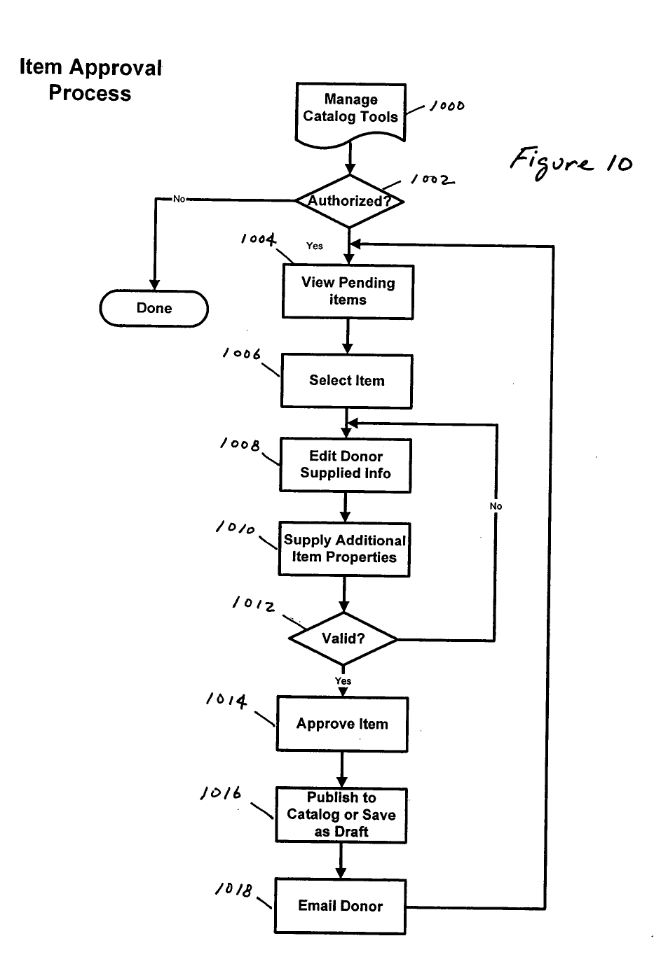

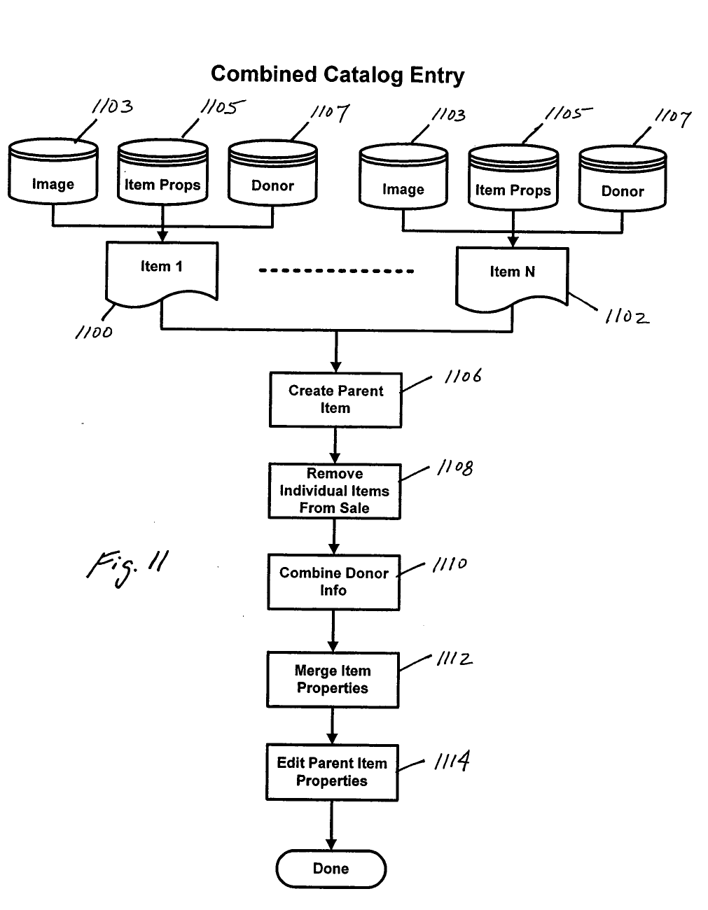

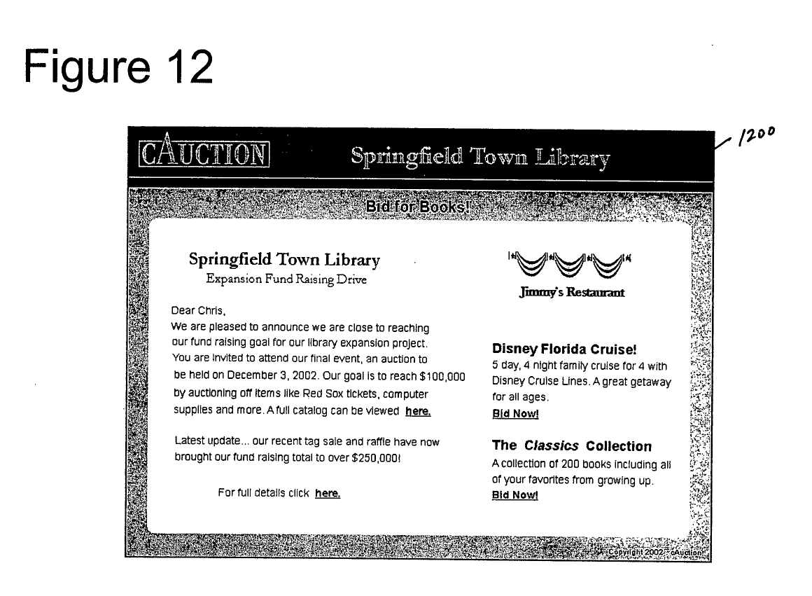

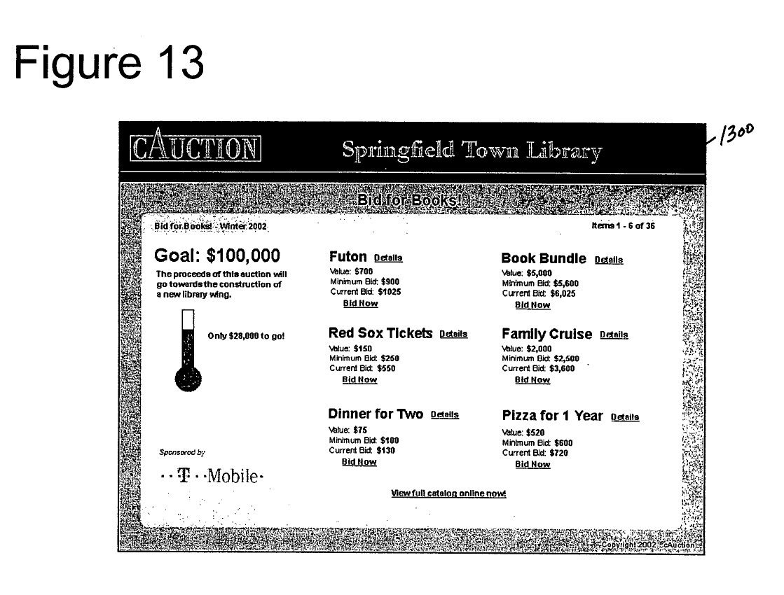

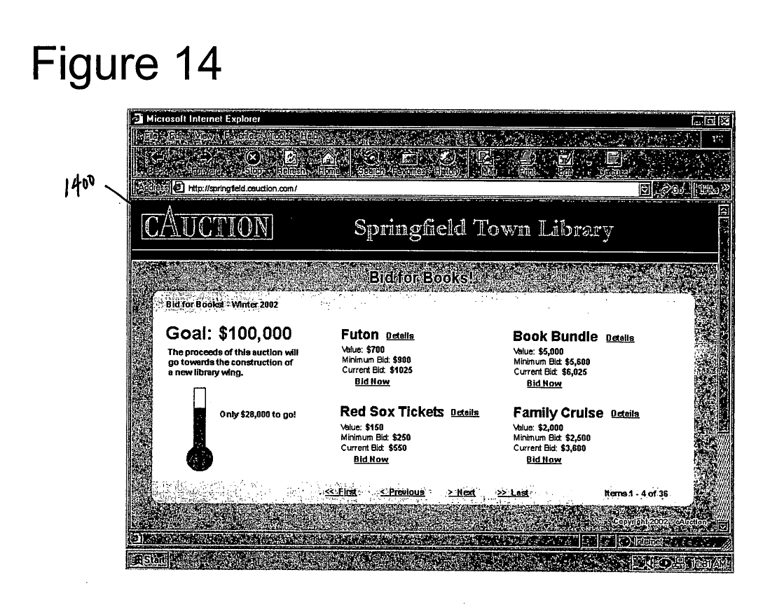

FIGS. 12-16 illustrate conceptual graphic user interfaces of the web pages 1200, 1300, 1400, 1500, and 1600, respectively, of a charitable auction, similar to that as would be experienced by bidder/donor processes 220A-B, when viewing the auction catalog online. FIG. 12 illustrates the web page displayed to a bidder/donor process upon accessing the portion of the web server dedicated to a specific auction, which includes an online invitation to a live auction event as well as highlighted items from the published virtual catalog associated with the auction. FIGS. 13-14 illustrate web pages showing selected published items from the catalog associated with the auction event. Virtual online catalog allows easy browsing and paging through all items associated to a particular catalog. Navigation from one catalog to another maintains all appropriate branding for the particular catalog and organization. Each option item displays value, minimum bid, and current bid price is, as well as links to further details for the item and two bid on the item. Each page further includes a link to view the catalog online, a listing of the auction and the current page of the total page number, as well as an indicator of the current amount raised by the auction event. The page also includes a sponsor logo.

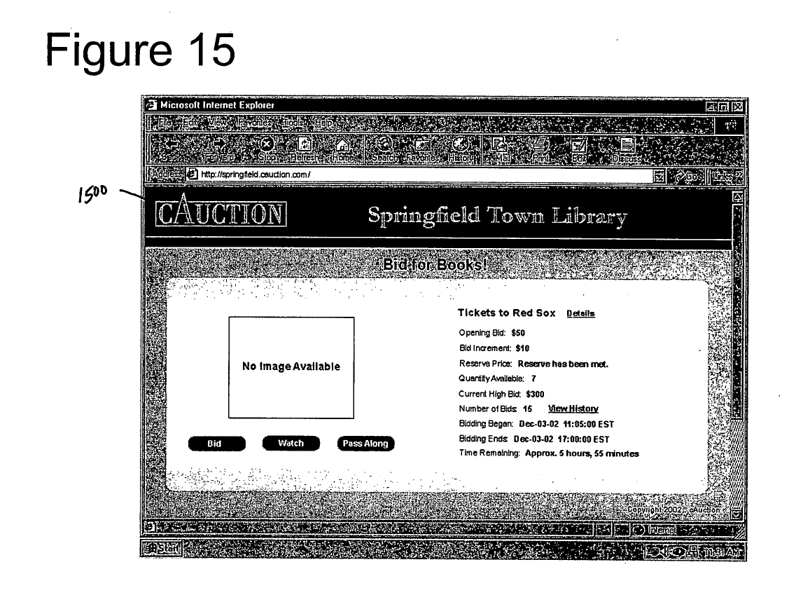

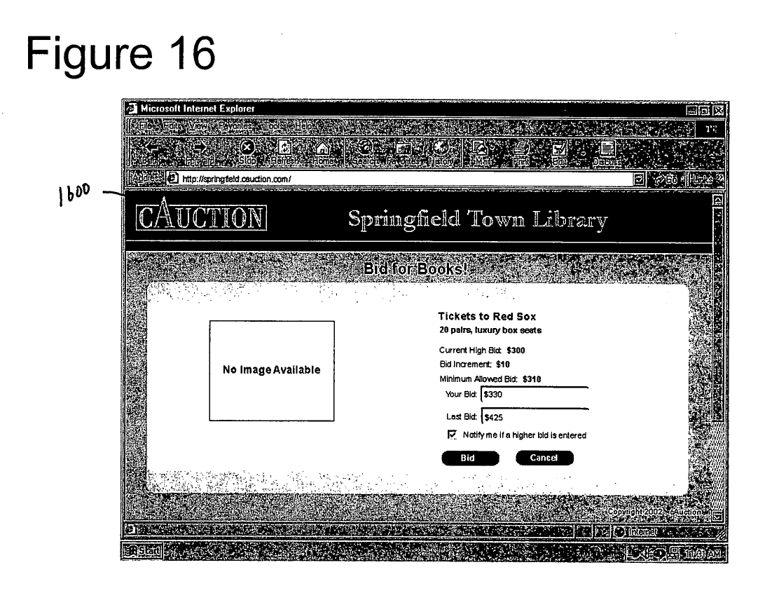

FIG. 15 illustrates a web page showing the details of a particular auction item, in this example Red Sox tickets, as would be presented upon selection of the Details link from a catalog web pages of either of FIGS. 13-14. FIG. 15 illustrates a number of parameters related to the auction item, including the opening bid, bid increments, reserve price, quantity available, current high bid, number of bids, bidding starts time, bidding and time, and total time remaining to bid, as illustrated. In addition, an image of the item may be optionally displayed along with selectable tabs to either bid on the item, watch the item or pass the link to the item to another potential bidder. Upon selection of the bid tab, a user interface similar to that illustrated in FIG. 16 will be displayed including selected of the information displayed in FIG. 15 along with the dialog boxes for entering a current bid and a maximum (last) bid, as illustrated. In addition, an image of the item may be optionally displayed along with selectable tabs to either bid on the item or cancel a bid.

Creating and Building a Catalog

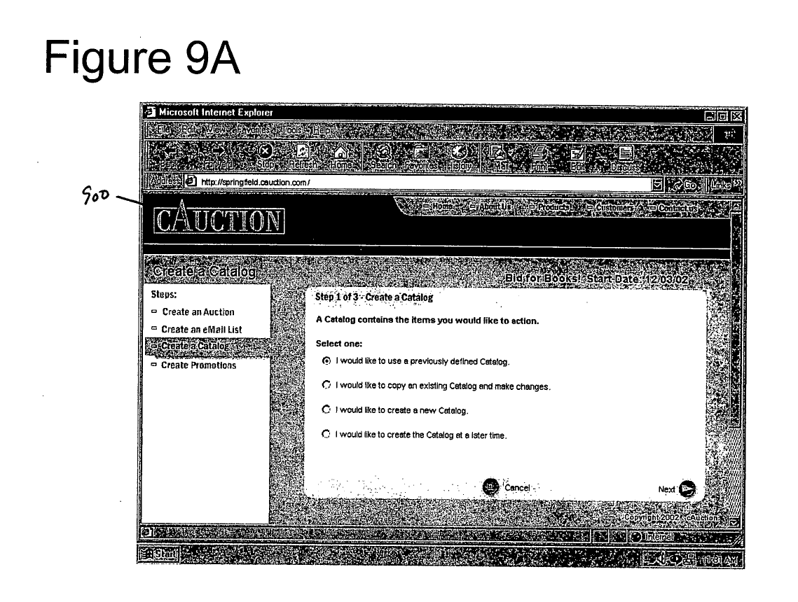

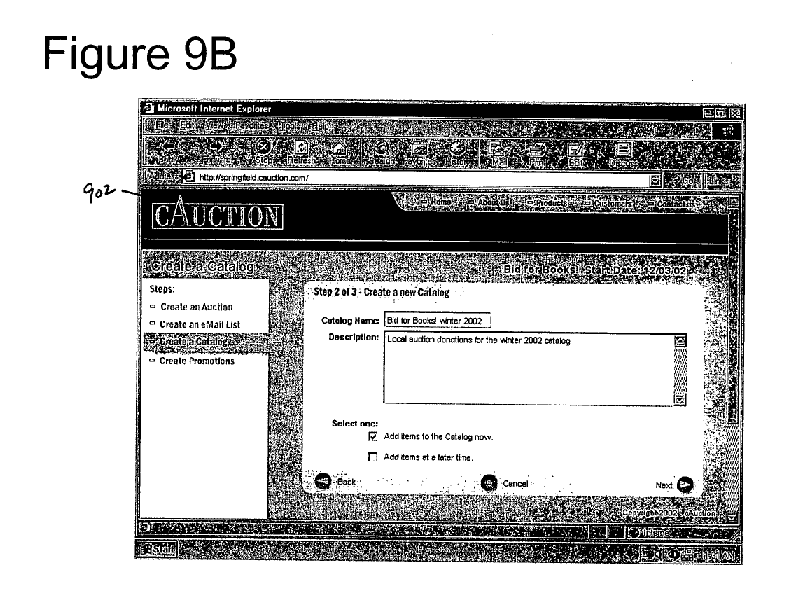

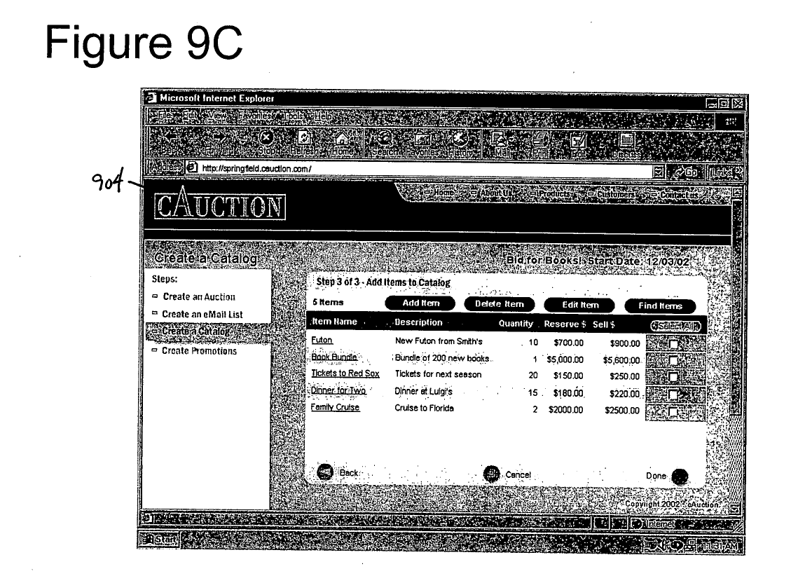

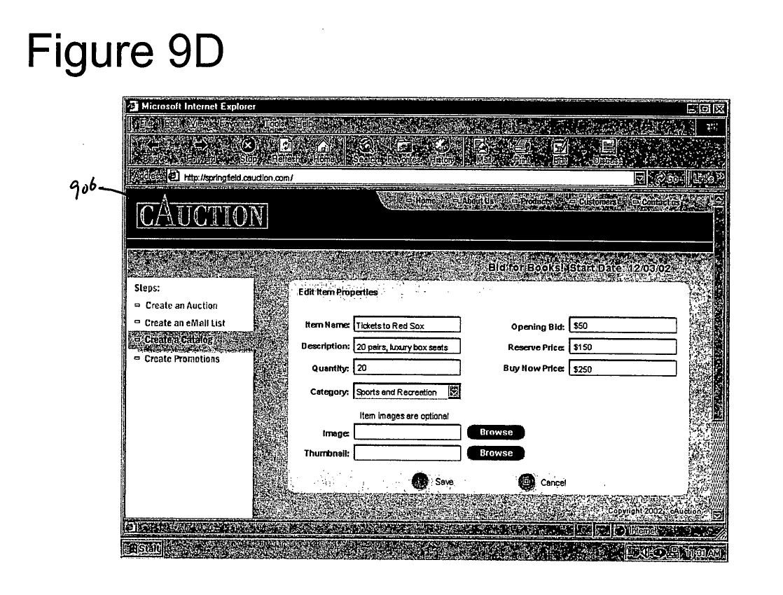

FIGS. 9A-D illustrate conceptually the graphic user interface(s) of web pages 900, 902 904, and 906, respectively, that a charitable client may utilize to create a catalog of items for an auction event, in accordance with the inventive system 250. In FIG. 9A, the charitable client user, who is typically a member of an auction committee for the nonprofit organization or charity, selects the “Create a Catalog” tab from the web pages illustrated and designates that a new catalog is to be created. Next, the user interface illustrated in FIG. 9B would be displayed. This web page enables the charitable client user to designate a catalog name and description and to selectively add catalog items, as illustrated.

The inventive system 250 enables a nonprofit or charitable client to request that their constituency donate items for an auction, either via electronic mail with an embedded link or through an embedded icon on a web page. The link embedded in the electronic mail or the embedded icon on the web page leads to a catalog item entry web page. If enabled by the charitable organization, the constituent can assign the item to a particular participant, cause, chapter, or organization for credit.

Donated items are queued for review within the inventive application that is restricted to viewing by auction committee members with correct permissions. Committee members can either accept, edit or reject items within the queue. When a committee member approves an item an automatic electronic mail notification is sent to the donating party. When a committee member edits an item an automatic electronic mail notification may be generated and sent to the donating party with the changes highlighted. Similarly, when a committee member rejects an item an automatic electronic mail is generated and sent to the donor with the reason for the disapproval. Upon approval, the item is added to the auction database and published to a database-served auction catalog based upon the ‘born on’ date or, if a ‘born on’ date is not present, the item may be published immediately. Donors can view a ‘personal page’ that lists the items that they have donated and their current status; in queue, accepted, rejected, and, if already accepted and in the auction process, the current bid status. When an item is sold an automatic electronic mail may be generated and sent to the donor with an IRS-acceptable donation receipt (electronic) attached. The above described process is set forth in greater detail with reference to FIG. 10.

Referring to FIG. 10, the process utilized by the charitable client, typically an authorized member or administrator of the auction committee for the charitable client, to approve or reject an item submitted by members of the constituent community using the catalog item entry web page of system 250 accessed using the previously described processes of an embedded link in the electronic mail or an embedded icon on the web page. The data parameters describing item submitted by the constituent community using the catalog item entry web page are placed in memory, as database records or objects, and designated as pending items for the review by an authorized member of the auction committee. The charitable client user accesses the web page presented by auction web server 260 for managing catalog tools, as illustrated by process block 1000. The system checks to authenticate the user, as illustrated by decisional block 1002, and, if authorized, views the records of pending items that have been submitted by the constituent community, as illustrated by process block 1004. Next, a listing of pending donated items, as illustrated in the user interface of FIG. 9C, is displayed with tabs allowing the items to be added to the current catalog, deleted from the current catalog, edited or a search query initiated. If the user selects to edit a catalog item, as illustrated by process block 1006, the user interface illustrated in FIG. 9D is presented which enables the editing of the donor supplied item parameters illustrated, as illustrated by procedural block 1008. Once the client process representing an authorized auction administrator has finished editing the parameters of the selected catalog item, the item can be approved through selection of the Add Item tab from the user interface enabling the submission of the additional item properties and updating the status of the item to “approved” and submitting the item to the catalog for publication, as illustrated by blocks 1010 through 1016. Alternatively, the client process user could save the edited item as a draft for later evaluation and/or publication, as illustrated by process block 1018. Acceptance, rejection or modification of the parameters of a donor supplied item generates an electronic-mail message to the donor constituent explaining the same, as illustrated by procedural block 1020. The item review process may repeat thereafter for other pending items currently submitted or upon submission prior to the auction event. In this manner, the catalog for the auction event may be generated efficiently.

In the illustrative embodiment, the data structures processed by the inventive algorithms described herein are implemented in an object-oriented format with data records implemented as objects having both data attributes and methods, as applicable. Referring to FIGS. 7D and 17-21, the implementation class definitions of the data structure objects useful for implementing the inventive concepts in an object-oriented environments, particularly the data and methods described herein, are illustrated. These record objects may be stored in any of the databases illustrated in the figures and may include data which simultaneously resides as parts of other records in other databases. The data-types of the data variables contained within the records are illustrated in FIGS. 7D and 17-21, e.g. char, date, Boolean, currency, etc., selected of which are explained in greater detail hereafter. In the record objects of FIGS. 76D and 17-21, selected relevant methods utilized by one object to call another object are designated with the following form: “methodname( )” where the actual name of the method will replace methodname. Also, a “1” associated with a method indicates that there can be only one valid data value for the queried object while a “0 . . . *” associated with a method indicates that there can be multiple valid data value(s) for the queried object.

FIGS. 17-20 illustrate the relationship between Event Record 1700, Organization Record 1701, Catalog Record 1704, Item Record 1706, Donation Record 1708, Benefactor Record 1710, Item Status Record 1712, and Member Record 1714. Primary records maintained for an auction include Organization Record 1701, Event Record 1700, and Catalog Record 1704. In the illustrative embodiment, all auctions all have an Organization Record 1701. In the illustrated embodiment, Organization Record 1701 comprises the following variables:
uuid
name
alias
description

The nature of the data type used to implement each variable is illustrated in FIG. 17. In Organization Record 1701 the uuid is a unique universal identifier and may be implemented with a multiple bit field of alphanumeric data. The uuid data serves as a primary key to identify an organization, e.g. the nonprofit or charitable or other entity holding the event. The name and description variables describe the name and nature of the organization, respectively, while the alias data may be used to describe an alternative name for the organization. In addition, the organization record has two methods associated therewith. As illustrated in FIG. 17, the +events( ) method can be used to call up one more events associated with the organization using the appropriate events identifier. Similarly, the +catalogs( ) method can be used to call one more catalogs associated with the organization using the appropriate catalog identifier.

In the illustrative embodiment, on-line auctions and combined on-line/live event auctions have Event Records 1700. In the illustrated embodiment, Event Record 1700 comprises the following variables:
uuid
organization_id
name
event_type
chairperson
description
start_time
finish_time

The nature of the data type used to implement each variable is illustrated in FIG. 17. In Event Record 1700 the uuid may be implemented similar to record 1701 and serves as a primary key to identify an auction. The organization_id variable identifies the parent organization, e.g. the nonprofit or charitable entity holding the event. The event_type variable identifies the event as being Online, Live Event or Both. The name and description variables describe the name and nature of the event, respectively. The chairperson variable identifies the chairperson associated with the event, respectively. The start_time variable identifies the date and time at which the event commences. The finish_time variable identifies the date and time at which the event ends. As illustrated in FIG. 17, the +catalogs( ) method can be used to call one more catalogs associated with the organization using the appropriate catalog identifier.

A Live Event record exist only for auctions which have a corresponding live event. The Live Event record, not shown in the figures, comprises the uuid, start_time, and finish_time variables similar to those described with reference to Event Record 1700. In addition, Live Event record comprises an event_id variable that identifies the corresponding Event Record 1700 to which the live event record corresponds.

Catalog details are maintained in the Catalog, Item, Donation and Benefactors records as described herein. One or more Catalog records 1704 can exist for each Event Record 1700. Multiple catalogs allow the separation of Online and Live Event items, if desired. In this manner, a different set of auction items may be available for an online auction event than those offered at a corresponding live auction event. In the illustrated embodiment, Catalog Record 1704 comprises the following variables:
uuid
organization_id
event_id
name
description
start_time
finish_time
points
donation
absentee_bidding

The nature of the data type used to implement each variable is illustrated in FIG. 17. In Catalog Record 1704 the uuid data may be implemented similar to record 1701 and serves as a primary key to identify a catalog. The organization_id variable identifies the parent organization, e.g. the nonprofit or charitable entity holding the event. The event_id variable identifies the corresponding Event Record 1700 to which the live event record corresponds. The name and description variables describe the name and nature of the catalog, respectively. The start_time variable if present, overrides the event start date and time. The finish_time variable, if present, overrides event close date and time. The remaining fields with in the Catalog Record 1704 are optional. The points variable is a flag to indicate if a rewards program enabled. The donation variable is a flag to indicate if donations are accepted. The absentee_bidding variable enables absentee bidding in live events. As illustrated in FIG. 17, the +items( ) method can be used to call one or more items associated with the catalog using the appropriate item identifier.

Item properties are stored in item records, with additional status and flags maintained in Item Status records, as illustrated. An Item Record 1706 exists for each item associated with a particular Catalog Record 1704 and has the form illustrated in FIG. 17. In the illustrative embodiment, items may be a composite parent auction item or be a component thereof as described herein. In the illustrated embodiment, Item Record 1706 comprises the following variables:
uuid
category_id
catalog_id
donation_id
lot_number
name
description
image
reserve_price
opening_bid
bid_increment
quantity
buy_now_price
buy_now_quantity
est_value
display_value
cost
start_time
finish_time

The nature of the data type used to implement each variable is illustrated in FIG. 17. In Item Record 1706 the uuid variable serves as a primary key to identify an item. The category_id variable identifies the item category of the auction item. The catalog_id variable identifies the catalog record of the auction item. The donation_id variable identifies the donation record if the item was donated by constituency. The optional lot_number variable identifies the lot of the auction item. The name variable identifies the name of the auctioned item. The description variable provides a description of the auctioned item. The image variable identifies the name of the image file associated with the auctioned item and a link, where applicable. In the illustrative embodiment, the image file may be stored on a webserver, with only the name referenced in one of the local databases of system 250. The image file may be formatted in any number of conventional image data formats, including, but not limited to JPEG, GIF, PNG, etc. The reserve_price, opening_bid, bid_increment, and buy_now_price identify the amounts in currency of the reserve price, opening bid, bid increment, buy item now price of the auction item, respectively. The quantity variable identifies the number of auction items available. The buy_now_quantity variable identifies the number of auction items available or that must be purchased to achieve the buy_now price. The est_value variable identifies the estimated value (fair market value) of the item used for printing purchase receipts. The display_value variable identifies the estimated value to be display in either the printed or on line catalog associated with the auction item. The cost variable identifies the amount in currency of any cost to purchase the auction item, or component auction items, if any. The start_time variable identifies the date and time at which the auction for the item commences. The finish_time variable identifies the date and time at which the auction for the auction item is complete.

In addition, the organization record has six methods associated therewith that can be used to call other records containing data values related to the item record. As illustrated in FIG. 17, the +catalogs( ) method can be used to call one more catalogs associated with the organization using the appropriate catalog identifier. The +donation( ) method can be used to call up the record associated with the using the donor using the appropriate identifier. Similarly, the a plurality of method, the +itemsStatus( ) method can be used to call the status data associated with the item the appropriate itemStatus identifier.

An ItemStatus record 1712 exists for each item associated with a particular item record 1706 to maintain additional status and flags, as illustrated in FIG. 17. The data type used to implement each variable in ItemStatus record 1712 are either Char or Boolean. In addition a single method, item( ) can be used to identify the item to which the status information relates.

A Donation Record 1708 exists if an item has been donated by the auction constituency. In the illustrated embodiment, Donation Record 1708 comprises the following variables:
uuid
benefactor_id
name
logo
link
description
donated_date

The nature of the data type used to implement each variable is illustrated in FIG. 17. In Donation Record 1708 the uuid variable serves as a primary key to identify a donor. The benefactor_id variable identifies the benefactor record if the parent item was donated by constituency. The name, logo, link, and description variables describe the name, logo, on line address, and nature of the donor, respectively, whether an individual or a business entity. The donated_date variable identifies the date and time at which the auction item was donated.

In addition, the Donation Record 1708 has three methods associated therewith that can be used to call other records containing data values related to the item record. The +items( ) method can be used to call one or more items associated with the donor using the appropriate donor. The +getMainBenefactor( ) and +benefactors( ) methods can be used to call one or more benefactors associated with the donor using the appropriate donor data.

In the illustrative embodiment, an item may be donated by an organization or multiple donors. In such instances, benefactor records 1710 are used to track information related to the multiple benefactors which comprises the donating entity. Accordingly, one or more benefactor records 1710 may exist for a donation record and contain appropriate contact information. In addition, benefactor records exist for donated and sponsored items. More than one benefactor is possible, each accessible via an API. Specific contact information may be available via the API for each benefactor, including name, address, contact info, etc. In addition to contact information, logos and URLs may be maintained. In benefactor records 1710 the uuid variable serves as a primary key to identify a benefactor. The member_id variable identifies the auction member who will be the benefactor of the donation. The name, address, and phone variables describe the name, address and telephone information of the benefactor of the donation, respectively. The +getContactInfo( ) and +donation( ) methods can be used to access the donation record and the contact information of the benefactor.

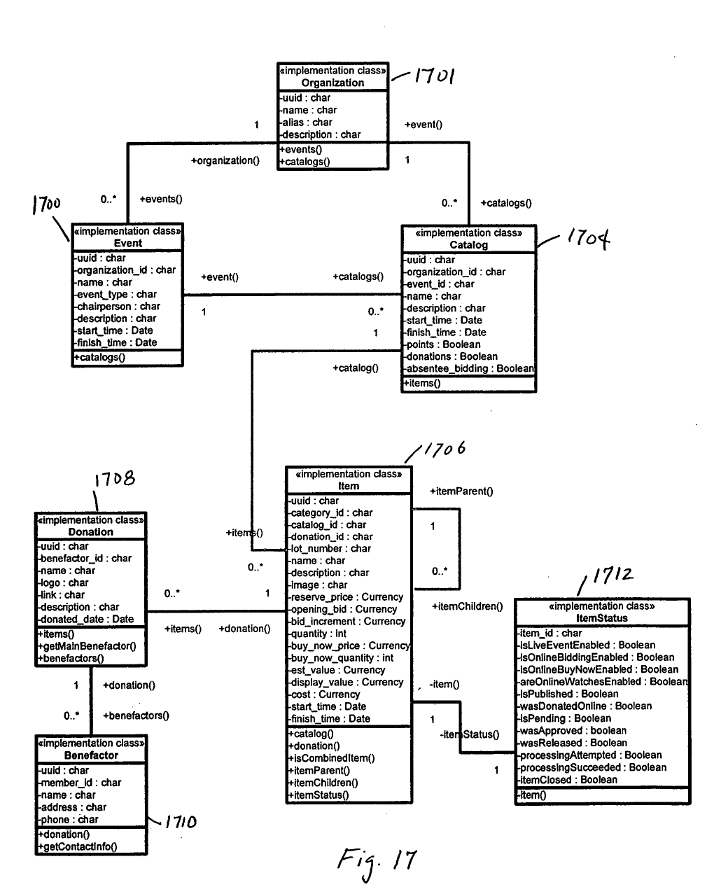

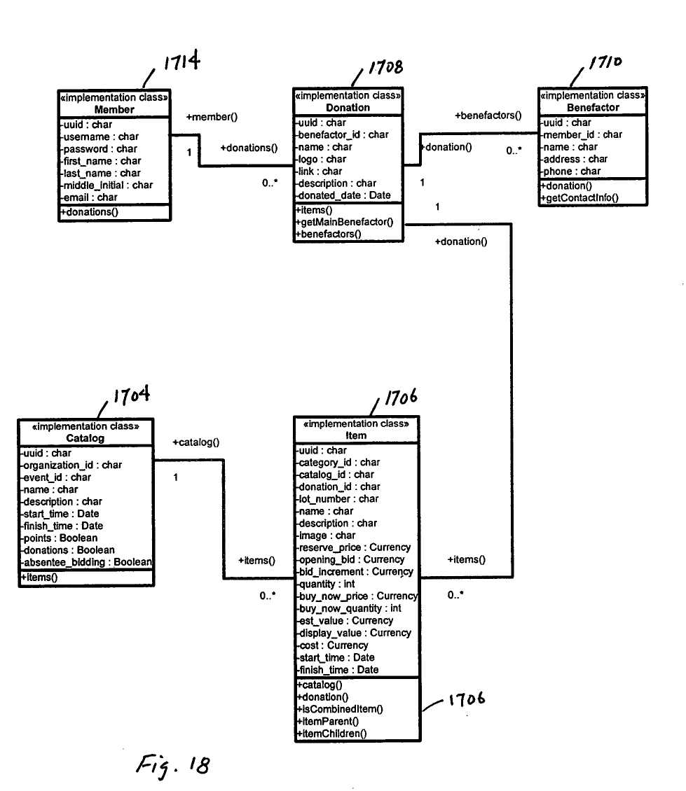

FIG. 18 illustrates the relationships among Catalog Record 1704, Item Record 1706, Donation Record 1708, Benefactor Record 1710, and Member Record 1714, and the respective methods utilized between records to access the other. In the illustrative embodiment, participants to an auction, whether as a bidder or as a donor of an item or other role, must first register with the auction as a member. The membership information is stored in Member Record 1714. The nature of the data type used to implement each variable is illustrated in FIG. 17. In Member Record 1714 the uuid data value may be implemented similar to record 1701 and serves as a primary key to identify a member. The username and password variables describe the username and password that a member uses to log-on to an on-line auction hosted by the system 250. The first_name, last_name and middle_initial fields are used to store the name of the member, while the e-mail field is used to store the electronic-mail address at which the member can be reached. The +donations( ) methods can be used to access one or more donation records associated with a member record.

In the illustrative embodiment, participants to an auction, whether as a bidder or as a donor of an item or other role, must first register with the auction as a member. On donation, a new member record is created if the donating member has not previously registered. For the donated item, the item, itemStatus, donation and benefactor records are created. Item properties are stored in item record, with additional status and flags maintained in Item Status records. On item donation, a limited number of properties are set in item and item status records. Specifically, required properties include item name, description, desired category, estimated value, and donor name. Optional properties can be specified, including special instructions and an item image. Optional donor properties may include donor link, donor logo, and donor description. Additional contact information, not accessible from member records, is available via the benefactor API. Contact information required to complete donation process.

Utilizing the process illustrated in FIG. 10, an auction administrator or other authorized party views pending items awaiting approval and determines whether or not to accept or release (reject) the donated item. In the illustrative embodiment, a query of database 1105 for items having the pending field of a specific value allows an auction administrator to review all of the pending items at a point in time. Alternatively, the data records representing pending items may be placed in an approval queue. Upon acceptance/rejection of an item, remaining item and item status properties are set. An item editor utility which enables the process as outlined herein and in FIG. 10, may be part of the Platform tools server 402, the construction and function of which is within the scope of those recently skilled in the arts given the disclosure of the procedural algorithms and data structures described herein, including the data type and methods of the relevant record objects.

FIG. 19A illustrates, for a donated auction item that has been approved, the relationships among Item Record 1706A, Item Status Record 1706A, Donation Record 1708, Benefactor Record 1710, and Member Record 1714, and the respective methods utilized between records to access the other. FIG. 19B illustrates for a donated auction item that has been released or rejected, the relationships among Item Record 1706B, and Item Status Record 1706B and the respective methods utilized between records to access the other.

In the illustrative embodiment, items donated by the same member can span catalogs and organizations for any particular member. A donor page provides a single view across all catalogs to view donated items. On the member's donor page, donated items are grouped together within their relevant catalog. Donors can view a the list of items they have donated and their current status as pending, accepted, rejected, and, if already accepted and in the auction process, the current bid status.

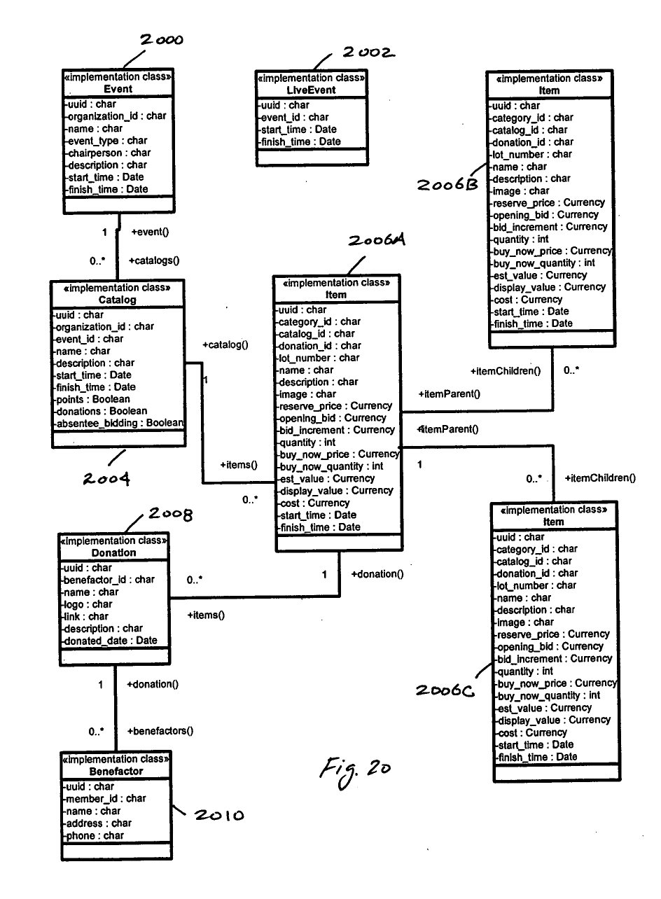

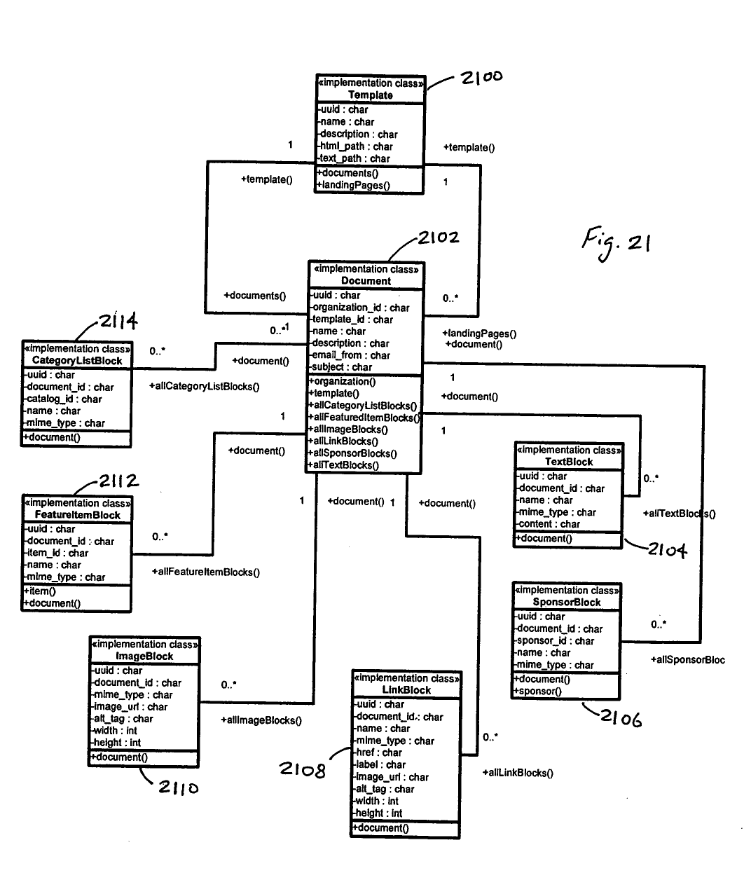

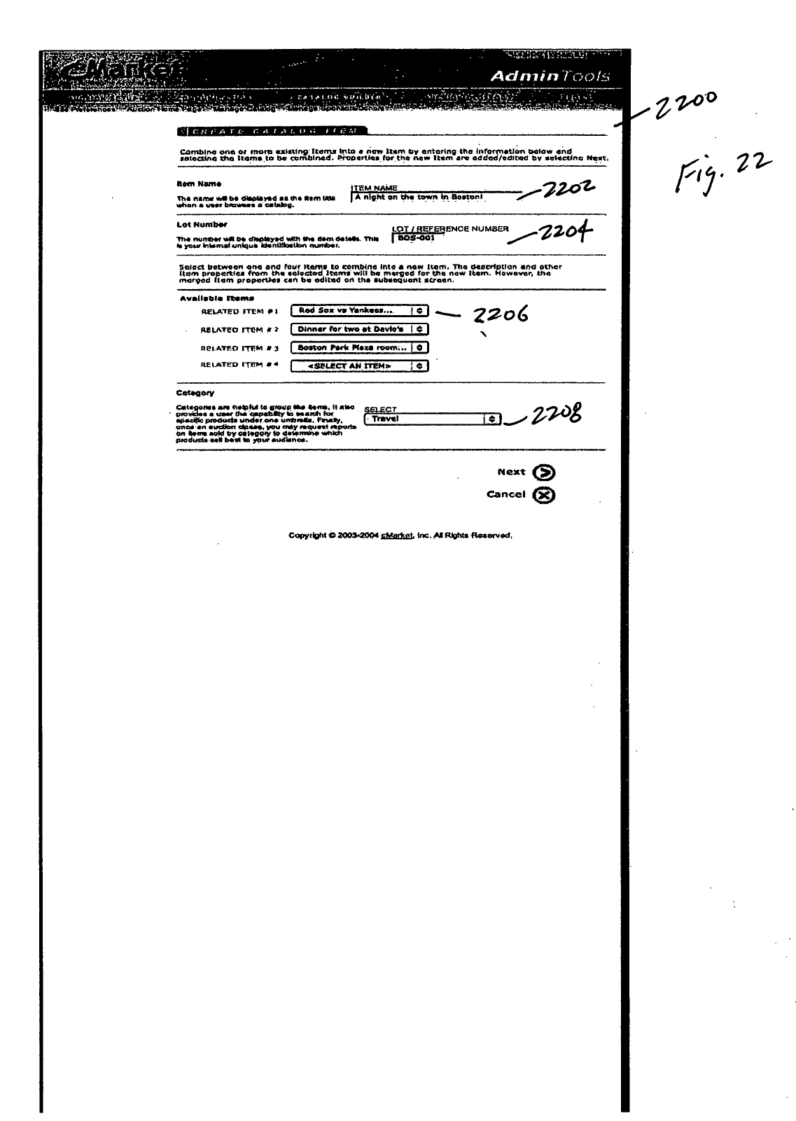

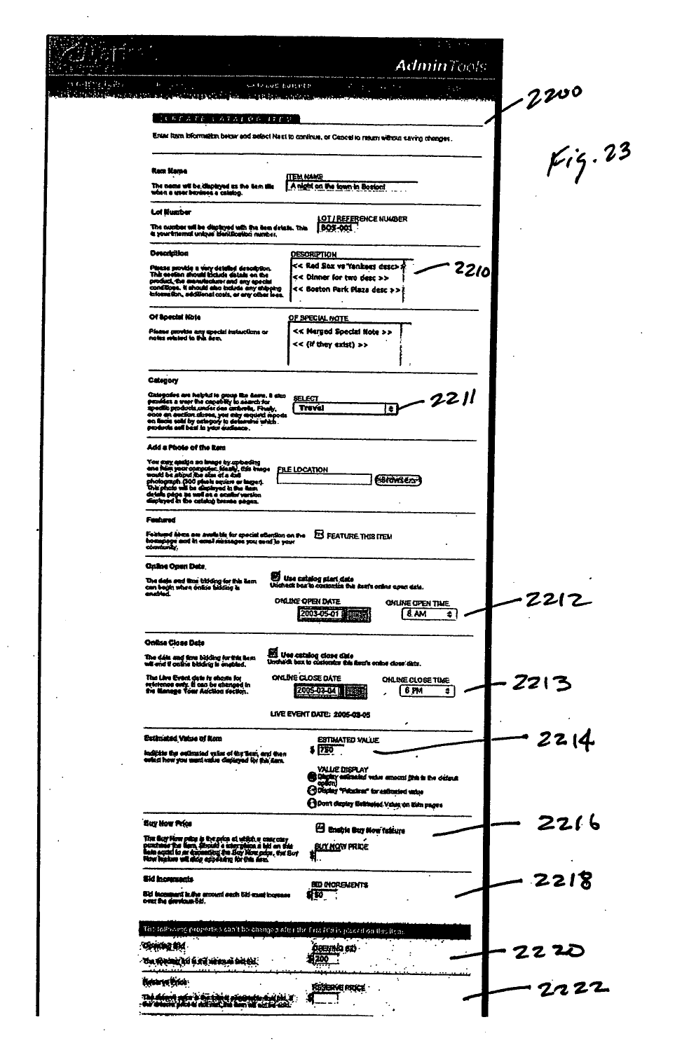

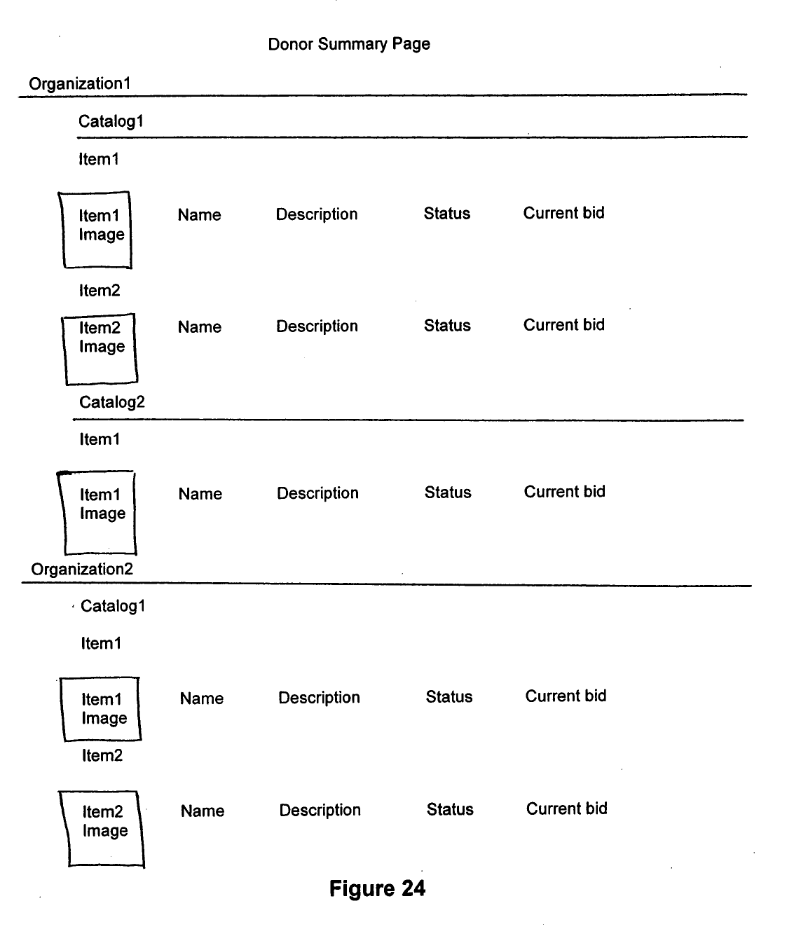

FIG. 24 illustrates an exemplary donor page in which multiple items, all donated by the same donor member are visible along with selected status information. Upon request of the member, and utilizing the record objects and methods described in the FIGS. 17-20, and appropriate set of queries are made into the respective databases, as would be understood by those reasonably skilled in the arts, given the descriptions contained herein. The resulting data is then assembled a Web page which can be displayed by the donor member. Other optional links on the Web page may provide additional information. Note that the donor page may include any relevant image files related to the respective items from the image server. The inventive system further maintains relationships among various items that enable searching capabilities such as to allow catalog viewers to sort the catalog by ‘donated to’, to enable donors to forward, via electronic mail, the catalog listing of their items.

Combining Catalog Entries

According to another aspect of the invention, once a catalog has been generated and a plurality of items donated, the inventive system 250 enables an auction committee member of a charitable organization to combine individual catalog items, either currently published or pending, into a single parent auction object that is an aggregate or composite auction item while still maintaining the integrity of the donor contribution the data of the individual components comprising parent item. For example, airfare, hotel, sightseeing items donated from various constituents can be combined into a single packaged offering having a fair market value and a starting bid which may be different than the fair market value and a starting bid of any of the individual component auction items within the parent item.

FIG. 11 illustrates in greater detail the algorithmic process utilized to combine the properties of multiple auction items to form a composite or parent item. In FIG. 11, a plurality of donated items 1100 and 1102, designated Item 1 and Item N, respectively, each have an image record stored in database 1103, an item record stored in database 1105 and donor record stored in database 1107 associated therewith. A user who has been authenticated by system 250 may combine items by creating a new ‘parent’ catalog entry with a parent item name and assigning them to the newly created name by selecting a combine item function and selecting the combined item name, as illustrated by process block 1106. Next, the individual items are removed from sale or pending status, as illustrated by procedural block 1108. The donor information from each of the individual items is combined and associated with a donor record for the parent item as illustrated by procedural block 1110. Other properties of Item 1 and Item N, such as item descriptions, images, etc. are edited, typically merged, where applicable, as illustrated by procedural block 1112. The estimated or fair market values of the individual items are combined automatically by the system 250 to generate the fair market value of the combined item. In the illustrative embodiment, there may be a drop-down menu or similarly enabled function that allows the authorized user/committee member to see other items already entered into the catalog, allowing an item that is currently being edited to be added to a parent item. Finally, the user can edit the properties of the parent item to include the same or different properties of the individual component items, as illustrated by procedural block 1114. In the contemplated embodiment, all the standard auction options, e.g. enable online bidding, LastBid, etc., are available at the parent level. Any related donor links and logos are preserved and displayed at the parent level or new donor links and logos may be entered and edited at the parent level. Any restrictions and/or special instructions are maintained and combined into a single restriction/special instruction display associated with the combined parent package. The new parent item, that results from the combination of individual items 1100 and 1102, using the above-described process, has image, auction properties and donor record values associated therewith, in the same manner as other published items in the catalog.

The above process can be better understood with reference to the specific object records involved and the relationship among such records in memory. In the illustrative embodiment, combined items are maintained via a parent item record and parent/child relationships with plural item records. FIG. 20 illustrates the relationship between a parent item record 2006A and a plurality of child item records 2006A and 2006B as well as other relevant records similar to those illustrated in FIGS. 17-19. Specifically, in FIG. 20, Event Record 2000, Catalog Record 2004, Item Record 2006B-C, Donation Record 2008, and Benefactor Record 2010 are similar in structure and implementation to Event Record 1700, Catalog Record 1704, Item Record 1706, Donation Record 1708, and Benefactor Record 1710, respectively, of FIG. 17, except where noted. In Event Record 2000, the organization_id variable identifies the parent organization, e.g. the nonprofit or charitable entity holding the event. In Catalog Record 2004, the organization_id variable identifies the parent organization, e.g. the nonprofit or charitable entity holding the event. In Donation Record 2008, the benefactor_id variable identifies the benefactor record if the parent item was donated by constituency.

A Parent Item Record 2006A exists for each composite item associated with a particular Catalog Record 2004, and, for items which are part of a composite parent auction item, an Item Record 2006B exists, as illustrated in FIG. 20. In the illustrated embodiment, Parent Item Record 2006A comprises the following variables:
uuid
category_id
catalog_id
donation_id
lot_number
name
description
image
reserve_price
opening_bid
bid_increment
quantity
buy_now_price
buy_now_quantity
est_value
display_value
cost
start_time
finish_time

The nature of the data type used to implement each variable is illustrated in FIG. 20. In Parent Item Record 2006A the uuid variable serves as a primary key to identify a Parent Item Record. The category_id variable identifies the item category of the parent auction item. The catalog_id variable identifies the catalog record of the parent auction item. The donation_id variable identifies the donation record if the parent item was donated by constituency. The optional lot_number variable identifies the lot of the parent auction item. The name variable identifies the name of the parent auctioned item. The description variable provides a description of the parent auctioned item. The image variable identifies the name of the image file associated with the parent auctioned item and a link, where applicable. As with regular auction items, an associated image file may be formatted in any number of conventional image data formats, including, but not limited to JPEG, GIF, PNG, etc. The reserve_price, opening_bid, bid_increment, and buy_now_price identify the amounts in currency of the reserve price, opening bid, bid increment, buy item now price of the parent auction item, respectively. The quantity variable identifies the number of parent auction items available. The buy_now_quantity variable identifies the number of parent auction items available or that must be purchased to achieve the buy_now_price. The est_value variable identifies the estimated value (fair market value) of the parent item used for printing purchase receipts. The display_value variable identifies the estimated value to be display in either the printed or on line catalog associated with the parent auction item. The cost variable identifies the amount in currency of any cost to purchase the parent auction item, or component auction items, if any. The start_time variable identifies the date and time at which the parent auction item is offered. The finish_time variable identifies the date and time at which the auction for parent auction item is complete.

Combined items are maintained via parent/child relationships. For combined items, the Parent item is displayed in the catalog, with attributes being derived from each child item comprising the collection. The +is CombinedItem( ) method can be used to determine that whether the subject item is part of a combined item offering. If the subject item is a component or child item of a parent item combination, the +itemParent( ) method can be used to identify the parent item. If the subject item is a parent item combination, the +itemChildren( ) method can be used to identify the any children items.

Live Event record 2002 exist only for auctions which have a corresponding live event. Live Event record 2002 comprises the uuid, start_time, and finish_time variables similar to those described with reference to Event Record 2000. In addition, Live Event record 2002 comprises an event_id variable that identifies the corresponding Event Record 2000 to which the live event record corresponds.

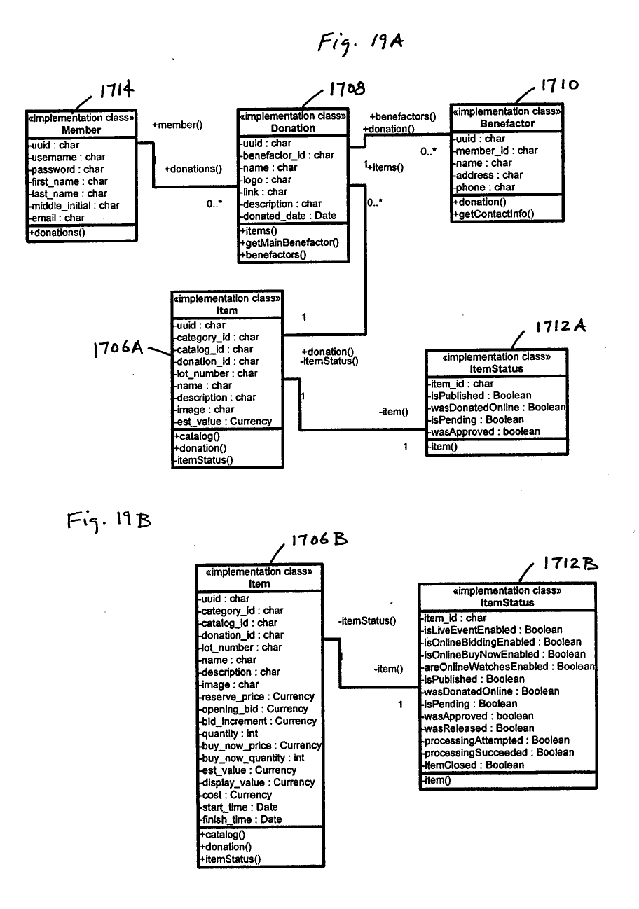

Figured 22 illustrates an exemplary user interface 2200 presented by the catalog builder function that enables an auction committee member or other person authorized within an auction to combine auction items into a composite auction item utilizing the inventive techniques described herein. As shown in FIG. 22, the user may select pending donated items or items already published in a catalog for combination into a composite auction item. In FIG. 22, a user administrator specifies a name for the combined parent item and its description, followed by selecting a plurality of existing items to be combined. Next, the user administrator modifies the default properties and adjusts the data as needed. System 250 automatically combines selected properties, using any of summing, an aggregation or concatenation algorithms as applicable, for example descriptions, special notes, estimated value, etc., to be presented as default values that can be further edited as illustrated in the figure of 23. Exemplary items are listed in dialogue box 2206. Selected data fields within the parent record object, such as item name, lot number and category, may be user-defined through dialogue boxes 2202, 2204 and 2208, respectively, of interface 2200. Selection of the next page option from the user interface toy 200 of FIG. 22 causes an extension of user interface 2200 to be presented, as illustrated in FIG. 23. In FIG. 23, other data fields within the parent item record, such as description, on-line open date, on-line close date, estimated value, by now price, bid increments, opening bid, reserve price, etc., may be defined through the user-defined through dialogue boxes 2210, 2211, 2212 and 2213, 2214, 2216, 2218, 2220, and 2222, respectively, of interface 2200. Where applicable, the respective data values in the child item records are combined in the parent record, for example, as illustrated by description dialogue box 2210 in which the parent description comprises an aggregation of the descriptions of the component child items. Once the data within the parent item record is defined, it is saved and the appropriate methods within the component items will maintain the parent/child relationships to the parent item record. An catalog builder utility function which enables the process as outlined herein and in FIG. 11 and generates the interfaces of FIG. 22-23, may be part of the Platform tools server 402, the construction and function of which is within the scope of those recently skilled in the arts given the disclosure of the procedural algorithms and data structures and interfaces described herein, including the data type and methods of the relevant record objects.

FIG. 21 illustrates the relationship between template record 2100, document record 2102, text block record 2104, sponsor block record 2106, link block record 2108, image block record 2110, feature item block record 2112, and category list block record 2114. In the illustrated embodiment, template 2100 comprises the following variables:
uuid
name
description
html_path
text_path

The nature of the data type used to implement the variable in record 2100 is illustrated in FIG. 21. In template record 2100 the uuid is a unique universal identifier and may be implemented with a multiple bit field of alphanumeric data. The uuid data serves as a primary key to identify the template record. The name and description variables describe the name and nature of the template, respectively. The html_path and text_path variables describe resolvable addresses to memory location for html and text content, respectively, of the template.

In addition, the template record has at least a +documents( ) method which can be used to call up one more documents that have been created from the template record, using the appropriate documents identifier. A user customized document created following the selection of a template and population thereof with user-defined data is stored in one of the databases, as illustrated in FIG. 21.

In the illustrated embodiment, document record 2102, comprises the following variables:
uuid
organization_id
template_id
name
description
email_from
subject

The nature of the data type used to implement the variables in record 2102 is illustrated in FIG. 21. In document record 2102 the uuid is a unique universal identifier and may be implemented with a multiple bit field of alphanumeric data. The uuid data serves as a primary key to identify the document record. The name and description variables describe the name and nature of the document, respectively. The organization_id and template_id variables describe, respectively, the organization and template associated with the document. The email variable describes an electronic mail address associated with the document, typically that of the author or an auction administrator. The subject variable describes subject matter of the document. In addition, the document record has at least eight methods associated therewith to access one or more of any of the template record 2100, document record 2102, text block record 2104, sponsor block record 2106, link block record 2108, image block record 2110, feature item block record 2112 with which the document record is associated.

In the illustrated embodiment, text block record 2104 comprises the following variables:
uuid
document_id
name
mime_type
content

The nature of the data type used to implement each variable is illustrated in FIG. 21. In text block record 2104 the uuid is a unique universal identifier and may be implemented with a multiple bit field of alphanumeric data. The uuid data serves as a primary key to identify the text block record. The document_id variable identifies the document with which the text block is associated. The name variable describes the name of the text block. The mime_type variables describe message format associated with the text block while the content variables defines the content of the text block. In addition, the text block record has a +documents( ) method that can be used to call the document with which the text block record is associated.

In the illustrative embodiment, the web pages of an auction catalog or the homepage of the auction itself may have associated therewith one or more links to sponsors of the fundraising event. In the illustrated embodiment, sponsor block record 2106 comprises the following variables:
uuid
document_id
name
mime_type
content
sponsor_id

The nature of the data type used to implement each variable is illustrated in FIG. 21. In sponsor block record 2106 the uuid is a unique universal identifier and may be implemented with a multiple bit field of alphanumeric data. The uuid data serves as a primary key to identify the sponsor block record. The document_id variable identifies the document with which the sponsor block is associated. The name variable describes the name of the sponsor. The mime_type variables describe message format associated with the sponsor block while the sponsor_id variable identifies an optional sponsor associated with the document. In addition, the sponsor block record has at least +documents( ) and +sponsor( ) methods that can be used to call document and sponsor records, respectively, with which the sponsor block record is associated.

In FIG. 21, link block record 2108 comprises the following variables:
uuid
document_id
name
mime_type
image_url
height
width
label
alt_tag
href

The nature of the data type used to implement each variable is illustrated in FIG. 21. In link block record 2108 the uuid is a unique universal identifier and may be implemented with a multiple bit field of alphanumeric data. The uuid data serves as a primary key to identify the link block record. The document_id variable identifies the document with which the link block is associated. The name variable describes the name of the link block. The mime_type variables describe message format associated with the link block while the image_url variable identifies the address of an optional image file associated with the link block record. The height, width, label, alt-tag, and href variables describe other characteristics associated with link image file associated with the link block record. In addition, the link block record has at least a +documents( ) method that can be used to call the document records with which the link block record is associated.

In the illustrative embodiment, image block record 2110 comprises the following variables:
uuid
document_id
mime_type
image_url
height
width
alt-tag

The nature of the data type used to implement each variable is illustrated in FIG. 21. In image block record 2110 the uuid is a unique universal identifier and may be implemented with a multiple bit field of alphanumeric data. The uuid data serves as a primary key to identify the image block record. The document_id variable identifies the document with which the image block is associated. The mime_type variables describe message format associated with the image block while the image_url variable identifies the address of an image file associated with the image block record. The height, width, and alt-tag, variables describe other characteristics of the image associated with the image block record. In addition, the image block record has at least a +documents( ) method that can be used to call the document record with which the image block record is associated.

In FIG. 21, feature item block record 2112 comprises the following variables:
uuid
document_id
mime_type
item_id
name

The nature of the data type used to implement each variable is illustrated in FIG. 21. In feature item block record 2112 the uuid is a unique universal identifier and may be implemented with a multiple bit field of alphanumeric data. The uuid data serves as a primary key to identify the feature item block record. The document_id variable identifies the document with which the feature item block is associated. The mime_type variables describe message format associated with the feature item block while the item_id variable identifies the featured item associated with the featured item block record. Typically, a featured item will be a catalog item donated by a sponsor and for which the sponsor wishes to be recognized. There may be multiple featured item blocks associated with a document. The name variable describes the name of the featured item. In addition, the feature item block record has at least the +documents( ) and +item( ) methods that can be used to call the document record and item record up, respectively, with which the feature item block record is associated. An example of a template for use with a sponsorship promotion including featured items is illustrated in FIG. 25.

In the illustrative embodiment, catalog list block record 2114 comprises the following variables:
uuid
document_id
mime_type
catalog_id
name

The nature of the data type used to implement each variable is illustrated in FIG. 21. In catalog lists block record 2114 the uuid is a unique universal identifier and may be implemented with a multiple bit field of alphanumeric data. The uuid data serves as a primary key to identify the catalog list block record. The document_id variable identifies the document with which the catalog list block is associated. The mime_type variables describe message format associated with the catalog list block while the catalog_id variable identifies the catalog associated with the catalog list block record. The name variable describes the name of the catalog. In addition, the catalog list block record has at least a +documents( ) method that can be used to call the document record with which the catalog list block record is associated.

Utilizing the object records described with reference to FIGS. 17-21 and the graphic user interface illustrated in FIG. 6A-C and elsewhere herein the present invention further enables the rapid creation of new auctions from previously stored auction templates. Referring to the flowchart of FIG. 28, an authorized user, typically a member of the auction committee, creates/edits an auction template and related communication and promotion templates utilizing the interfaces previously described, as illustrated by procedural block 2800. Once the template objects have been defined and the original auction created, the inventive system 250 stores of the relevant data within one or more of the databases described herein and associated with a URL address to a publicly accessible portion of a server application, typically executed by auction engine 295, as illustrated by decisional block 2802 and procedural block 2804. Once stored, the auction template(s) can be used to duplicate the auction, typically at a later point in time, or the auction template can serve as the basis for a new auction whose parameters are derived from the stored auction template(s). Referring again to the flowchart of FIG. 28, the auction creator retrieves the previously stored auction templates, typically through a user interface that includes a file directory or menu selection of previously stored auctions, as illustrated by decisional block 2806 and procedural block 2808. The auction creator may then edit any of the available parameters associated with the auction template(s) utilizing the interface is of FIGS. 6A-C, for example, changing the dates, contact name, auction theme, etc., as illustrated by procedural block 2810. Once the new auction is completed, the new auction template(s) are stored similar to the original auction templates in association with a different URL address to a publicly accessible portion of a server application than the URL of the original auction from which selected parameters thereof were derived, as illustrated by decisional block 2812 and procedural block 2804, else the process ends. Accordingly, the present invention enables a client to replicate an auction including the auction home page and templates that have been previously edited and customized with links, logos, marketing information, banners, etc., resulting in an exact copy of a previously created auction with all the associated pages, community lists, etc., but located at a new URL. Replication of the auction saves time, particularly for charitable organizations that have such a fund raising events are on a regular basis.

Sponorship/Donor Advertisements

According to another aspect of the invention, a system and computer program and method enables an auction committee administrator or author to enter sponsor information to be published as part of the catalog or as part of sponsor pages accessible via the auction web site. The organization can determine, in advance, the size of a sponsor ad based upon the amount or value donated. The inventive application automatically formats the sponsor pages based upon the value of the sponsor dollars with more expensive sponsorships receiving premium placement. In present invention, sponsorship may occur through the donation of one or more items to be auctioned, the donation of currency, or through the donation of services, such as printing services, to facilitate the fund raising event. The fair market value of items or services donated can be supplied by the sponsor or determined by the auction administrator in a manner as described herein.

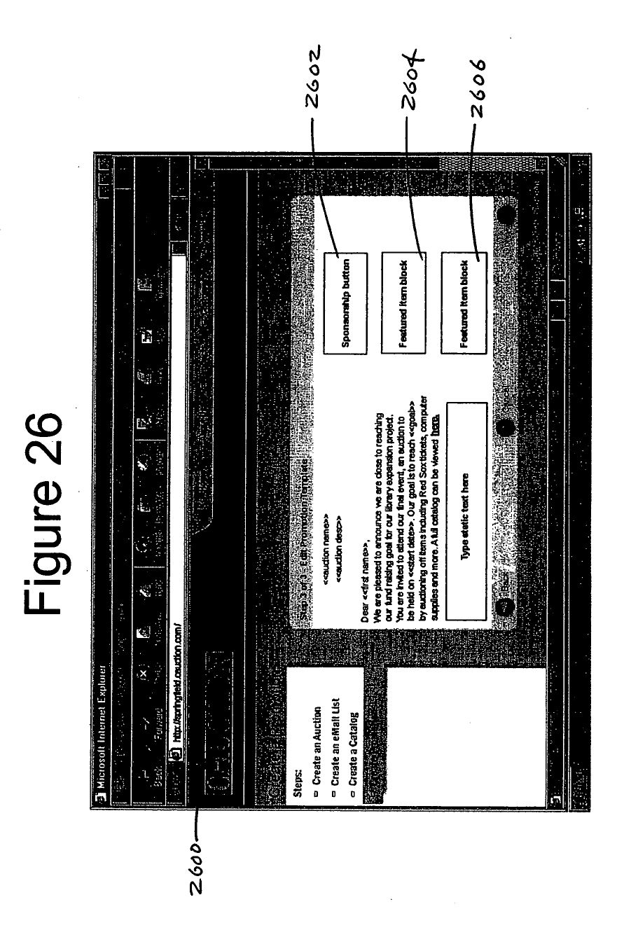

In addition to the processes described with reference to FIGS. 9A-D and 10, FIGS. 25-26 illustrate conceptual graphic user interfaces of the web pages 2500 and 2600, respectively, in accordance with the inventive system, that may be utilized to create an auction catalog, including one or more auction sponsors whose presence in the catalog is determined by the sponsorship level. The charitable client user, who is authoring the catalog, selects one of a plurality of template page format styles from menu 2502 and template layouts from menu 2504, as illustrated in FIG. 25 and also defines a number of sponsorship placement parameters by entering data in dialogue boxes 2506 and 2508. These parameters include a plurality of dollar or value thresholds, the amount of advertising space allotted on a web page associated with that threshold, and the minimum level of sponsorship required for sponsorship at either the item or catalog level.

Sponsorship of the auction may occur through members of the constituent community submitting sponsorship data via a sponsorship entry web page accessed using the previously described processes of an embedded link in the electronic mail or an embedded icon on a web page. The data parameters describing the sponsorship by the constituent community using the sponsorship entry web page are placed in memory, as database records or objects as described with reference to records 2100-2114 of FIG. 21, and are stored in the form of library. An algorithm or server application which is part of engine 295 of system 250 loads the sponsor library information, as illustrated by procedure block 2700 FIG. 27, and determines from the data contained therein if any sponsors have donated amounts which at least equal or exceed a predetermined threshold for the auction, as illustrated by decisional block 2702. According to the invention, a nonprofit or charitable organization is able to define dollar thresholds for the appearance of donor logos and links and have the process automated by system 250. If the Fair Market Value of the item being donated, meets one of the predefined threshold criteria, whether determined by the auction committee or by a community donor, the inventive system enables ‘add logo’ or ‘add link’ graphics to be displayed when a donor is entering the information in the donor web page. The donor may then include a logo and are linked to the donor's web site which will appear in the on-line catalog, similar to that illustrated in FIG. 12. The data defining the such donor logo and link are stored in Donation Record 1708.

Referring again to FIG. 27, the placement parameters designated by the catalog author are next loaded from memory, as illustrated by procedural block 2704. The inventive system allows the catalog author to designate whether sponsors can be assigned at the catalog level or at the individual item level. The process utilizes the sponsor library data and the placement parameter data to sort through the sponsors and ranked them according to a criteria, such as total dollar value of items donated, sponsorship dollars, or frequency of donations, as illustrated by procedural block 2706. In the event that more than one sponsor exists at the same level of sponsorship, the sponsorship information may be rotated throughout the various pages of the catalog, on either a random or a weighted basis, as illustrated by decisional block 2708 and procedural block 2710. For weighted distribution, the frequency with which sponsorship information appears may be directly related to the sponsors value donated relative to other sponsors within a single threshold category or across multiple threshold categories. Thereafter, the sponsorships are rendered by populating the selected catalog page templates, similar to that illustrated in web page 2600 of FIG. 26, with the sponsor information 2602 including name, link to sponsor's web site, optional logo, photo, graphic and/or other sponsor information, and one or more featured items 2604-2606, as illustrated by procedural block 2712. The catalog, including the items and home pages are then rendered, as illustrated by procedural block 2714. The catalog is then rendered, as illustrated by procedural block 2714. The sponsorship ads may appear similar to that illustrated in ads 1200 of FIG. 12 or ads 3704-3708 of FIG. 37.

It is also contemplated with the present invention that one of the display parameters defined by the value of the sponsor's contributions to the auction can be, in addition to the placement and size of the window or display region within a web page template in which the sponsorship information is displayed, be the duration of the display. In this embodiment, one or more timer algorithms may be utilized in association with the algorithms for displaying and rendering a virtual catalog of the auction items and may terminate a sponsor's display or rotate through the various sponsor displays, stored with the sponsorship library, at predetermined timer generated interrupts or upon refresh of the web page. In process blocks 2710-2714 of FIG. 27, for embodiments in which multiple sponsors qualified for the same threshold category, a first-in-first-out queue or circular buffer may be utilized to store references to the respective records containing the sponsor information. Upon timer generated interrupts or upon refresh the sponsorship information the next reference is accessed and used to populate the web page. In this manner, a window or display region with a particular web page associated with the item or with the catalog, in general, may display information associated with more than one sponsor during a viewing/dibbing session.

Auction-a-Thon

According to another aspect of the invention, an inventive system, computer program and method enable participants of a competitive fund raising event, such as a walk-a-thon, bike-a-thon, climb-a-thon, etc. (a -thon event), and their supporters to donate items for a related charitable auction during the catalog building process and assign either the item value or the eventual sales price of a donated auction item to one or more -thon participant(s) using the methods detailed herein. According to this aspect of the invention, during the catalog building process an item donor can assign either the item value or the eventual selling price of the item to a -thon participant. The inventive technique also enables a donor to assign a value, based on dollars or percentage, to more than one -thon participant. If the donor is unaware of the -thon participant identifier (participant number, etc.) they can look up the identifier via a provided look-up function. The inventive technique also enables a bidder to assign a value, based on dollars or percentage, to more than one -thon participant, at the time the bid is made during the auction. The points are then credited to the designated competitor(s) at the time the winning bid is determined.

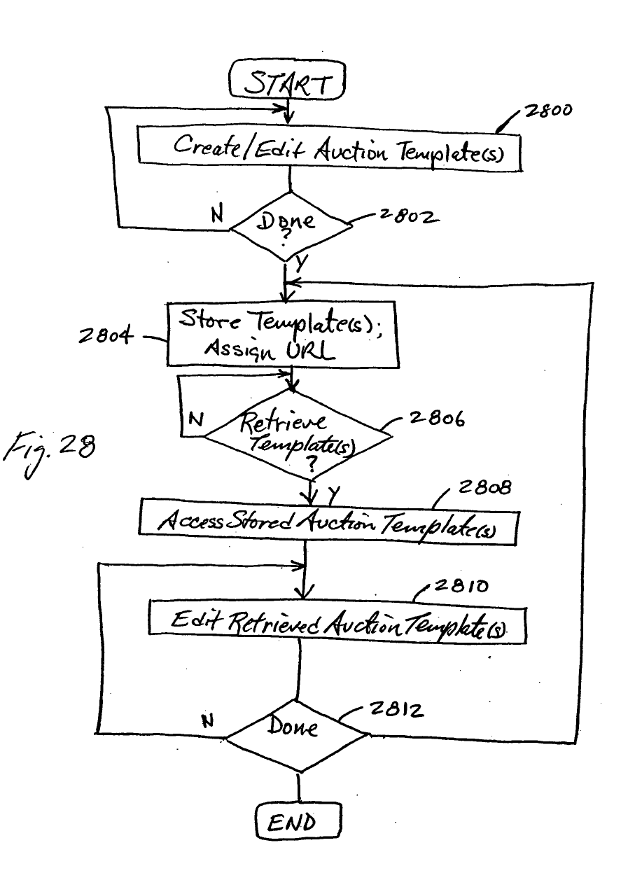

According to another aspect of the invention, a system and computer program and method allows an organization to enable, at the global event level or on a per item basis, the ability for donors and/or buyers in an auction to assign either the value of an item or the final selling price of an item to a specific chapter of an organization or to a specific organization when multiple organizations are participating in a common auction. Alternatively, a buyer or donor can specify a fraction or percentage of the value or selling price such that multiple causes, chapters, or organizations may receive partial credit on the donation or sale of an item. Optionally, the inventive system may provide an available look-up function to find causes, chapters, or organizations. Utilizing a database containing the data identifying the respective multiple causes, chapters, or organizations, an assignment process and a lookup process, as described with reference to FIGS. 30-33, may be utilized to implement such functionality, either at the time and item is donated to an auction or at the time a bid is submitted during the auction.

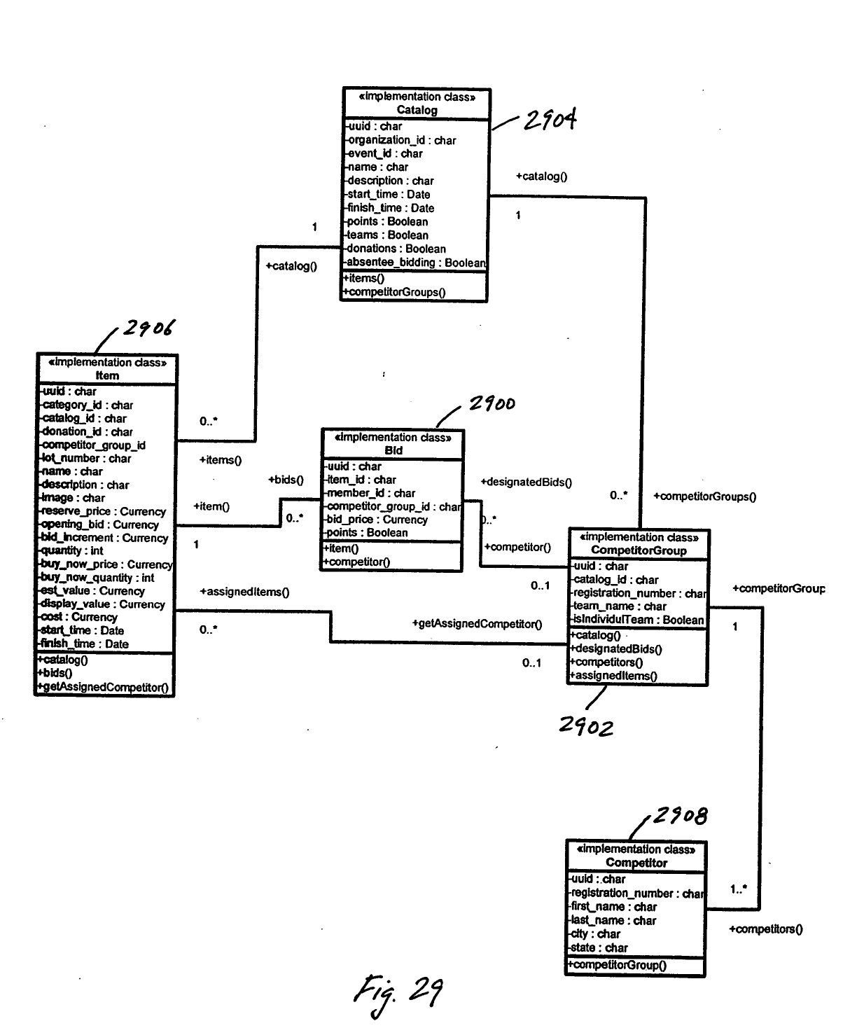

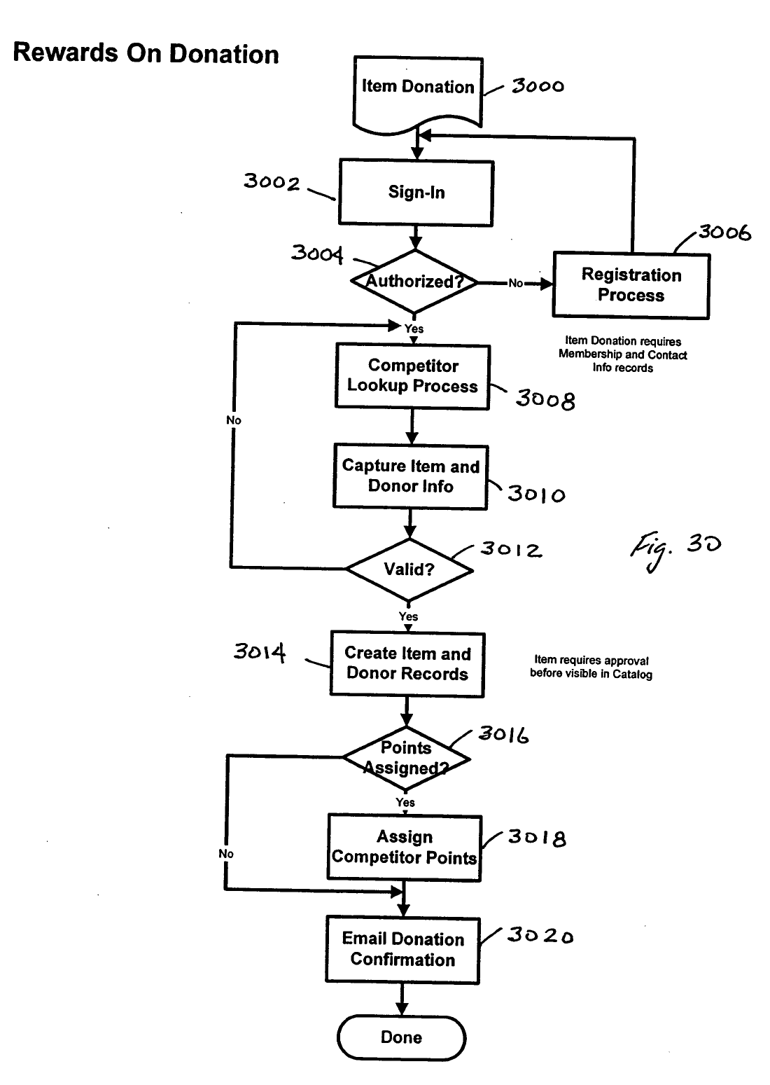

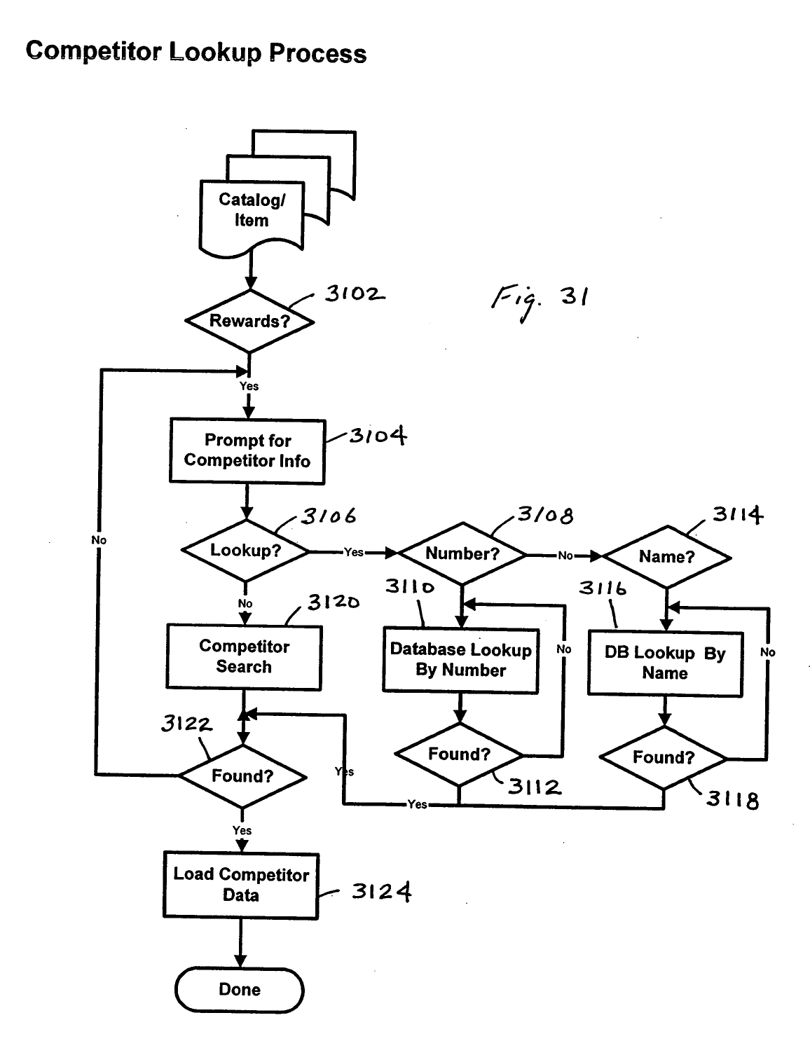

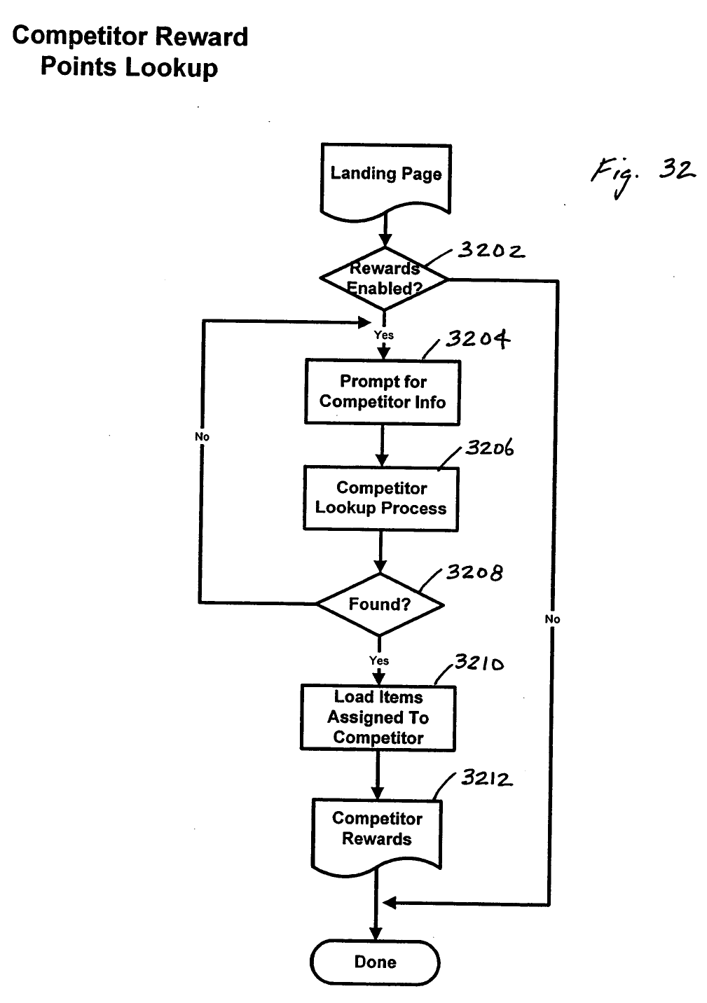

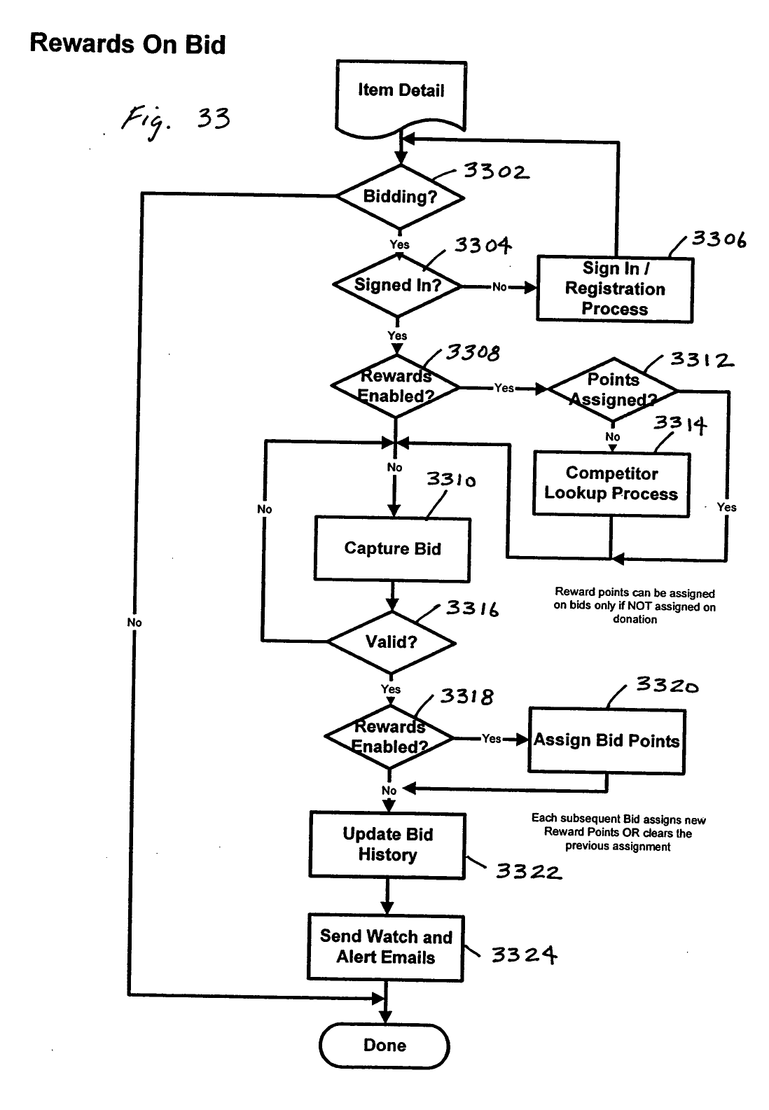

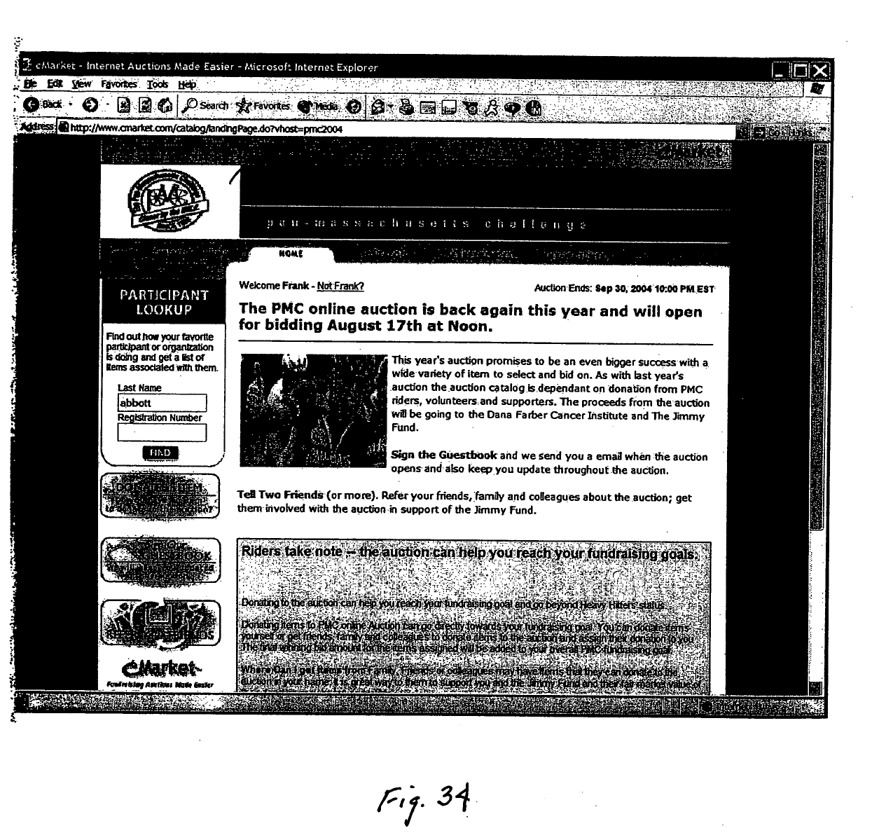

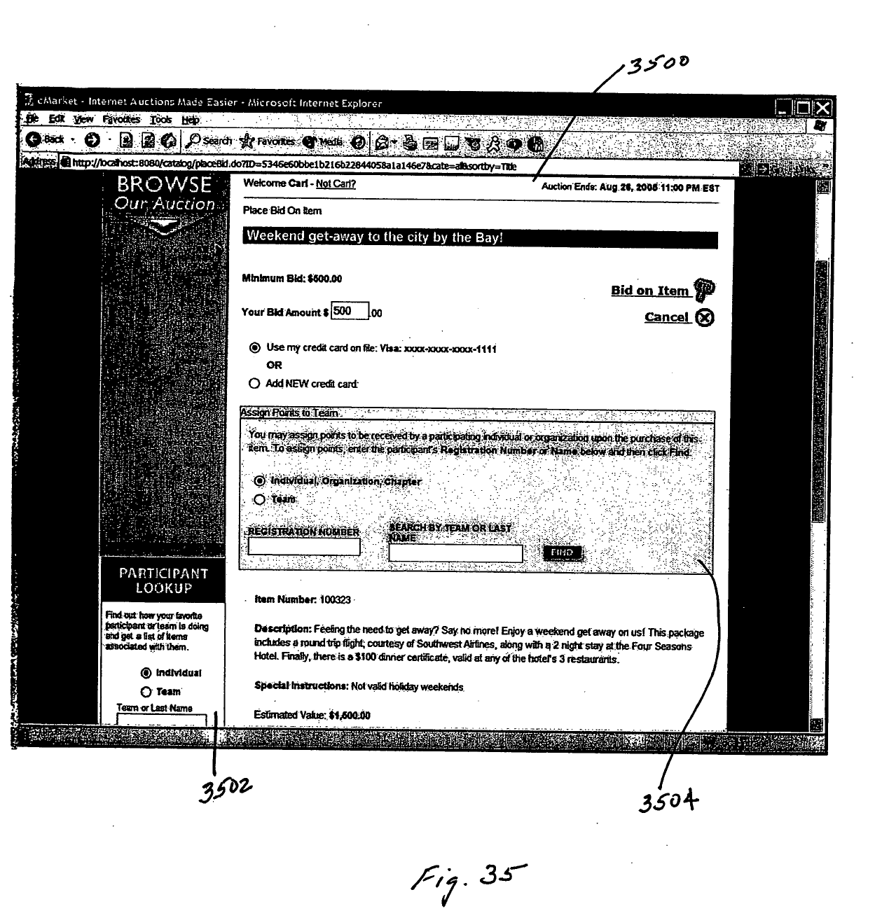

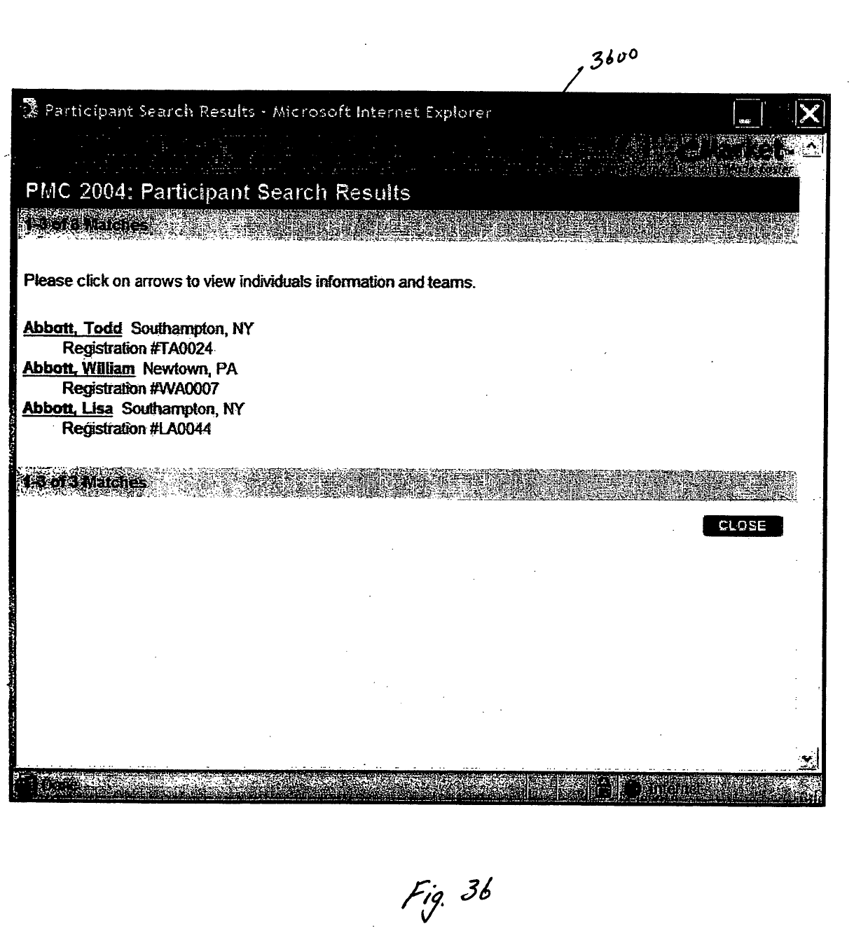

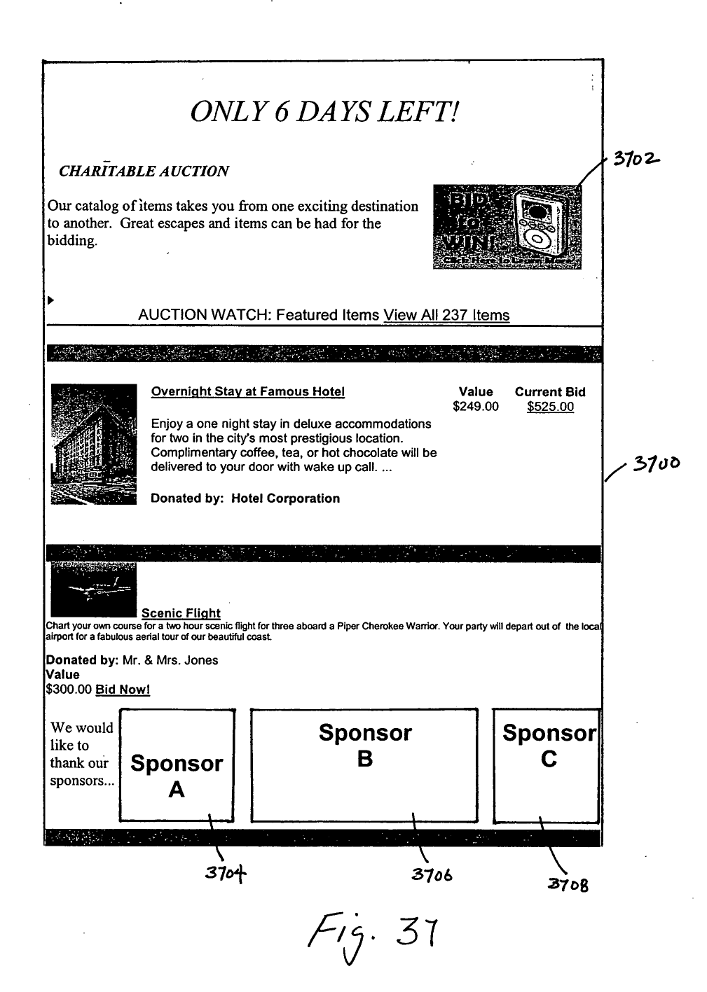

Referring to FIGS. 30-33, the flow diagrams of the processes utilized to allow -thon participants and their supporters to donate items for an auction in accordance with present invention are illustrated. Referring to FIG. 30, the process for awarding points to a competitor at the time of donating an item to an auction is illustrated. During the catalog building process the donor can assign either the item value or the eventual winning bid price of the item to the -thon participant. Utilizing the techniques described with reference to FIGS. 9A-D and 10, the inventive system 250 enables a nonprofit or charitable client to request that their constituency donate items for an auction, either via electronic mail with an embedded link or through an embedded icon on a web page. The link embedded in the electronic mail or the embedded icon on the web page leads to a catalog item entry web page 3000. If enabled by the charitable organization, the constituent can assign “points' associated with an item to a particular participant, cause, chapter, or organization for credit. Such reward points may or may not have a one to one correspondence with a particular currency. The constituent first signs in to the auction, as illustrated by procedural block 3002. The system then determines whether the constituent is authorized to proceed, as illustrated by decisional block 3004. If the constituent is authorized they proceed to a web page, such as web page 3400 of FIG. 34, which includes a user interface 3402 for identifying a competitor or participant in the competitive event. The competitor lookup process, illustrated by procedural block 3008 of FIG. 31, is explained in greater detail with reference to FIG. 31. If the constituent is not authorized, typically because they are not registered, the process may proceed to a web page including a registration interface for registration by the potential donor. In the contemplated embodiment, donation of an item to an auction requires membership and the contact information to be recorded, as illustrated by procedural blocked 3006.

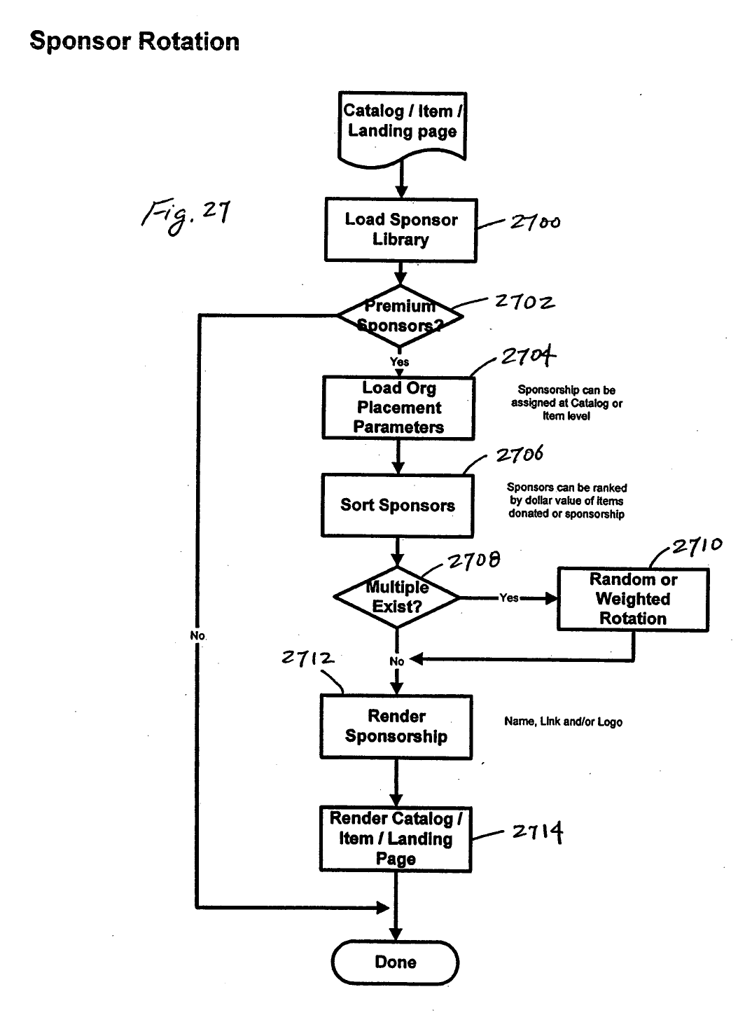

Once a competitor to the -thon event has been identified in procedural block 3008, the information regarding the donated item and the donor are entered through the user interface of a web page, as illustrated in procedural block 3010. Thereafter, the system determines whether the information entered in the prior procedurals steps is a valid, as illustrated by decisional block 3012. If not, for example, for failure to identify a registered competitor to the -thon event, the process returns to 's it's procedural block 3008. If the system validates the competitor, donor and item data, and reward points, the item record 2906 of FIG. 29 are created, as illustrated by procedural block 3014. Thereafter, the donated item(s) are queued for review by auction committee members who can either accept, edit or reject item(s) within the queue, as described with reference to FIG. 10 herein. Once the donated item has been accepted for the auction catalog, the system determines whether the donor has assigned points to be associated with the donated item, as illustrated by decisional block 3016, and, if so, the associated points are assigned to the designated competitor(s), as illustrated in procedure step 3018. This process typically occurs through examination of the item and/or donor records to determine the number points and the competitor(s) designated. Thereafter, an electronic-mail message is generated and sent by the system 250 to the constituent donor to confirm the conditions surrounding the donation, as illustrated by procedural block 3020. If, in the above-identified donation process, less than all of the points associated with a donated item were assigned to an identified competitor, steps 3008 through 3020 may be repeated for additional competitor(s), allowing the constituent to spread the points associated with the donated item amongst plural competitors.

FIG. 31 illustrates in greater detail the competitor lookup process of procedural block 3008 of FIG. 30. Specifically, if the auction administrator has allowed reward points to be associated with donated items, as illustrated by decisional block 3102, the constituent donor will be prompted through a user interface, such as user interface 3402 of FIG. 34 or user interface 3502 of FIG. 35, for information identifying the competitor, as illustrated by procedural block 3104. If the donor is able to identify the competitor, they may enter part or all of the data identifying the competitor and prompt the system to search the database of records for competitors to a certain -thon event, as illustrated by decisional block 3120. If the donor is unable to identify the competitor, they may enter one or more of the requested data items, such as the team or individual name and/or number, and prompt the system to search the database of records for competitors to a certain -thon event, as illustrated by decisional block 3106. The contemplated system allows the donor to look up a competitor by number, as illustrated by decisional and procedure blocks 3108, 3110 and 3112, or by name, as illustrated by decisional and procedure blocks 3114, 3116 and 3118. If a competitor is identified, as illustrated by decisional block 3122, the record identifying the competitor will be retrieved and loaded, as illustrated by procedural block 3124. For example, if the donor/bidder enters the name “Abbott” as a query to search the database records for participants, a listing of “hits” satisfying the query is presented and may be similar to exemplary results illustrated in page 3600 of FIG. 36. The user may then select one of the found records to view the information about the individual and/or teams located. Upon selecting one of the found records, the inventive system may display the personal web site URL for the competitor/participant along with their name, participant number, etc. resulting in an automatically generated link from the competitor name to their web page or site. If in decisional block 3122, a competitor is not identified, the system returns to procedural block 3104 and again prompts the donor to enter the data identifying the competitor.

It is contemplated within the inventive technique and system that the value, either the total value of items donated or total value of items sold, is tracked per participant. Referring to FIG. 32, the process by which competitors or constituents may review the amount of reward points associated with a specific individual or competitor profile is illustrated. Specifically, if the auction administrator has allowed points to be associated with donated items, as illustrated by decisional block 3202, the constituent donor will be prompted through a user interface, such as user interface 3402 of FIG. 34 or user interface 3502 of FIG. 35, for information identifying the competitor, as illustrated by procedural block 3204. If the donor is unable to identify the competitor, they can perform a competitor lookup process, similar to describe with reference to FIG. 31, and as illustrated by procedural block 3206. If a competitor is identified, as illustrated by decisional block 3208, the system will review the records within the database associated with the identified competitor and provide a value representing the total cumulative points associated with the identified competitor in the auction event, to date, as illustrated by procedural block 3210 and 3212. Optionally, as part of procedural block 3212, each participant may view, at any time, the status, total value and current bids or sales prices, of the items donated and whose associated reward points are assigned to the competitor. The format in which so such information is presented may be similar to that illustrated in FIG. 24, with applicable changes relative to the number of auctions and the status of items within an auctions.

If, at the time of bidding for an item, the reward points associated with the item have not yet been assigned to one or more of the competitors to the -thon event, the party bidding on the item may designate to which competitor the points should be assigned, if the submitted bid is the winning bid. Referring to FIG. 33, the process by which the system enables bidders to assign award points at the time of bid the submission is illustrated. Specifically, if a party wishes to bid on an item in an on-line auction, the potential bidder must first sign in, as illustrated by decisional blocks 3302 and 3304 and procedural block 3306, if necessary. The bidder may then assign points to an individual, organization, chapter, or team using a user interface, such as user interface 3504 illustrated in FIG. 35, which utilizes a look-up process similar to that described previously. Once a bid has been submitted, the inventive system determines if the rewards for the particular item have been enabled, as illustrated by decisional block 3308. If not, the system captures the data entered through the user interface which defines the bid, typically including an item identifier, the bid price or maximum bid price, and a donor identifier, as illustrated by procedural block 3310. If the rewards have been enabled, the system determines if the points associated with the item have been assigned to one of the competitors, as illustrated by decisional block 3312. If the points have already been signed, as for example at the time the item was donated, the process flow proceeds to procedural block 3310 where the data defining the bid is captured, as described previously, with the addition of the data identifying a competitor to which the reward points were assigned. Otherwise, if the points associated with the item have not yet been assigned, the system enables the potential bidder to enter the competitor lookup process similar to that described with reference to FIG. 32, and as illustrated herein as procedural block 3314. Once the system captures the bid data, the bid data is compared to the corresponding values within the database in order to validate the same and determined that the bid is currently the highest submitted bid, as illustrated by decisional block 3316. Thereafter, the system again determines if rewards are enabled for the subject item, as illustrated in decisional block 3318, and, if so, the bid points are assigned to the identified competitor, as illustrated by procedural block 3320. The bid history is then updated has illustrated by procedural block 3322. Once the bid history for the item has been updated and stored, the system generates a number of electronic mail communications to other potential bidders who may be watching the item, as well as to the current high bidder confirming the bid, all as illustrated by procedural block 3324. Note that each subsequent higher bid assigns the reward points to the high bidder's competitor of choice and clears the rewards from the competitor of choice from the lower, prior bidder. In this matter, the reward points associated with the donated item will be assigned to the competitor of choice only by the winning bidder. Alternatively, the assignment of reward points associated with an item may be a temporarily held until the auction for the item has completed and has been paid for, after which the points may be awarded to the winning bidder's competitor of choice.

The process is described with reference to the flowcharts of FIGS. 30-33 and elsewhere herein, as applicable, utilize the records and data structures illustrated in FIGS. 17-21 and 29. Specifically, FIG. 29 illustrates the relationship between Bid Record 2900, CompetitorGroup Record 2902, Catalog Record 2904, Item Record 2906, and Competitor Record 2908. The nature of the data type used to implement each variable within the records, is illustrated in FIG. 29. Catalog details are maintained in the Catalog and Item records as described herein. One or more Catalog records 2904 can exist for each -thon event associated with an auction of one.

In the illustrated embodiment, Catalog Record 2904 comprises the following variables:
uuid
organization_id
event_id
name
description
start_time
finish_time
points
teams
donation
absentee_bidding

In Catalog Record 2904 the uuid data may be implemented similar to record 2901 and serves as a primary key to identify a catalog. The organization_id variable identifies the parent organization, e.g. the nonprofit or charitable entity holding the event. The event_id variable identifies the corresponding Event Record to which the live event record corresponds. The name and description variables describe the name and nature of the catalog, respectively. The start_time variable, if present, overrides the event start date and time. The finish_time variable, if present, overrides event close date and time. Rewards assignment is specified at the catalog level. The points attribute is used to indicate whether or not reward assignments is enabled. The teams attribute specifies whether or not individual or team assignments are used. In either case, points can be distributed among several individuals or across multiple teams.

The points variable is a flag to indicate if a rewards program enabled. The teams variable is a flag to indicate if a reward is to be assigned to a team versus an individual competitor. The donation variable is a flag to indicate if donations are accepted. The absentee_bidding variable enables absentee bidding in live events. As illustrated in FIG. 29, the +items( ) method can be used to call one or more items associated with the catalog using the appropriate item identifier. The +competitorGroups( ) method can be used to call the competitor group associated with the catalog using the appropriate identifier.

Item properties are stored in item records. An Item Record 2906 exists for each item associated with a particular Catalog Record 2904 and has the form illustrated in FIG. 29. In the illustrative embodiment, items may be a composite parent auction item or be a component thereof as described herein. In the illustrated embodiment, Item Record 2906 comprises the following variables:
uuid
category_id
catalog_id
donation_id
competitor_group_id
lot_number
name
description
image
reserve_price
opening_bid
bid_increment
quantity
buy_now_price
buy_now_quantity
est_value
display_value
cost
start_time
finish_time

The nature of the data type used to implement each variable is illustrated in FIG. 29. In Item Record 2906 the uuid variable serves as a primary key to identify an item. The category_id variable identifies the item category of the auction item. The catalog_id variable identifies the catalog record of the auction item. The donation_id variable identifies the donation record if the item was donated by constituency. The optional lot_number variable identifies the lot of the auction item. The competitor_group_id variable identifies the competitor group record 2902 with which the item is currently assigned using the +getAssignedCompetitor( ) method call. The name variable identifies the name of the auctioned item. The description variable provides a description of the auctioned item. The image variable identifies the name of the image file associated with the auctioned item and a link, where applicable. In the illustrative embodiment, the image file may be stored on a webserver, with only the name referenced in one of the local databases of system 250. The image file may be formatted in any number of conventional image data formats, including, but not limited to JPEG, GIF, PNG, etc. The reserve_price, opening_bid, bid_increment, and buy_now_price identify the amounts in currency of the reserve price, opening bid, bid increment, buy item now price of the auction item, respectively. The quantity variable identifies the number of auction items available. The buy_now_quantity variable identifies the number of auction items available or that must be purchased to achieve the buy_now_price. The est_value variable identifies the estimated value (fair market value) of the item used for printing purchase receipts. The display_value variable identifies the estimated value to be displayed in either the printed or on-line catalog associated with the auction item. The cost variable identifies the amount in currency of any cost to purchase the auction item, or component auction items, if any. The start_time variable identifies the date and time at which the auction for the item commences. The finish_time variable identifies the date and time at which the auction for the auction item is complete.

In addition, the item record 2906 has at least three methods associated therewith that can be used to call other records containing data values related to the item record. As illustrated in FIG. 29, the +catalogs( ) method can be used to call one more catalogs associated with the item using the appropriate catalog identifier. The +bids( ) method can be used to call up the record associated with the bid using the appropriate identifier. Similarly, the +getAssignedCompetitor( ) method can be used to call the data associated with the currently assigned competitor using the appropriate identifier.

Bid details are maintained in the Bid records 2900 as described herein. One or more bid records 2900 can exist for each item. In the illustrated embodiment, Bid Record 2900 comprises the following variables:
uuid
item_id
member_id
competitor_group_id
bid_price
points

The nature of the data type used to implement each variable is illustrated in FIG. 29. In Bid record 2900 the uuid data may be implemented similar to record 2902 and serves as a primary key to identify a bid. The item_id variable identifies the item with which the bid is associated. The member_id variable identifies the participating member to the auction that submitted the bid. The competitor_group_id variable identifies the competitor group record with which the bid is currently associated. The bid_price variable identifies the price with which the bid is currently associated. The points variable identifies is a flag that indicates whether points associated with the item bid are assignable to one of the competitors if the bid is successful. As illustrated in FIG. 29, the +item( ) method can be used to access data relating to the item associated with the bid using the appropriate item identifier. The +competitor( ) method can be used to access one or more competitors associated with the bid using the appropriate identifier.

In the illustrated embodiment, CompetitorGroup 2902 comprises the following variables:
uuid
catalog_id
registration_number
team_name
isIndividualTeam

In CompetitorGroup record 2902 the uuid is a unique universal identifier and may be implemented with a multiple bit field of alphanumeric data. The uuid data serves as a primary key to identify a competitor group, e.g. 18 participating in the competitive -thon event. The catalog_id variable identifies the catalog record associated with the competitive group. The registration_number variable identifies the registration data associated with the competitor group. The team_name variable identifies the name of the competitive group. The isIndividualTeam variable is a flag to indicate if the team comprises an individual competitor.

In addition, the CompetitorGroup record has four methods associated therewith. As illustrated in FIG. 29, the +catalogs( ) method can be used to call one more catalogs associated with the Competitor Group using the appropriate identifier. The +designatedBids( ) method can be used access the data associated with a bid record 2900 with which the competitor group is currently associated. The +assignedItems( ) method can be used to call one or more items currently assigned with a competitor group using the appropriate item identifier. The +competitors( ) method can be used to call the competitors comprising the competitor group using the appropriate identifier.

In the illustrated embodiment, Competitor 2908 comprises the following variables:
uuid
catalog_id
first_name
last_name
city
state

In Competitor record 2908 the uuid is a unique universal identifier and may be implemented with a multiple bit field of alphanumeric data. The uuid data serves as a primary key to identify a competitor participating in the competitive -thon event. The registration_number variable identifies the registration data associated with the competitor. The first_name and last_name variables identify the first and last names, respectively, of the competitor. The city and state variables identify the city and state, respectively, of the competitor's address. In addition, the Competitor record has a +competitorGroup( ) method that can be used to access the competitor group with which the competitor is associated using the appropriate identifier.

Using the process outlined with reference to FIG. 30, upon item donation, an assignment of the points associated with the auction item can be made to one of the competitors. Thereafter, further assignments are not possible. Donation assignments are awarded only for donated items that have been approved for acceptance and publication in a catalog. Reward assignments upon donation are done through the user interface similar to that of interface 3504 of FIG. 35, for both individual and group assignments. The data structure illustrated in FIG. 29 is aware when an individual versus a group assignment is made. Alternatively, using the process outlined with reference to FIG. 33, bid assignments are only possible when there has been no competitor assigned on item donation.

The reader can appreciate that the processes described above with reference to FIGS. 30-36 enable the merging of an on-line auction with other fundraising events, such as walk-a-thon, bike-a-thon, climb-a-thon, tele-a-thons, etc., so that participants and their supporters can donate items for an auction to increase a participant's chance of raising the most money. Such a hybrid, compound event increases competitive nature of the fundraising, ultimately resulting in greater amounts of funds raised for the nonprofit or charitable organization. In the present invention, the terms “participant” and “competitor” are used interchangeably and have the same meaning.

Although the inventive concepts disclosed herein have been described with reference to implementations regarding auctions for nonprofit or charitable entities, the inventive concepts may equally apply to commercial or any other auction in which it is a desirable to combine multiple auction items. For example, in commercial auctions, the donor may correspond to a seller or seller(s) while the charitable entity, as well as the persons authorized to edit the auction items, may be from the same or separate business entities, such as auction hosting services, auction houses, or other online services. In addition, with the auction-a-thon it is contemplated that an auction may be combined with any other type of competitive event or contest, including intellectual activities, games of skill, etc. and is not limited to athletic competitions.

Although the inventive concepts disclosed herein have been described with reference to implementations in an object-oriented environment, other programming techniques utilizing other data structures and memory configurations may be similarly utilize to achieve the same results as the inventive system described herein. For example, the record structures may be implemented other than as objects and the described databases may be implemented in different configurations, redundant, distributed, etc., while still achieving the same results.

Assignment of Value to Plural Causes or Organizations

According to another aspect of the invention, either alone or in conjunction with a competitive fund raising event, a system and computer program and method allows an organization to enable, at the global event level or on a per item basis, the ability for donors and/or buyers in an auction to assign either the value of an item or the final selling price of an item to a specific chapter of an organization or to a specific organization when multiple organizations are participating in a common auction. Alternatively, a buyer or donor can specify a fraction or percentage of the value or selling price such that multiple causes, chapters, or organizations may receive partial credit on the donation or sale of an item. Optionally, the inventive system may provide an available look-up function to find causes, chapters, or organizations. Utilizing a database containing the data identifying the respective multiple causes, chapters, or organizations, an assignment process and a lookup process, as described with reference to FIGS. 30-33, may be utilized to implement such functionality, either at the time and item is donated to an auction or at the time a bid is submitted during the auction. In this regard, terms “participant” and “competitor” can also be used to designate any entity that functions as the beneficiary of the auction or competitive event proceeds, for example, a charitable organization, a subchapter of national or global organization, or any other cause(s). For example, in a national on-line auction to benefit the United Way, the donor or the high bidder of a particular auction item may be able to designate a particular local chapter of the United Way chapter as recipient of the points or value of an auction item. In this manner, the “participant” and “competitor” of the processes, algorithms and data structures described with respect to FIG. 29-36, are not limited to individuals or teams of individuals, but may comprise any entity including but not limited to organizations, chapters of organizations, subchapters, or other causes, etc., benefiting from the fundraising activities.

Given the detailed description herein, particularly with regard to FIGS. 29-36, of how either the donor or high bidder can assign the value of an auction item to a single or multiple competitors within a competitive event, it will be obvious to those recently skilled in the arts how the appropriate data structures and algorithms may be modified to so that similar assignments can be made not to individuals, or groups of individuals, but to charitable organizations or other entities.

Bid Driver Promotion

According to another aspect of the invention, the inventive system allows an organization to enable the embedding of a promotion within an auction. The purpose of the promotion is too encourage bidding from a constituency. An item or service, supplied by the nonprofit or a third-party, is offered as a promotion prize. In the illustrative environment, the promotion is selected and enabled by a auction creator the auction creation process, as described herein.

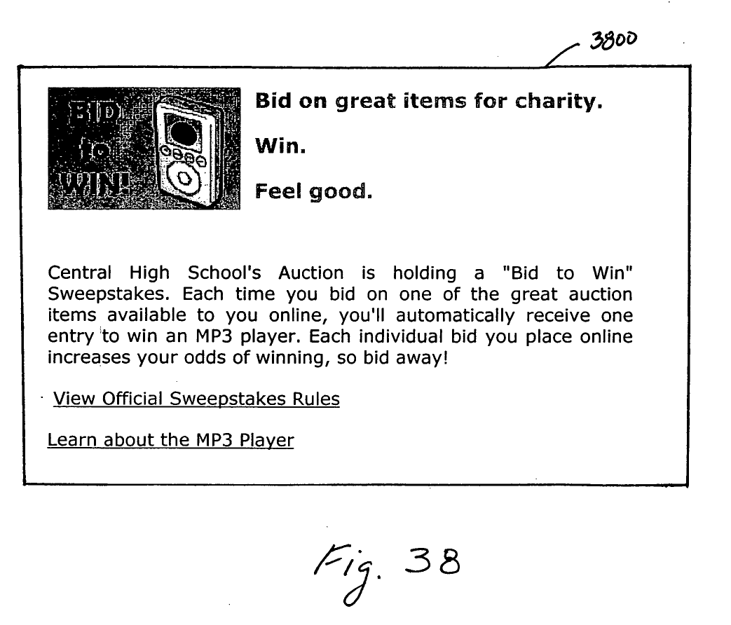

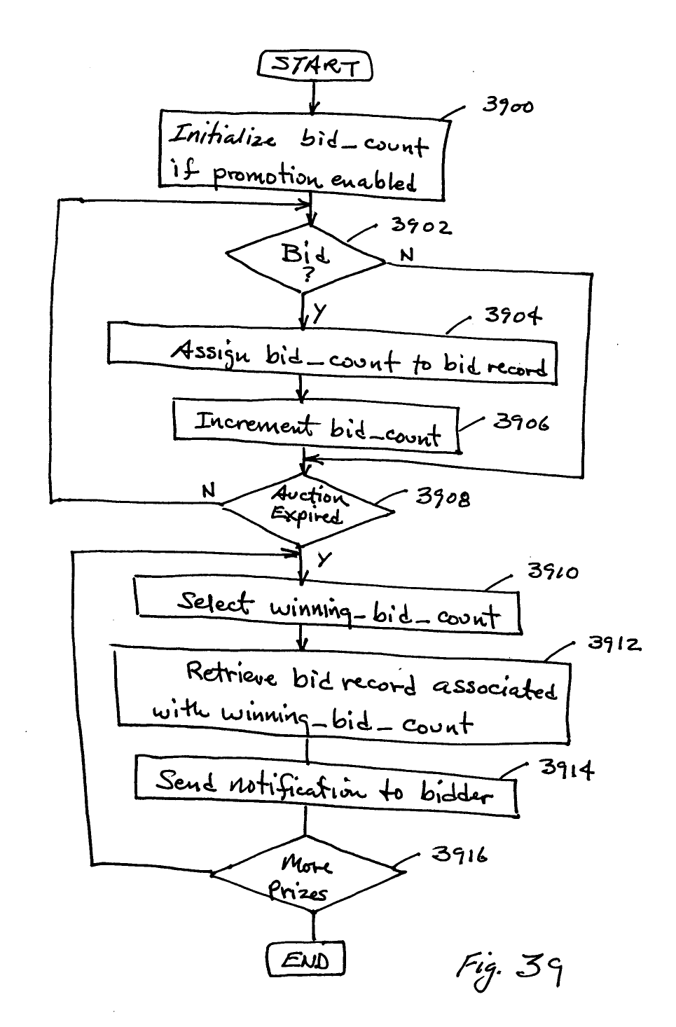

Referring to FIG. 37, a graphic element, such as “Bid to Win” button 3702 is embedded on each web page 3700 of the auction catalog and in each auction communication. Button 3702 may include a link to an other web page, such as web page 3800 of FIG. 38, which may provide a written description of the promotional prize and the contest, in general, and may include, optionally, links to other web pages describing the contest rules and/or the prize item in greater detail. Each bid placed results in an entry in the contest, e.g. five bids equal five entries, etc. The winning bidder may be selected using the algorithms outlined in FIG. 39 or other equivalent algorithms. An announcement can be sent to all constituents with the promotion details. The auction creator can automate the electronic mail process so that, on a frequency determined by the auction creator, electronic mail communications are generated to their constituency with the current status of the promotion, the number of contest entries for a constituent bidder, and, optionally, a list of ‘frequent bidders’.

The data records and parameters describing an auction and its respective catalogs and bids are described with regard to records 1700-1712 of FIG. 21 and their accompanying descriptions. Similarly, the data parameters describing an auction bid are described with regard to record 2900 of FIG. 29 and their accompanying descriptions. The bid driver promotion aspect of the invention utilizes an additional data record associated with a catalog auction that includes the following variables:
bid_count
winning_bid_count
bid_driver_promotion
prize_id
prize₁₃ winner

The bid_count variable may be implemented as an integer value that is unique to each bid submitted in association with a auction item in an event. In the illustrative embodiment, each record 2900 includes an additional bid_count variable which is defined with a value at the time the bid is approved as a legitimate bid. The most recent value of the bid_count variable is also stored in the catalog record 1704 and updated each time the value is modified and written to a bid record 2900. In this matter, the current value of the bid_count variable is always associated with a particular catalog record. Also associated with catalog record 1704 are the winning_bid_count, bid_driver_promotion, prize_id, and prize_winner variables. The bid_driver_promotion may be implemented with a Boolean variable used to indicate whether a promotion is associated with the relevant catalog/event. The winning_bid_count may be implemented with an integer value and represents one of the bid_count values selected from the range of bid_count values assigned prior to expiration of the auction event. The prize_id and prize_winner variables may be implemented with alphanumeric character strings and identify the prize and the prize recepient (i.e. the bidder associated with the winning_bid_count), respectively.

Referring to FIG. 39, a server application which is part of engine 295 of system 250 determines whether the bid_driver_promotion variable associated with an auction is enabled, and, if so, initializes the bid_count variable to a starting value, typically 0, as illustrated by procedure block 3900 of FIG. 39. Next, as bids are submitted on-line, the same application, or specialized server application, monitors when submitted bids are accepted, and assigns the current value of the bid_count variable to the corresponding bid record, as illustrated by decisional block 3902 and procedural block 3904.

Thereafter, the current value of the bid_count variable is incremented, as illustrated by procedural block 3906. A subroutine for incrementing the bid_count value associated with the auction/catalog record may be utilized to increment the current bid_count value. Alternatively, a subroutine for decrementing an initialized bid_count value or a counter algorithm, initialized in procedure block 3900, may be utilized to modifiy the bid_count value with each successive bid submitted during the auction to achieve the same effect. Next, the same application, or a specialized server application, monitors when the auction has expired, as illustrated by decisional block 3908. While the auction is still on going, the processes described with reference to blocks 3902-3908 are repeated until the auction has expired.

Once the auction has expired, as indicated by the finish_time value in record 2004, for example, a value for the winning_bid_count is selected randomly from within the range of bid_count values assigned during the auction from the initial value to the most recent value of bid_count, as illustrated by procedural block 3910. Depending on the implementation of the algorithm illustrated in FIG. 39, the current value of the bid_count variable may need to be decremented one. For example, if the bid_count variable is initialized to zero the last unassigned value of the bid_count variable at the time of auction expiration is 975, the total number of bids during the auction is 974, utilizing the algorithm illustrated in FIG. 39. Accordingly, the value for winning_bid_count is selected from 0 to 974.

In the illustrative embodiment, the value for the winning_bid_count may be selected randomly using any number of known random number generation algorithms provided with the range endpoint values. Note, the more bids a bidder submits, the greater the chance of one of his/her bid_count values being chosen as the winning_bid_count. Once the value of the winning_bid_count has been established, the bid record having the matching value is retrieved, as illustrated by procedural block 3912, the value of prize_winner is set to the bidder identifier, and a notification to the bidder associated with that bid record is sent indicating that they have won a promotional prize, as illustrated by procedural block 3914. It is contemplated with the present invention that more than one prize may be associated with a particular auction event. Accordingly, a determination is made if other unawarded prizes remain, as illustrated by decisional block 3916, and, if so, the algorithm of process blocks 3910-3914 are repeated for each prize yet to be awarded.

As an alternative to having the value of the winning_bid_count selected automatically, especially if the auction is associated with a live event, the value on the winning_bid_count may be selected manually, with a traditional drawing or other technique. The reader will further appreciate that other algorithms may be utilized to identify the recipient of the prize as would be obvious to those reasonably skilled in the arts given the disclosure set forth herein.

Winning Bidder Round-Up

According to another aspect of the invention, a system and computer program and method enables a nonprofit organization, as part of the auction preferences set-up, to optionally include the ability to suggest a ‘round up’ amount to any winning bidder. If enabled, the system will automatically suggest a ‘round up’ purchase price above the winning bid. For instance, ‘round up’ any winning bid to the amounts that is the next higher multiple of ten, e.g. for a winning bid of $53, the inventive system suggests a round up to $60. The bidder would be informed where the ‘round up’ amount will be utilized, or, alternatively can designate to which competitor participant in a -thon, as described previously, the points should be rewarded. The bidder has the option to disregard the ‘round up’ price and continue the close-out with the original winning bid.

The data records and parameters describing an auction and its respective catalogs are described with regard to records 1700-1712 of FIG. 21 and their accompanying descriptions. Similarly, the data parameters describing an auction bid are described with regard to record 2900 of FIG. 29 and their accompanying descriptions. The round up aspect of the invention utilizes an additional data record associated with a catalog/auction that includes the following variables:
round_up threshold
round_up_percent
round_up_bid
round_up

The round_up variable may be implemented with a Boolean variable and is used to indicate whether a promotion is associated with the relevant catalog/event. The round_up_percent variable may be implemented with a floating point number and represents a scaling factor by which the winning bid is multiplied. For example, the auction creator may determine that all winning bids should be encouraged to round up the amount by 10%. In this instance the round_up_percent value will be 1.10, that is 110% of the winning bid value. The round_up_threshold variable may be implemented with an integer or floating point number and represents the round up threshold, e.g. the next higher multiple of five, the next higher multiple of ten, the next higher multiple of twenty five, etc. or any amount desired, e.g. plus $10, plus $15, etc., that the winning bid amount from bid record 2900 should be increased too. The round_up_bid may be implemented with a currency value and represents the product of the winning bid and the round_up_percent value plus the difference amount necessary to reach the round_{—}up_threshold. In the illustrative embodiment, the round_up_bid would be calculated as the product of the winning bid value and the round_up_percent value, i.e. an intermediate value, summed with the difference between the intermediate value and the next higher multiple value. Using the previous example, for a winning bid of $53, and a round_up_percent of 1.10, and a round_up_threshold to the next higher multiple of ten, the round_up_bid would be calculated as follows:
(($53)(1.10))+($1.70)=$60.00
The above calculation has the dual benefit of ensuring that each round_up_bid will be greater that the winning bid by at least the round_up_percent and be a multiple value as well. In an alternative embodiment, the round_up_percent value may be eliminated and the round_up_bid computed simply as the sum of the of the winning bid and the difference between the winning bid and the next higher multiple value. Note that the calculations necessary to determine the difference between the winning bid and the next higher multiple value of the round_up_threshold amount are within the comprehension of those skilled in the arts. In another alternative embodiment, the round_up_threshold value may be eliminated and the round_up_bid computed simply as the product of the winning bid and the round_up_percent. Following calculation of the round_up_bid, the system would prompt the winning bidder through a payment web page interface of the auction or an email communication if he/she would like to round up the payment to $60.

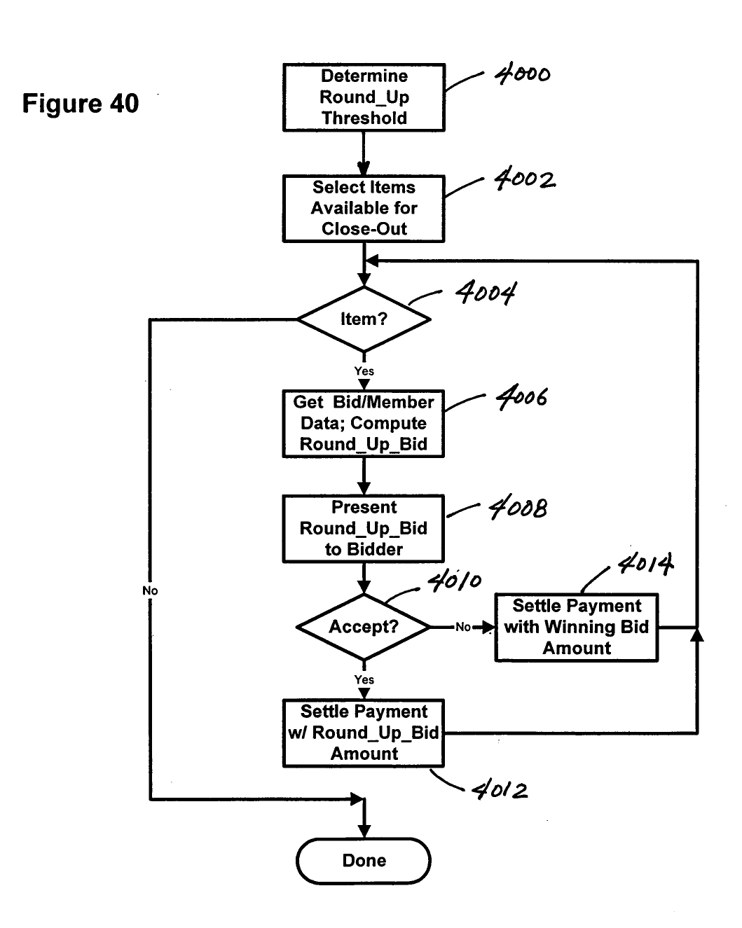

Referring to FIG. 40, a server application which is part of engine 295 of system 250 determines the valueof the round_up_threshold, as illustrated by procedure block 4000 of FIG. 40. Next, as auctions expire, the same application, or specialized server application, determines which auction items can be closed, as illustrated procedural block 4002. If the bidding for an auction item has closed, the bid record for the item is retrieved and the value for the round_up_bid is calculated, as previously described, and as illustrated by decisional block 4004 and procedural block 4006. Next, the system presents the winning bidder through a payment web page interface of the auction or an email communication with the suggested round_up_bid and asks if he/she would like to round up the payment to the suggested value of the round_up_bid, as illustrated by procedural block 4008. Such presentation may come in the form of a graphic element, having an accept or reject button. If the bidder accepts the alternative suggested round_up_bid amount, the payment will be settled using the round_up_bid, as illustrated by decisional block 4010 and procedural block 4012. Otherwise, the payment will be settled using the original winning bid price from bid record 2900, as illustrated by decisional block 4010 and procedural block 4014. This process continues until all items have had payment processed. It will be obvious to those reasonably skilled in the art that other algorithms may be utilized to arrived at a round_up_bid value value. For example, using a dialog box, a bidder may enter his own rounded amount that can be any amount greater than the winning bid amount. Optionally, a statement reiterating that the payment proceeds go to benefit the relevant charity or non-profit organization may also be displayed along with the suggested value of the round_up_bid.

Process for Handling Rejected Electronic Payments

According to another aspect of the invention, a system and computer program and method enables a nonprofit organization, as part of the auction preferences setup, to determine whether the process for clearing a rejected credit card or electronic payment transactions is to be resolved automatically or manually, thereby enabling the nonprofit to specify, as part of the auction process, how much time a successful bidder has to correct a payment problem.

Most items purchased on-line utilize credit cards, debit cards, value-added cards or electronic payment services, such as PayPal. If there is a problem completing the transaction because the credit card will not clear, the charitable organization does not wish to lose sale proceeds and will typically provide a limited time in which the winning bidder can clear the credit card problem. Otherwise, the auction item will be awarded to the next highest bidder. In accordance with the present invention, the process of handling rejected credit card transactions in notifying the potential winning bidder may be completely automated. If the credit card used to pay for a winning bidder does not clear within the typically excepted transaction processing time, an electronic mail message is automatically sent to the credit card holder detailing the problem and informing them of the time period they have to correct the problem. A link to the corresponding credit card page for the auction is embedded in the electronic mail to expedite access. The electronic mail communication also informs the winning bidder that if the problem is not corrected within the designated time period, the winning bid will revert to the previous high bidder. If the winning bidder is unable to provide payment for the item, an electronic mail communication will be sent to the next highest bidder informing them that they have won the auction for that item and also providing them with a fixed period of time in which to acknowledge purchase of the item. This process will continue, until a successful winning bidder pays for the item in the appropriate manner. A database associated with the system 250 maintains the bidding history and information for each bidder for an auction item, at least until the item has been purchased. Using the techniques described above, where applicable. the above-described system also ensures the rewarding of points to the competitor designated by the bidder who timely pays for the item. Automatic electronic mail messages maybe generated and sent the auction committee informing them of the initial rejection and, at various times, of the status of the process to correct/find a winning bidder. Messages may also be generated and sent to bidders who were unable to timely pay for the auction item, if necessary.

In addition, the above-described system also tracks whether the second highest bidder has bid to an amount that exceeded the minimum threshold for a particular auction item. If not, the next highest bidder is sent an electronic mail communication offering him to purchase the item at least the reserve or threshold minimum price. If the next highest bidder does not respond within the designated time interval, the third highest bidders will be notified, in succession, etc. until a bidder is found who was willing to offer the reserve or minimum threshold price for the item. If no bidder is found, the auction item is withdrawn from the auction and the donor is notified accordingly.

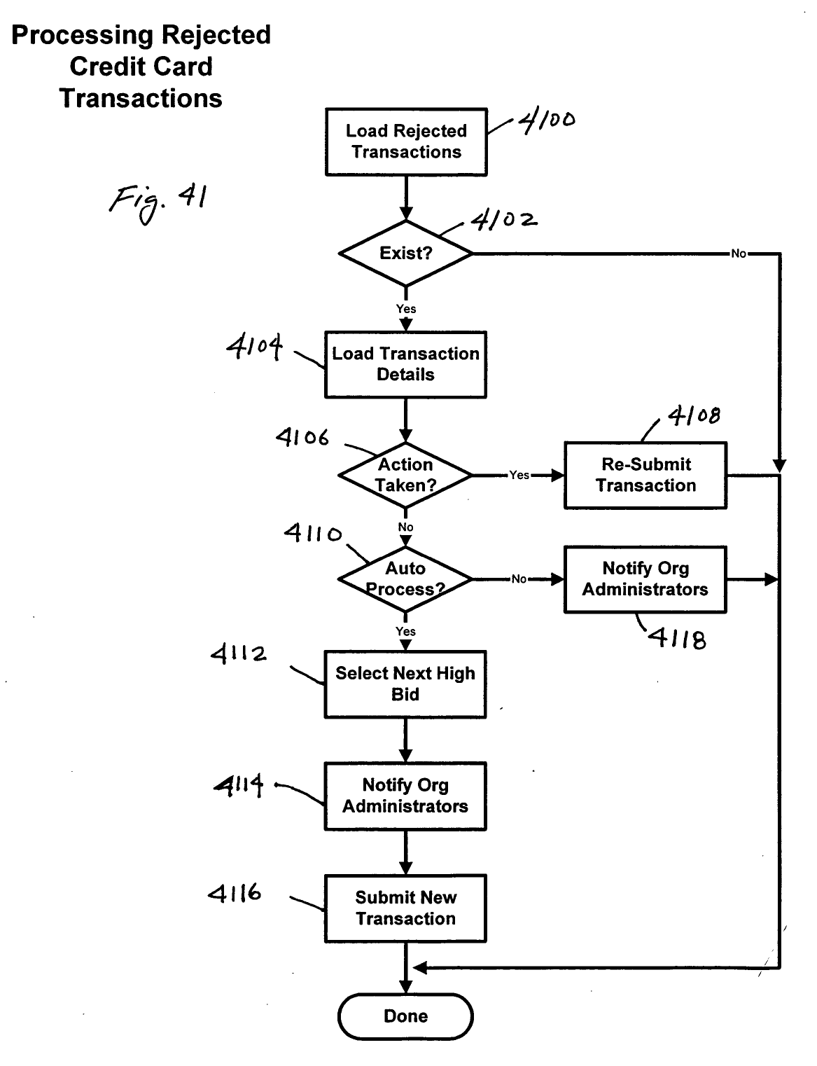

Referring to FIG. 41, the process by which the inventive system automatically handles rejected electronic payments transactions is illustrated. Specifically, following the end of the bidding process, the system attempts to process winning bids for all items with the payment information that exists for the winning bidders. Purchase confirmation electronic mails are sent to those winning bidders whose payment has been received. The system then processes the information and accumulates the records of any transactions that were not completed normally. Periodically, or after all other purchases associated with the auction have been processed, the records associated with failed transactions are retrieved and loaded into a functional algorithm within the system, typically a server application, as illustrated by procedural block 4100. If there are no failed transactions, the process ends. If one or more failed transactions exist, the data for a transaction is loaded, as indicated by decisional block 4102 and procedural block 4104. At this point, depending on the preferences associated with the auction, the failed transaction may be resubmitted to the credit card or electronic banking service, as illustrated by decisional block 4106 and procedural block 4108, and, if successful, the process ends. If unsuccessful, the failed transaction record will be stored with the other failed transaction data in memory. Otherwise, if the automatic processing of failed transaction feature has been enabled for the auction, as illustrated by decisional step 4110, the second highest bidder from the auction bidding record is selected and an electronic mail communication offering the item is automatically generated, as illustrated by procedural block 4112. If the notified second highest bidder submits the necessary payment information, the transaction will be processed, as illustrated by procedural block 4116, and, upon successful completion, the auction item will be purchased. The auction administrators may be notified via electronic mail communications, of the status of a rejected transaction, at various stages of the above-identified process, as illustrated by procedural blocks 4114 and 4118.

Alternately, the nonprofit can enable a ‘rejection queue’ at the time to the auction is created. Rejected bidders are entered into the queue for manual processing. The nonprofit can open each entry, review the bidder, the bid amount, the reason for rejection, as well as the ‘next winning’ bidder. Personnel from the nonprofit can communicate with the bidder to correct the problem or instruct the system to automatically process the next bidder in line, resulting in an automatic electronic mail message being sent to the rejected bidder, with reason, etc., and to the next highest bidder offering the opportunity to pay for the item within a designated period of time. The reader will note that the above described processes may be utilized to minimize the number of failed transactions associated with an auction, and, therefore, maximize revenue generated by the charitable event.

The above-described invention may be implemented in either all software, all hardware, or a combination of hardware and software, including program code stored in firmware format to support dedicated hardware. A software implementation of the above described embodiment(s) may comprise a series of computer instructions either fixed on a tangible medium, such as a computer readable media, e.g. diskette 142, CD-ROM 147, ROM 115, or fixed disk 152 of FIG. 1, or transmittable to a computer system in a carrier wave, via a modem or other interface device, such as communications adapter 190 connected to the network 195 over a medium 191. Medium 191 can be either a tangible medium, including but not limited to optical or analog communications lines, or may be implemented with wireless techniques, including but not limited to microwave, infrared or other transmission techniques. The series of computer instructions whether contained in a tangible medium or a carrier wave embodies all or part of the functionality previously described herein with respect to the invention. Those skilled in the art will appreciate that such computer instructions can be written in a number of programming languages for use with many computer architectures or operating systems and may exist in machine executable format. Further, such instructions may be stored using any memory technology, present or future, including, but not limited to, semiconductor, magnetic, optical or other memory technologies. It is contemplated that such a computer program product may be distributed as a removable media with accompanying printed or electronic documentation, e.g., shrink wrapped software, preloaded with a computer system, e.g., on system ROM or fixed disk, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Further, the methods of the invention may be achieved in either all software implementations, using the appropriate processor instructions, or in hybrid implementations which utilize a combination of hardware logic and software logic to achieve the same results.

1. In a computer system operatively connectable to a network and capable of communicating with one or more other processes operatively connectable to the network capable of hosting an on-line auction with at least one auction item, a method comprising:
(A) identifying a winning bid and bidder associated with an auction item;
(B) deriving from the winning bid an alternative bid of greater value; and
(C) presenting the alternative bid of greater value to the bidder.

2. The method of claim 1 further comprising:
(D) receiving indicia of acceptance of the alternative bid as a payment amount for the auction item.

3. The method of claim 1 wherein (B) further comprises:
(B1) identifying a percent increase by which the winning bid will be multiplied; and
(B2) computing the alternative bid as the product of the winning bid and the percent increase.

4. The method of claim 1 wherein (B) further comprises:
(B1) identifying a multiple threshold to which the winning bid will be increased; and
(B2) computing the alternative bid as the sum of the of the winning bid and the difference between the winning bid and a next higher multiple value.

5. The method of claim 1 wherein (B) further comprises:
(B1) identifying a percent increase by which the winning bid will be multiplied; and;
(B2) identifying a multiple threshold to which the winning bid will be increased.

6. The method of claim 5 wherein (B) further comprises:
(B3) computing a first intermediate value as the product of the winning bid and the percent increase;
(B4) computing a second intermediate value as the difference between the first intermediate and the next higher multiple value; and
(B5) computing the alternative bid as the sum of the of the first intermediate and the second intermediate value.

7. The method of claim 1 wherein further comprising:
(D) repeating (A) through (C) for each of a plurality of items within the auction.

8. The method of claim 1 wherein (A) further comprises:
(A1) maintaining an online accessible user-interface coupled to a memory associated with the auction; and
(A2) receiving data describing the plurality of bids submitted during the auction and data identifying a bidder associated with each bid through the online accessible user-interface.

9. The method of claim 1 wherein (C) further comprises:
(C1) maintaining an online accessible user-interface coupled to a memory associated with the auction; and
(C2) presenting the alternative bid through the online accessible user-interface.

10. A computer program product for use with a computer system operatively connectable to a network and capable of communicating with one or more other processes operatively connectable to the network and capable of hosting an on-line auction with at least one auction item, the computer program product comprising a computer useable medium having embodied therein program code comprising:
(A) program code for identifying a winning bid and bidder associated with an auction item;
(B) program code for deriving from the winning bid an alternative bid of greater value; and
(C) program code for presenting the alternative bid of greater value to the bidder.

11. The computer program product of claim 10 further comprising:
(D) program code for receiving indicia of acceptance of the alternative bid;
(E) program code for processing the alternative bid as payment for the auction item.

12. The computer program product of claim 10 wherein (B) further comprises:
(B1) program code for identifying a percent increase by which the winning bid will be multiplied; and
(B2) program code for computing the alternative bid as the product of the winning bid and the percent increase.

13. The computer program product of claim 10 wherein (B) further comprises:
(B1) program code for identifying a multiple threshold to which the winning bid will be increased; and
(B2) program code for computing the alternative bid as the sum of the of the winning bid and the difference between the winning bid and the next higher multiple value.

14. The computer program product of claim 10 wherein (B) further comprises:
(B1) program code for identifying a percent increase by which the winning bid will be multiplied; and;
(B2) program code for identifying a multiple threshold to which the winning bid will be increased.

15. The computer program product of claim 10 wherein (B) further comprises:
(B3) program code for computing a first intermediate value as the product of the winning bid and the percent increase;
(B4) program code for computing a second intermediate value as the difference between the first intermediate and the next higher multiple value; and
(B5) program code for computing the alternative bid as the sum of the of the first intermediate and the second intermediate value.

16. The computer program product of claim 10 wherein (C) further comprises:
(C1) program code for maintaining an online accessible user-interface coupled to a memory associated with the auction;
(C2) program code for presenting the alternative bid through the online accessible user-interface; and
(C3) program code for receiving indicia of acceptance of the alternative bid as a payment amount for the auction item.

17. In a computer system operatively connectable to a network and capable of communicating with one or more other processes operatively connectable to the network and capable of hosting an on-line auction with at least one auction item, apparatus comprising:
(A) program logic for identifying a winning bid and bidder associated with an auction item;
(B) program logic for deriving from the winning bid an alternative bid of greater value; and
(C) program logic for presenting the alternative bid of greater value to the bidder.

18. The computer program product of claim 17 wherein (B) further comprises:
(B1) program logic for identifying a percent increase by which the winning bid will be multiplied; and
(B2) program logic for computing the alternative bid as the product of the winning bid and the percent increase.

19. The computer program product of claim 17 wherein (B) further comprises:
(B1) program logic for identifying a higher multiple threshold to which the winning bid will be increased; and
(B2) program logic for computing the alternative bid as the sum of the of the winning bid and the difference between the winning bid and a next higher multiple value.

20. The computer program product of claim 17 wherein (B) further comprises:
(B1) program logic for identifying a percent increase by which the winning bid will be multiplied; and;
(B2) program logic for identifying a multiple threshold to which the winning bid will be increased.

21. The computer program product of claim 17 wherein (B) further comprises:
(B3) program logic for computing a first intermediate value as the product of the winning bid and the percent increase;
(B4) program logic for computing a second intermediate value as the difference between the first intermediate and the next higher multiple value; and
(B5) program logic for computing the alternative bid as the sum of the of the first intermediate and the second intermediate value.

22. In a computer system operatively connectable to a network and capable of communicating with one or more other processes operatively connectable to the network capable of hosting an on-line auction with at least one auction item, a method comprising:
(A) determining that a transaction for payment of an auction item was not completed;
(B) notifying a winning bidder of the auction item that the transaction for payment of the auction item was not completed and indicating a time by which the transaction for payment of the auction item must be completed; and
(C) offering the auction item to a next highest bidder for the auction item that has met all auction conditions, if the transaction for payment of the auction item is not completed by the winning bidder before the indicated time.
